(19) United States
(12) Patent Application Publication
(10) Pub. No.: US 2024/0299929 A1
(43) Pub. Date: Sep. 12, 2024

(54) COMPARTAMENTALIZING BIOREACTOR DEVICE AND SEPARATION MACHINERY

(71) Applicants: Tamara Krstic, Novi Sad (RS); Rakesh Mishra, White Plains, NY (US)

(72) Inventors: Tamara Krstic, Novi Sad (RS); Rakesh Mishra, White Plains, NY (US)

(21) Appl. No.: 18/597,304

(22) Filed: Mar. 6, 2024

Related U.S. Application Data
(60) Provisional application No. 63/489,278, filed on Mar. 9, 2023.

(51) Int. Cl. B01L 3/00; B01D 15/38

(52) U.S. Cl. CPC B01L 3/502; B01D 15/3809; B01L 2200/026; B01L 2200/143; B01L 2300/0864

(57) ABSTRACT

The bioreactor system including a compartmentalizing device and subsequent machinery that enable advanced conditions for cell-free synthesis and/or posttranslational modifications, continuity of the purification and/or production process and/or reuse of cell-free production components is described herein. The bioreactor system enables interaction of each product making compartment that contains cell-free production mixture with providing platforms that contain supporting fluids. Methods of producing biological products by utilizing the bioreactor system are provided. Methods of manufacturing a bioreactor system is also described.

### CROSS REFERENCE TO RELATED APPLICATIONS

This application claims the benefit of U.S. provisional application No. 63/489,278 filed on Mar. 9, 2023, which is incorporated by reference as if fully set forth.

### TECHNICAL FIELD

The present disclosure relates to the compartmentalizing bioreactor device and separation machinery and cell-free production of peptides, polypeptides, proteins, and antibodies and/or their conjugates with other molecules, as well as many other molecules done by one or more synthesis that consists of transcription and/or translation and/or posttranslational modifications.

### BACKGROUND OF THE INVENTION

One of the biggest problems in biotechnology industry is production of large masses of desired products while keeping the sophistication of subcellular processes. Resolving this problem require biological, physicochemical, pharmaceutical, mechanical, practical and economical approaches.

Cells based bioproduction is widely used practice all around the world, and initially was an obvious choice for protein production. However, cells have numerous deficiencies as protein producers. Namely, cells are slow, produce a lot of unneeded and sometimes even unwanted proteins and they require special culturing conditions and treatments. Sometimes they can contain viruses, which can make production more complicated and/or the final product totally unusable.

That is why more and more people turn to cell-free techniques that proved to be extraordinarily good in solving all the above problems. Cell-free technology has made bioproduction much simpler and quicker. Since in this type of production the genetic material is provided and highly controlled, chance of production of unwanted and/or unnecessary proteins is almost non existing. Cell-free in comparison to cell-based techniques makes small scale products' synthesis much more effective, and, if done the right way, it could also significantly enhance large scale types of production. Therefore, for this type of production, there is an ongoing search for the right device that would implement cell-free synthesis into large scale production. However, in doing that there are several problems that need to be solved.

Those problems are: (1) chaos of cell-free based production; (2) adequate way of providing supporting substances to production compartments; (3) need for continuous fabrication process; and (4) need for reuse of cell free components.

### (1) Chaos of Cell-Free Based Production

Cell-free production consists of one or more transcriptions and translations or only translations of genetic material. There could also be one or more posttranslational modifications included. These processes are very fragile, because they are based on small quantum of physicochemical attractive energy between molecules. Therefore, in nature these processes are done within a cell, whose inside is surrounded by at least one membrane. As nature never wastes materials and/or energy on building something useless, that is how cell membranes are crucial in protecting transcriptional and translational processes from outside interference, in order to be done properly and in reasonable amount of time and material invested. In such conditions, biosynthesis is protected from interference. In biotechnology, the benefits of not having to deal with natural membranes and cells as wholes are widely known and used. However, by removing cell's natural membrane, transcription and/or translation processes get exposed to outside influences, which can cause numerous issues. The main issue is disruption of transcription and/or translation by other processes within bioreactor, which can be various. A mixing device is often directly or indirectly included in place where synthesis process is performed. It can disturb the processes mechanically, by pulling components away from each other, disrupting their trajectory towards each other, tearing apart established molecular connections and built products. Other substances also present in the same bioreactor, can interfere and unable creation of wanted molecule, by physicochemical reacting with some of the production components and disrupt the processes in that way. Also, even excess amounts of some substances can severely interfere with transcription, translation and/or posttranslational modifications. For example, it is well known that waste and other byproducts can interfere and, when accumulated, even stop transcription and/or translation processes. That is why it is extremely important to have as much control over supporting fluids as it is reasonably possible.

Conventional bioreactors are too robust, providing no separation and causing the chaos of numerous cell free reactions all being done in one pot, while hollow fiber techniques are inadequate for cell free type of production. In order to overcome these obstacles, cell free techniques are usually conducted in small scales. On contrary to that, the requirements for products made by this type of production are in huge volumes. Therefore, it is of crucial importance to find a way for transcription and/or translation processes to be protected, but also to keep them as productive as possible when done in large amounts. That is why pivotal question in biotechnology is how to arrange cell free materials and design artificial membranes that would serve our production needs in the best possible way.

### (2) Adequate Way of Providing to Synthesis

Besides the need for production mixtures to be adequately sized and for processes to be protected from interruptions, it is also necessary to keep them productive as much and as long as it is possible. In order to do that, it is essential to provide every production mixture with all that is necessary for functioning of its processes. These necessities can include addition of: amino acids, energy molecules, nucleotides, gasses, cofactors, posttranslational materials and/or many other molecules, but also and removal of unwanted: byproducts, waste products, etc. Hence, production can go wrong or even be stopped if even only one component is missing or because of accumulation of some material.

### (3) Need for Continuity of Fabrication Process

Each interruption in biotechnology production carries a string of consequences. The most dangerous consequences can be increased risk of microbial and/or chemical contamination. Also, interruptions carry the risk of mechanical stress on the production mixture, which can lead to reduction of the quality or total destruction of desired product. Interruptions also require additional steps in fabrication process, usually performed by human assistance, which also carries string of consequences and increases the price of a product. All interruptions increase energy and time consumption leading to bigger price and possible lower quality of the product. This is especially important while producing fragile, low stability products that on top of all that need to be sterile, as many biotechnology products do. Therefore, it is of high importance to design processes and machinery that will enable continuous fabrication in the most autonomous way possible. Cell-free reactions provide special accessibility to molecules of interest, that should be used in automatization of pharmaceutical production.

### (4) Need for Reuse of Cell Free Components

There are two ways the cell-free components are usually obtained. The first one is by cell lysis of microbial, plant or animal cells and they are called lysates. They can be more or less purified. The second way is by artificial synthesis of cell free compounds necessary for production. No matter what type of production is used, mutual for all cell-free compounds is that they are costly, hard to get and that they should be used as much as possible. While prolongation of cell free synthesis by renewing necessities for its functioning has been extensively examined by other researchers, the idea of reuse of cell free components after the reaction is over has not been so widely examined.

Cell-free components such as ribosomes and transport RNA are very hard to isolate and also hard to produce on their own. That is why their maximal use and/or reuse are important, as they can lead to severe reduction in fabrications' complexity and costs. Compounds for production are usually being used only once in current production processes, often not fulfilling their maximal potential. Since, it is known that removal of some waste products enables continuation of functioning of cell-free components, it should be possible to reuse cell-free compounds after production is over, which would ensure that their potential is maximally exploited.

### SUMMARY OF THE INVENTION

In an aspect, the invention relates to a bioreactor system for cell-free production comprising at least one unit selected from the following group consisting of: a device sector, an inload sector, an unload sector, a separating sector, a recycling sector and a desired product sector. The bioreactor system comprises a device sector comprising at least one unit comprising a plurality of compartments to carry out cell-free reactions. The bioreactor system further comprises an inload sector comprising one or more containers for intake of fluid and one or more tubes operational to carry fluid from the inload sector to the device sector; an unload sector comprising one or more tubes operational for removal of fluid from the device sector; a separating sector comprising one or more tubes for separation of a desired product from a waste material; the recycling sector comprising at least one tube and at least one container and configured for separating production components from waste material and directing them back to the device sector or the inload sector, and the desired product sector comprising at least one tube and at least one container for collecting the desired product.

In an aspect, the invention relates to a device for cell-free production of a biological product. The device comprises at least one section comprising a plurality of compartments to carry out cell-free reactions and at least one section providing support fluids for cell-free reactions.

In an aspect, the invention relates to a method of producing a biological product. The method comprises the steps of inloading fluid comprising a cell-free biological material into a plurality of compartments within a bioreactor device, adding at least one supporting solution to each one of the plurality of the compartments to form a production mixture, providing conditions suitable for one or more chemical reactions within the plurality of the compartments for transforming the production mixture into a resulting mixture, removing waste material from each of the plurality of the compartments, separating production components from a desired product within the resulting mixture, and collecting the desired product in a container.

In an aspect, the invention relates to a method of manufacturing any one of the bioreactor systems described herein comprising assembling, casting or bolting parts of the bioreactor system together.

### BRIEF DESCRIPTION OF THE DRAWINGS

The following detailed description of the embodiments of the present invention will be better understood when read in conjunction with the appended drawings. For the purpose of illustration, there are shown in the drawings embodiments which are presently preferred. It is understood, however, that the invention is not limited to the precise arrangements and instrumentalities shown. In the drawings:

FIGS. 1A-1C are schematic drawings of the bioreactor systems according to embodiments herein.

FIG. 1A is a scheme of the sectors included in a bioreactor system.

FIG. 1B illustrates a bioreactor system that includes subsequent machinery.

FIG. 1C illustrates an exemplary bioreactor system that includes production-products in vials.

FIG. 2 illustrates different types and characteristics of containers included in a bioreactor system.

FIG. 3 is a schematic drawing of the containers connected to the tubes.

FIG. 4 illustrates assembly view for a pouring-in sector in the device.

FIG. 5 illustrates front and side view of the device including upper, middle, side and bottom sections.

FIG. 6 is a cross section view of the device and its sections.

FIG. 7 is a front and side view of the side section.

FIG. 8 is a cross section view of the side section.

FIG. 9 illustrates a cross section view of the scaffold tubes included in the device.

FIG. 10 is a schematic drawing of the device with a clear envelope (outside view).

FIG. 11 is a schematic drawing of the device's exterior with angular tubes (outside view).

FIG. 12 is a schematic drawing of the device's exterior with pouring in and out openings for each section.

FIG. 13 is a schematic drawing of the device exterior's with multiple scaffold tubes.

FIGS. 14A-14F illustrate layouts of the scaffold tubes' openings in the tridimensional grid. FIG. 14A illustrates tubes' openings in the middle of the tridimensional grid. FIG. 14B illustrates tubes' openings in the middle of the tridimensional grid and in its corners. FIG. 14C illustrates scaffold tubes' openings at the ends of the tridimensional grid. FIG. 14D illustrates multiple scaffold tubes' openings at the ends the tridimensional grid. FIG. 14E illustrates scaffold tubes' openings across the end of the tridimensional grid and next to each of the wells. FIG. 14F illustrates scaffold tubes' openings across the ends of the tridimensional grid and between wells.

FIGS. 15A-15C illustrate the main parts of the tridimensional grid structure (front and side view). FIG. 15A illustrates the grid's plate in shape of a rectangle with round edges carrying six rows and seven columns of round shaped grid's elements. FIG. 15B illustrates grid's plate with built up side walls. FIG. 15C illustrates tridimensional grid with an upper membrane.

FIGS. 16A-16C illustrate different kinds of an upper part of the tridimensional grid. FIG. 16A illustrates an empty upper part of the tridimensional grid. FIG. 16B illustrates an upper membrane and the tridimensional grid as one piece. FIG. 16C illustrates an upper membrane attached to the tridimensional grid.

FIG. 17 is a schematic drawing of the device with tridimensional grid containing two different grid's plates (side view).

FIG. 18 illustrates a tridimensional grid containing two different grid's plates (top view).

FIGS. 19A-19D illustrate various shapes of the grid elements. FIG. 19A illustrates round shaped grid's elements. FIG. 19B illustrates rectangle shaped wells' openings and round scaffold tube opening. FIG. 19C illustrates triangle shaped grid's elements. FIG. 19D illustrates star shaped wells' openings and round scaffold tube openings.

FIGS. 20A-20B illustrate the grid plates of different size, designs and number of well openings.

FIG. 20A illustrates the grid plate with the low number of wells openings.

FIG. 20B illustrates the grid plate with the high number of wells' openings.

FIG. 21 illustrates side walls of the tridimensional grid (contrasting left view).

FIG. 22 illustrates an upper membrane in the tridimensional grid (cross section view).

FIGS. 23A-23B illustrate the tridimensional grid without tridimensional grid's side wall. FIG. 23A illustrates the tridimensional grid containing only a grid's plate and wells' walls. FIG. 23B illustrates the tridimensional grid containing only a grid's plate and wells' walls covered with an upper membrane.

FIGS. 24A-24B illustrate the tridimensional grid with scaffold tube openings connected to the tridimensional grid's side wall. FIG. 24A illustrates the tridimensional grid with the tube openings connected to the tridimensional grid's side wall (top view). FIG. 24B illustrates the tridimensional grid with tube openings connected to the tridimensional grid's side wall (front and side view).

FIGS. 25A-25B illustrate the tridimensional grid with the tube openings connected with wires. FIG. 25A illustrates the tridimensional grid with tube openings connected with wires (top view). FIG. 25B illustrates the tridimensional grid with tube openings connected with wires (front and side view).

FIGS. 26A-26C illustrate the grids with separating walls between the wells. FIG. 26A illustrates the grid with separating walls between the wells (top view). FIG. 26B illustrates the grid with separating walls between wells (side and front view). FIG. 26C illustrates the grid with separating walls between wells (top, side and front view).

FIGS. 27A-27C illustrate various shapes and designs of the grid's plate. FIG. 27A illustrates the rectangle shaped grid's plate. FIG. 27B illustrates the rectangle with round edges shaped grid's plate. FIG. 27C illustrates the round shaped grid's plate.

FIGS. 28A-28D illustrate different perspectives of the multiunit devices. FIG. 28A is a scheme of multiunit device having five units that are placed one on top of the other and tubes going out of the device. FIG. 28B is a 3D outside view of the multiunit device that includes five units placed one on top of other and tubes going out of device in tridimensional space. FIG. 28C is a 3D outside view of the exterior of an empty multiunit device. FIG. 28D is a 3D outside view of the clear empty multiunit device.

FIGS. 29A-29C illustrate different types of multiunit devices (cross section views). FIG. 29A illustrates the multiunit device having four sections separate for each unit (cross section view). FIG. 29B illustrates the multiunit device with sections mutual for several units (cross section view). FIG. 29C illustrates the difference between the multiunit device with four sections separate for each unit and the multiunit device with some sections mutual for units (tridimensional cross section views).

FIGS. 30A-30D illustrate relations of the scaffold tubes and tridimensional grids in multiunit devices (cross section views). FIG. 30A illustrates attachment of the tridimensional grids to the scaffold tubes within multiple units device (cross section view). FIG. 30B illustrates different types of the scaffold tubes (cross section view). FIG. 30C illustrates the tridimensional grids being pulled up with the scaffold tubes (cross section view). FIG. 30D illustrates the scaffold tubes of the tridimensional grids (cross section view).

FIGS. 31A-31C illustrate multiunit devices with impermeable layers (cross section views). FIG. 31A illustrates an empty five unit device with impermeable layers (cross section view). FIG. 31B illustrates the filled impermeable layers (cross section view). FIG. 31C illustrates filled a five-unit device with impermeable layers (cross section view

FIGS. 32A-32B illustrate long poles. FIG. 32A illustrates long supportive poles. FIG. 32B illustrates long connecting and supportive poles.

FIGS. 33A-33B illustrate short poles. FIG. 33A illustrates short connecting and supportive poles. FIG. 33B illustrates strings of poles.

FIGS. 34A-34D illustrate the scaffold tubes wedged in the upper membrane and the grid. FIG. 34A illustrates the scaffold tubes wedged in the upper membrane and the grid (2D cross section view). FIGS. 34B-34BD illustrate assembly of multiunit device by wedging (3D view). FIG. 34B illustrates the lower membrane wedged in the bottom unit of device. FIG. 34C illustrates the scaffold tube part wedged in the upper membrane and the grid in the bottom unit. FIG. 34D the illustrates the scaffold tubes' parts wedged connecting two tridimensional grids from two device units.

FIGS. 35A-35B illustrate the scaffold tubes bolted in the upper membrane and the grid (assembly view). FIG. 35A illustrates assembling of the device. FIG. 35B illustrates the scaffold tubes bolted into their places.

FIG. 36 illustrates the scaffold tube cast with the upper membrane and the grid.

FIG. 37 illustrates multi grids bolted (assembly view).

FIG. 38 illustrates multi grids casted (assembly view).

FIG. 39 illustrates a device where envelope's wall serves as a door.

FIGS. 40A-40B illustrate a device closed by two locks. FIG. 40A illustrates an opened position-device divided in two parts (assembly view). FIG. 40B illustrates closed locks.

FIGS. 41A-41D illustrate a device that opens only on one side. FIG. 41A illustrates a device slightly open. FIG. 41B illustrates a device wide open. FIG. 41C illustrates a device closed. FIG. 41D illustrates wrapping the envelopes walls around scaffold.

FIGS. 42A-42G illustrate setups of the devices (cross section view). FIG. 42A illustrates setup of the one unit device. FIGS. 42B-42G illustrate setup of the multiunit devices. FIG. 42B illustrates an empty device. FIG. 42C illustrates the device having the bottom sections filled and grids pulled up. FIG. 42D illustrates the device with production mixtures filled. FIG. 42E illustrates the middle sections in compartments and grid filled. FIG. 42F illustrates the upper section filled. FIG. 42G illustrates all sections that are filled and products formed.

FIGS. 43A-43F illustrate devices with a movable upper membrane (cross section views). FIG. 43A illustrates an empty device with a movable upper membrane. FIG. 43B illustrates the tridimensional grid down, and the upper membrane pulled up. FIG. 43C illustrates production mixture poured in. FIG. 43D illustrates the middle section in compartments. FIG. 43E illustrates production mixture in wells covered with the upper membrane. FIG. 43F illustrates the upper section filled.

FIGS. 44A-44D illustrate pulling production mixture into compartments-device with movable parts of upper membrane (cross section views). FIG. 44A illustrates the tridimensional grid up. FIG. 44B illustrates the tridimensional grid on top of the production mixture. FIG. 44C illustrates pulling production mixture into wells. FIG. 44D illustrates production mixture pulled into wells.

FIGS. 45A-45B illustrate device sector having poles holding the lower membrane. FIG. 45A illustrates a device with two poles on the lower membrane. FIG. 45B illustrates a device with numerous poles on the lower membrane.

FIGS. 46A-46H illustrate impermeable items for a lower membrane in the setup of the device. FIGS. 46A-46B illustrate impermeable items for lower membrane in one unit device for pouring out. FIG. 46A illustrates impermeable items up on the membrane. FIG. 46B illustrates impermeable items down in the bottom section. FIGS. 46C-46H illustrate impermeable items for the lower membrane in the multiunit device where impermeable items enable functioning of the device whose upper and bottom sections of several units are united. FIG. 46C illustrates an empty multiunit device whose upper and bottom sections of several units are united, and only the bottom section of the bottom unit is filled. FIG. 46D illustrates filling production mixtures into empty a multiunit device whose upper and bottom sections of several units are united and impermeable items ensure there is no leakage of production mixture. FIG. 46E illustrates placing production mixtures into wells and impermeable items ensure there is no leakage of production mixture. FIG. 46F illustrates filling all sections with supporting fluids, and impermeable items ensure there is no leakage of production mixture. FIG. 46G illustrates impermeable items moved left from wells. FIG. 46H illustrates impermeable items turned away from the wells into bottom sections.

FIGS. 47A-47I illustrate the setups of the device for pouring out. FIGS. 47A-47B illustrate pumping out sections. FIG. 47A illustrates pumps on pouring in containers and pouring out tubes. FIG. 47B illustrates pumps on pouring in containers, pouring in and pouring out tubes. FIGS. 47C-47F illustrates tilting of lower membrane. FIG. 47C illustrates setting up the device. FIG. 47D illustrates starting synthesis. FIG. 47E illustrates synthesis and posttranslational modifications over. FIG. 47F illustrates pouring out of resulting production mixture by tilting lower membrane. FIGS. 47G-47I illustrate pouring in and out of sections (2D and 3D cross section view). FIG. 47G illustrates pouring in and out of bottom sections. FIG. 47H illustrates pouring in and out of middle sections. FIG. 47I illustrates pouring in and out of upper sections.

FIG. 48 illustrates collection of the products in a container.

FIGS. 49A-49E illustrate production setups where parts of the subsequent machinery are excluded. FIG. 49A illustrates the production setup without second separation and chemical and/or biological treatment of products and recycling of the production components. FIG. 49B illustrates the production setup without recycling of production components. FIG. 49C illustrates the production setup without second separation and chemical and/or biological treatment of products. FIG. 49D illustrates the production setup without second separation of products. FIG. 49E illustrates the production setup without second separation products and recycling of production components.

FIGS. 50A-50F illustrate setups for separation sector. FIG. 50A illustrates a setup where each middle section's fluid of the device is inloaded into a separate tube that contains the first line of separation 50001-50008. FIG. 50B illustrates a separate first line of separation production setup without second separation and chemical and/or biological treatment of products and recycling of production components. FIG. 50C illustrates a separate first line of separation production setup without recycling of production components. FIG. 50D illustrates a separate first line of separation production setup without second separation and chemical and/or biological treatment of products. FIG. 50E illustrates a separate first line of separation production setup without second separation of products. FIG. 50F illustrates a separate first line of separation production setup without second separation products and recycling of production components.

FIGS. 51A-51B illustrate a device implemented into conventional bioreactor. FIG. 51A illustrates a setup with no pouring in and out openings on sides, only on top of the upper section. FIG. 51B illustrates a setup with three pouring in and out opening on sides.

### DETAILED DESCRIPTION OF THE PREFERRED EMBODIMENTS

Certain terminology is used in the following description for convenience only and is not limiting. Unless stated otherwise, or implicit from context, the following terms and phrases include the meanings provided below. Unless explicitly stated otherwise, or apparent from context, the terms and phrases below do not exclude the meaning that the term or phrase has acquired in the art to which it pertains. The definitions are provided to aid in describing particular embodiments, and are not intended to limit the claimed invention, because the scope of the invention is limited only by the claims. Further, unless otherwise required by context, singular terms shall include pluralities and plural terms shall include the singular.

The singular terms “a,” “an,” and “the” include plural referents unless context clearly indicates otherwise. Similarly, the word “or” is intended to include “and” unless the context clearly indicates otherwise.

The phrase “at least one” followed by a list of two or more items, such as “A, B, or C,” means any individual one of A, B or C as well as any combination thereof.

The words “right,” “left,” “top,” and “bottom” designate directions in the drawings to which reference is made.

Although methods and materials similar or equivalent to those described herein can be used in the practice or testing of this disclosure, suitable methods and materials are described below.

This invention presents machinery and its way of functioning for production that includes cell free synthesis of peptides, polypeptides, proteins, antibodies, nucleic acids, different kinds of conjugates, etc. and one or more posttranslational modifications. The machinery consists of: device for cell free synthesis and subsequent machinery.

Sizes of bioreactor compartmentalizing device and potential subsequent machinery can be various. Sizes of device can be ranging from half an inch to several feet, while sizes of subsequent machinery can be ranging from several inches to several feet, depending on the production volume, method of use and ability to build the machinery or some of its parts. Some embodiments can be made as simple manufacturing devices, while some other embodiments can be used as or parts of huge production plants.

It should be understood that although the following description has been made on explanations, embodiments and examples of the invention and also illustrated by drawings, the invention is not limited thereto and various changes and modifications may be made without departing from the spirit and the scope of the invention.

### Definitions of Terms

The term “fabrication process,” or “production process” refers to the process of bioreactor's functioning. It consists of production, that can consist of one or more syntheses and/or posttranslational modifications, and can also contain more or less of purification and/or recycling. The synonym of the “fabrication process” is manufacture.

The term “product's forming” refers to making of one or more products within present invention. It consists of production, but it also includes more or less of purification in subsequent or separation machinery. The synonyms of this term are manufacture and creation.

The term “production” refers to all physical, biological and/or chemical processes used to make desired product.

The term “synthesis” refers to all reactions leading to and including all transcriptions and/or translations within one production process. The synonyms of synthesis are synthesis process and synthesis reaction.

The term “posttranslational modification” refers to any production reaction following synthesis process that can modify product of synthesis. It can include physical, biological and/or chemical processes. The synonym of posttranslational modification is posttranslational modification reaction.

The term “other production process” refers to any process, reaction and/or action, other than synthesis and posttranslational modifications, that is included in production.

The term “supporting process” refers to any process, reaction and/or action, that is used to support and/or to enable production. It can contain supporting, inload and/or unload operations.

The term “cell free” or “cell-free” refers to anything and/or process that does not include conventional cell structure, i.e. cell arranged as cell elements surrounded by functional cell membrane. It can contain cell elements, inside of cell and/or cell membrane, but not cell as a whole.

The term “pouring in” refers to the process of transferring something into an object. The synonyms of pouring in are uploading, filling, entrance.

The term “pouring out” refers to the process of transferring something from an object. The synonyms of pouring out are unloading and exit.

The term “inload” refers to act of loading or entering a particular object or material into a designated space, such as a vehicle, container, or system. It refers to the process of introducing or inserting something into a specific location or structure. Inload typically denotes the flow or transfer of items into a target area, often with the intention of transportation, storage, or further processing.

The term “unload” refers to the process of taking the load from; removing the cargo or freight from, removal or discharge. The synonym of the term is empty.

The term “compartmentalizing” or “compartamentalizing” refers to the process of dividing something into compartments.

The term “case” refers to one of many possible actualizations of invention and/or actions happening in it. The synonym is embodiment.

The term “substance” refers to the essential nature of the real physical matter with particular, uniform properties.

The term “component” refers to an individual and/or group entity regarded as a structural and/or functional constituent of a whole, that can be considered separately from the whole. It combines with one or more other ingredients in order to perform any part of production, that it is involved in. This term contains all kinds of components present in invention. The synonyms of the term are compound, biocomponent, bio compound.

The term “fluid” refers to any substance, solution and/or mixture that is present in device and that is in liquid, gaseous, gel, gel-like, plasm and/or any other fluid state.

The term “solution” refers to one or more components, substances, molecules, ions, atoms and/or elements solved in any other substance. It can be in form of liquid, gas, gel, plasm, aerosol or any other fluid. This term contains different kinds of: materials, elutes, solutions present in invention. The synonyms of the term are liquid and gel.

The term “material” refers to substance, solution and/or mixture from which a thing consists and/or is made of, which has a tangible, solid presence in reality. It is the most important, essential part from what something is build and can be subject to changes.

The term “mixture” refers to a combination of one or more substances and/or solutions.

The term “elute” refers to substance or solution that is used to wash and/or flush away any other substance and/or component that is adsorbed or in any other way retained in elution road.

The term “production solution” refers to solution that can contain substances, components, molecules, ions and/or elements, that are used in any part of production process. There are many different types of production solutions. The synonyms of the term are reaction solution, and production solution.

The term “production mixture” refers to mixture that contains all solutions, substances, components, molecules, ions and/or elements, that are used in any part of production process. There are many different types of production mixtures. The synonyms of the term are reaction mixture, production solution.

The term “input solution” refers to the production solution that is introduced into device in order for one or more synthesis and/or posttranslational modifications to be performed in it.

The term “input mixture” refers to the production mixture that is introduced into device in order for one or more synthesis and/or posttranslational modifications to be performed in it.

The term “synthesis solution” refers to solution that contains all components, molecules, ions and/or elements, that are used in synthesis. The synonym of the term is cell free synthesis solution.

The term “synthesis mixture” refers to mixture that contains all components, molecules, ions and/or elements, that are used in synthesis. The synonym of the term is cell free synthesis solution.

The term “posttranslational modification solution” refers to solution that contains all solutions, substances, components, molecules, ions and/or elements, that are used in one or more posttranslational modifications.

The term “posttranslational modification mixture” refers to mixture that contains all solutions, substances, components, molecules, ions and/or elements, that are used in one or more posttranslational modifications.

The term “output solution” refers to production solution at the moment when and after each one of every synthesis and/or one or more posttranslational modifications are over, before it is released from wells by pulling the tridimensional grid up. There could be many different output solutions created from one input solution and each one of them is different and created after every synthesis and/or posttranslational modification happening in input solution.

The term “output mixture” refers to production mixture at the moment when and after each one of every synthesis and/or one or more posttranslational modifications are over, before it is released from wells by pulling the tridimensional grid up. There could be many different output mixtures created from one input mixture and each one of them is different and created after every synthesis and/or posttranslational modification happening in input mixture.

The term “resulting solution” refers to production solution at the time when and after all synthesis and/or posttranslational modifications are done, tridimensional grid is pulled up and wells' content is mixed together. One input solution can have one resulting solution.

The term “resulting mixture” refers to production mixture at the time when and after all synthesis and/or posttranslational modifications are done, tridimensional grid is pulled up and wells' content is mixed together. One input mixture can have one resulting mixture.

The term “supporting solution” refers to solution that contains one or more necessities and/or provides space for removal of waste. The synonym of the term is providing platforms' solutions.

The term “supporting mixture” refers to mixture that contains one or more necessities and/or provides space for removal of waste. The synonym of the term is providing platforms' mixtures.

The term “necessity” refers to substance, solution, item, component, molecule, atom, ion and/or element necessary for any part of production process. The synonyms of the term “necessity” are terms “required,” “required substance”, “required compound,” and “required material.”

The term “waste” refers to any material, substance, solution, by-product, component, molecule, atom, ion and/or element that is unwanted, unusable and/or unrequired, serves no purpose for production process and/or needs to be eliminated or discarded in order to enable completion of a process. The synonyms of the term are unwanted, inadequate product.

The term “waste solution” refers to the solution that is intended for adsorbing, solvating, clearing, eluting and/or in any other form removing of waste from the invention. The synonym of the term is waste eliminating solution. The term “waste solution” is used interchangeably herein with the terms “waste mixture” and “waster eliminating mixture.”

The term “upper section's solution and/or mixture” refers to the solution and/or mixture of all components present in the upper section.

The term “bottom section's solution and/or mixture” refers to the solution and/or mixture of all components present in the bottom section.

The term side section's solution and/or mixture” refers to the solution and/or mixture of all components present in the side section.

The term “middle section's solution and/or mixture” refers to solution and/or mixture of all components present in the middle section.

The term “cell free solution” refers to the solution whose all components are cell free. The cell-free solution is also referred to herein as “cell-free mixture.”

The term “cell-free synthesis solution” refers to solution used for synthesis whose all components are cell free. The cell-free synthesis solution is also referred to herein as “cell-free synthesis mixture.”

The term “machinery” refers to an assemblage of one or more machines, devices, apparatuses, tubes, containers and/or supporting items for performing any part of or entire production process.

The term “sector” refers to a portion of machinery intended to perform certain part of production.

The term “container” refers to a hollow object that is used to hold and/or transport solution. It can be made of any material. Vial is small form of container. Bowl is a medium size container. Container is also a name for biggest form of container.

The term “pump” refers to any object that has ability to provide reinforcement of the flow.

The term “apparatus” refers to machine that is used for its own functioning or in order to support functioning of another item.

The term “gadgetry” refers to an item that is used in order to support functioning of another item.

The term “bioreactor” refers to any created and/or manufactured item that supports one or more biological, physical and/or chemical activities and/or processes carried out within production.

Conventional bioreactor are bioreactors that are currently and were in use before this invention.

The term “batch” is used interchangeably herein with terms “pot” and “batch.”

The term “device” refers to an object that has been invented in order to provide possibility of surrounding each compartment with providing platforms, so that every part of cell free mixture can come in contact with proper solutions in adequate way. It can be made of one or more units. The synonyms of the term “device” herein are unit, multiple units' device, bioreactor device, device for cell free synthesis, bioreactor compartmentalizing device, compartmentalizing device, compartmentalizing bioreactor device, cell free bioreactor device, and cell free product synthesis device.

The term “unit” refers to an individual device regarded as complete and/or component of a larger, more complex whole, fitting with others like it or complementary parts. The synonym of the term “unit” herein is the term “device.”

The term “one unit device” refers to a device composed of single unit. The synonyms of the term are one-unit device, one unit's device, one-unit's device, single unit device, single-unit device, device.

The term “multiple units device” refers to a device composed of two or more units. The synonyms of the term are multiple-unit device, multiple units' device, multiple-units' device, multi units device.

The term “neighboring units” refers to two or more units joined and/or connected through side walls or placed one on top of the other.

The term “supportive, connecting pole” refers to a pole that connects two or more tridimensional grids, upper and/or lower membranes.

The term “impermeable layer” refers to the space between two units that does not leak any substance from one unit to another through its solid parts. It usually has one or more holes or other types of openings in order to provide one or more places for tubes and/or poles that connect one unit to another.

The term “section” refers to a portion of device. The synonym of the term is compartment.

The term “upper section” refers to a portion of device above upper membrane.

The term “middle section” refers to a portion of device above lower membrane when tridimensional grid is placed up and a portion of device that contains wells when tridimensional grid is placed on top of lower membrane.

The term “side section” refers to a portion of device that contains scaffold except for wells.

The term “bottom section” refers to a portion of device bellow lower membrane.

The term “medium of device” refers to central part of device that contains lower membrane, middle section and side section and upper membrane when they are pushed down, i.e. tridimensional grid placed on top of lower membrane and upper membrane placed on top of it, if they are separate.

The term “medium section” refers to the middle and side section when it is placed on top of the lower membrane, i.e. in the medium of device. The synonym of the term is middle of the device.

The term “envelope” refers to a continuous structure that encloses and/or divides an area of device from the outside and that is regarded as a protective or restrictive barrier. The term “envelope” may also apply to “envelope like structure.”

The term “envelope like structure” refers to an envelope improvised by assembling gadgets, machine parts and/or any other appropriate items.

The term “envelope's door” refers to part of envelope that can be opened, with that opening big enough to transfer a tridimensional grid through it.

The term “device's wall” refers to part of envelope that covers one entire side and/or part of the device.

The term “device's top wall” refers to the highest envelope wall of device.

The term “device's bottom wall” refers to the lowest envelope wall of device.

The term “device's side wall” refers to the envelope's wall between top and bottom wall placed on side. The synonyms of the term are device side wall and envelope side wall.

The term “tridimensional grid's side wall” refers to the wall surrounding grid's plate's frame.

The term “lock” refers to a mechanism for keeping an envelope, lid, container and/or any other item fastened.

The term “scaffold” refers to an apparatus that contains one or more tubes connected to one or more tridimensional grids, that are placed inside of a device. It contains or is made of semipermeable membrane.

The term “tube” refers to a hollow vessel intended to and/or that holds, conveys and/or transports something. It can be cylindric or any other shape of any material This term includes: long tube, short tube, pouring in, pouring out tube. The synonym of the term is pipe.

The term “scaffold tube” refers to any tube that is part of the scaffold, as one of its functions must be to provide side section with one or more solutions and/or to take one or more solutions out of it. The synonyms of the term are scaffold's tube, side sections' cylindric tube, cylindric tube, side sections' tube, and side section's tube.

The term “opening” refers to a space or gap that allows passage and/or access of an item to another one. Opening can be for one or more tubes, valves or anything else. The synonyms of the term are hole for tube, tube joint, and joint.

The term “tube opening” refers to a hole on tube through which one or more fluids can enter and/or leave area that tube is placed in by passing through it.

The term “carrying walls and/or wires” refers to walls and/or wires used to support certain item and keep it in place.

The term “long tube” refers to a tube that stretches between two or more tridimensional grids and outside of the device or more than two tridimensional grids inside of the same multi units device or that connects two or more tridimensional grids of different multi units devices. The synonym of the term is tube.

The term “short tube” refers to a tube that stretches between one tridimensional grid and outside of device. The synonym of the term is a tube or pipe.

The term “tube's part” refers to a small tube that stretches between two tridimensional grids of the same multi units device.

The term “beginning of tube” refers to the highest part of tube. If both openings of same tube are positioned at equal heights, beginning of the tube is opening that is first used in observed process. The synonym of the term is top of the tube.

The term “end of tube” refers to the lowest part of tube. If both openings of same tube are positioned at equal heights, beginning of the tube is opening that is last used in observed process. The synonym of the term is bottom of the tube.

The term “pouring in tube” refers to a tube used to pour in solution and/or anything else into something else. The synonyms of the term are pouring in pipe, uploading tube, uploading pipe, filling tube, and filling pipe.

The term “pouring out tube” refers to a tube used to pour out solution and/or anything else from something else. The synonyms of the terms are pouring out pipe, unloading tube, and unloading pipe.

The term “lid” refers to a removable or hinged cover for the top of something. The synonym of the term is cap.

The term “mount pad” refers to a pad used to mount item into specific place and/or to hold it there. By directly holding an item into and/or onto its place it sometimes can indirectly secure placement of another item connected to the first one.

The term “tridimensional grid” refers to a tridimensional structure having a bottom, and in some embodiments an upper end, is in the form of a grid. The elements of the structure are connected to each other by grid's walls, wells' walls and one or more tubes. The synonyms of the term are grid, grid structure, three-dimensional grid, the grid, and the tridimensional structure,

The term “grid” refers to a set of same and/or different shapes within a framework. The synonyms of the term are a well plate, grid plate, grid's plate, or plate.

Surfaces of the grid mean any interior and/or exterior layer and/or space occupied by tridimensional grid.

Tridimensional grid's wells' walls refers to grid's walls that surround compartments, i.e. walls surrounding each shape and connecting it to the upper part of the grid, whether that is top of the grid, nothing or upper membrane. The synonyms of “Tridimensional grid's wells” are wells' walls, well's wall, well's walls, and grid's side walls

The term “area around wells” refers to parts of tridimensional grid's inner structure other than wells, side walls, lower end and upper membrane and/or end.

Additional separating walls mean walls between wells, they can also be placed between wells and other structures. Additional separating walls can be referred to herein as separators.

The term “well” refers to part of the tridimensional grid which occupies a place between one shape, its walls and corresponding space on the opposite (upper or lower) side of the tridimensional grid. The synonyms of the “well” is a hole.

Grid's element mean any hollow part of grid's plate that is inside of its frame.

Well's bottom is a grid's element whose shape is foundation for buildup of well's wall.

The term “compartment” refers to each well when it is filled with solution presents one compartment.

The term “membrane” refers to a thin layer of material forming a barrier and/or lining between solutions.

Semi-permeability or semi permeability allows certain components, molecules, ions and/or elements to pass through something, while keeping others from passing through it.

The term “semipermeable membrane” refers to a membrane that will allow certain components, molecules, ions and/or elements to pass through, while keeping others from passing through it. The semipermeable membrane can refer to herein to a dialysis membrane.

Dialysis means separation of components, molecules, ions and/or elements on the basis of differences in their ability to pass through a semipermeable membrane.

The term “dialysis membrane” refers to a membrane through which dialysis is being done.

The term “providing platform” refers to semipermeable surfaces surrounding compartment that provide solutions within compartments with solutions their corresponding sections contain and/or with space to remove the waste products.

The term “upper membrane” refers to a semipermeable membrane that separates side and middle section from upper section. It can be placed on top of the tridimensional grid or be its integral part.

The term “lower membrane” refers to a semipermeable membrane that separates side and middle section from bottom section.

The term “holder” refers to an item for keeping one or more objects in place by placing them onto it.

The term “handle” refers to an item by which something is held, moved and/or controlled.

The term “subsequent or separation machinery” refers to all the machinery after the pouring out sector. It can consist of first separational tube, desired product's pipeline and/or recycle pipeline. The synonyms of the term are specific pipelines, pipelines, desired product's and production components' pipeline,

“Pipeline” refers to assemblage of connected tubes and other items that are used for carrying fluids and performing specific task or tasks within production process.

The term “first separation tube” refers to the first tube after pouring out sector that contains separative method. It can contain one or more separation columns inside it. Synonyms: separative tube, tube with separation column, tube with separation column part of it, the tube, separative tube, (in some embodiments) affinity chromatography tube, first separation method tube, (in desired product's pipeline) purification tube, first separation tube. The synonym of the term is big tube.

The term “of interest” means something that might be useful in production process, desired product and/or recycling component. There can be one or more products, components, molecules, ions and/or elements of interest. The synonym of the term is desired.

The term “tube's expansion” refers to broadening of a tube in one or more of its parts. The synonyms of the term are tube's widening and perforated part.

The term “two ended tube” refers to a tube that has one beginning and two ends next to each other. The term also refers to herein to a tube whose lower part and/or end is split in two parts.

The term “detecting device” refers to a device that produces a measurable response to a change in biological, chemical and/or physical condition.

Signal detection means noticing stimuli (a signal) through the senses. It can be quantified and/or recorded.

The term “separation signal” refers to signal showing that different type of product, component, molecule, ion and/or element is observed in comparison to the previous one.

The term “clear separation” refers to differentiation of independent sources using two or more detection signals.

The term “inadequate separation” refers to inability to differentiate independent sources using detection signals.

The term “satisfactory signal” refers to certain range of signals showing satisfactory product. The synonyms of the term are correct signal and correct range of signal.

The term “repetitional tube” refers to a tube that redirects solution back into desired area. It is usually connected to a single tube containing separation method within and serves as its repetitional tube. Also, it can be the tube that carries recycled compounds back into the production. The synonyms of the term herein are elution road, repetition tube, redirecting tube, redirection tube, redirecting pipe, redirection pipe.

The term “elution road” refers to part of or entire path in which the disclosed system is cleaned by flushing one or more elutes through its interior parts in order to carry out any of inappropriate materials, products, components, molecules, ions and/or elements remained in it.

The term “desired product” refers to the main wanted final result of the production process. It is usually obtained by one or more transcriptions and/or translations and/or one or more posttranslational modifications. The term “satisfactory product” refers to the product meets all the required parameters.

The term “inadequacy of the product” refers to the product does not meet one or more required specifications. The synonym inadequacy of the inadequacy of the product is waste product.

The term “recycle” refers to reuse of a component, molecule, ion and/or element utilizing cyclic process.

The term “normal flow” refers to the type of flow in which fluid travels smoothly through expected regular paths, by ordinary speed influenced by attractive force of gravitational field.

### I. Description of the Bioreactor System

### Sectors

An embodiment provides a bioreactor system for cell-free production that includes a device sector, an inload sector, an unload sector, a separation sector and a desired product sector. The bioreactor system may further include a recycle sector.

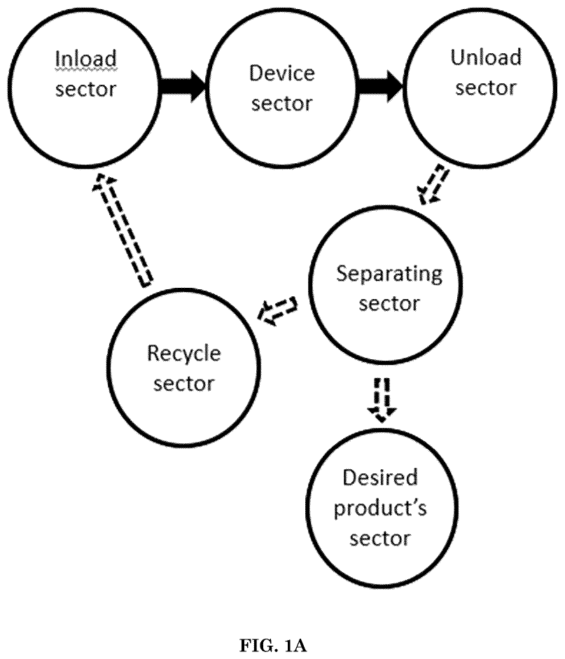

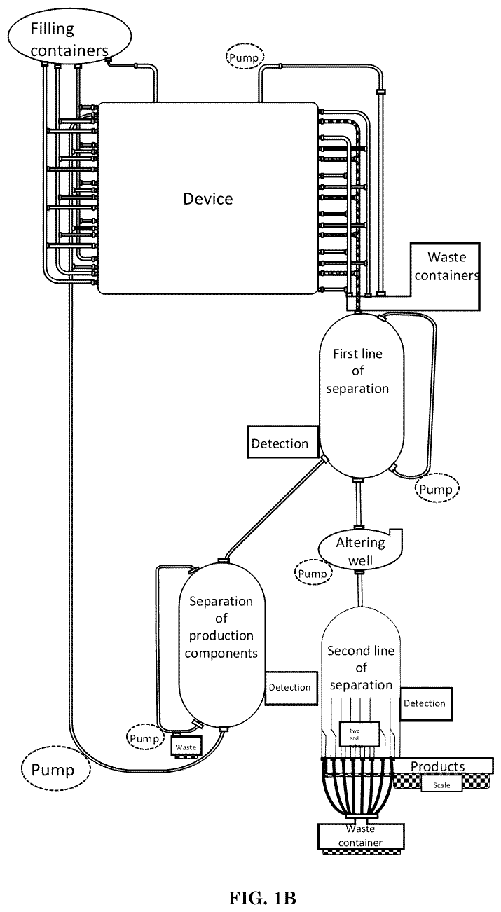

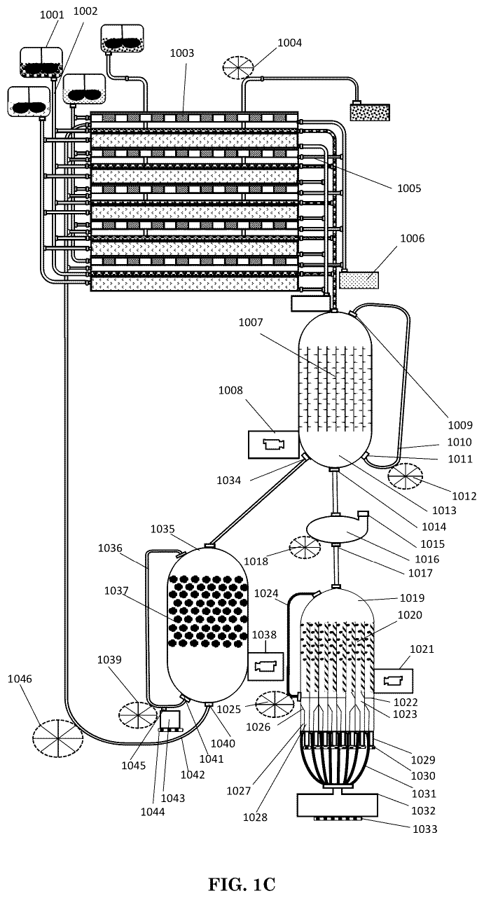

FIG. 1A is a schematic drawing of the sectors included in the bioreactor system in accordance with an embodiment of the present invention. First four sectors, e.g., an inload, device, unload and separation sectors go one after another. Then the separation sector is continued into desired product's and/or recycle sector. The recycle sector can continue back to the inload sector. In that way circulatory production process can be performed.

In some embodiments the bioreactor system can include subsequent machinery that is necessary for functioning of the system and may not be included in every embodiment described herein

FIG. 1B is a non-limiting schematic diagram of a compartmentalizing bioreactor system including subsequent machinery. In this figure, “Filing containers” of the inload sector are configured to be filled with inload fluid or fluids. The “Filing containers” are operably connected via tubes to the “Device” sector. The “Device” is configured to be inloaded with fluid or fluids for cell-free production of biological products. The device is equipped with an optional “Pump” operable to force fluid or fluids from the device to the “First line of separation,” or to the “Waste container.” The “First line of separation” of the separation sector includes “Detection” devices, and three tubes for separating fluids. One tube is configured to direct fluid containing the desired product into the “Altering well.” The “Altering well” is equipped with a “Pump” for operable for mixing reaction components and further directing fluids with the desired product to the tube “Second line of separation.” The “Second line of separation” tube is also equipped with detection devices and includes “Two end” tubes configured to direct fluids either to “Products” container or vial, or “Waste container.” The “Products” container is equipped with a “Scale.” Another tube of the “First line of separation” is configured for redirecting or recycling fluids that contains production components into another tube for “Separation of production components” and subsequently back to the “Device.” The tube “Separation of production components” of the recycle sector is also equipped with one or more detecting devices to monitor separation, and one more pumps for redirecting fluids either to the “Device” or “Waste” container. The third tube of the “First line of separation” redirect fluids back into the same line for further separation.

FIG. 1C is another non-limiting example of a bioreactor system for cell-free production of biological products in vials. The system comprises filling containers 1001 equipped with mixing devices. The filing containers comprise valves connected to the device 1003 through with the filling (inload) pipes 1002. The device is equipped with the pump 1004 for pumping out fluid from the side section. The device is further connected to unload, or pouring out, sector tubes 1005 that lead to the waste containers 1006. The unload sector further comprises tubes leading to the first line of separation tube 1007. The first line of separation tube is equipped with the detection device 1008. The first line of separation tube is also fitted with the upper valve 1009 and the lower valve 1011 on the redirecting tube 1010 for this line. The first line of separation tube further comprises pump 1012 for the redirecting tube 1010. The tube 1013 of the first line of separation is connected with the cell free unload tube by a valve on its top. The tube 1013 is fitted with the desired products pipeline's valve 1014 with subsequent tube. The tube leads to the well 1016 for chemical, physical and/or biological altering of the desired product. The well 1016 includes opening 1015 of the well closed with a cap on it. The well 1016 further includes an exit valve with the subsequent tube and the pump 1018. The well 1016 is connected to the second line of separation tube 1019 via the valve on its top. The second line of separation tube 1019 comprises pipes 1020 for second round of separation. The second line of separation tube contains the detection device 1021. The valve 1022 is configured to direct fluid to the two ended tube or to redirecting tube (closed). The valve 1023 is configured to direct fluid to the two ended tube or to redirecting tube (opened). The second line of separation tube includes the redirecting tube 1024 with valves on its bottom and top, and the pump 1025. The second line of separation tube also includes the valve 1026 on the normal flow (closed), normal flow part 1027 of the two ended tube, widening 1028 of the two ended tube, vial 1029 and small scale 1030 measuring vial's weight. The pipe 1031 is operable to carry liquid to the container 1032. The scale 1033 is operable to measure liquid in the container. The first line of separation further incudes a second production component's valve 1034 and the subsequent tube. This tube connects the first line of separation with the tube 1035 for production components' separation, connected with previous tube by a valve on its top. The production components' separation section further includes the redirecting tube 1036 equipped with the pump 1039 and matrices 1037 for production components separation. The production components' separation section includes the detection device 1038 operable to control quality and quantity of the production components separation. The tube 1035 for production components' separation with its components is part of a recycle sector of the bioreactor system. The tube 1035 for production components' separation contains the valve 1040 for the redirecting tube of the production components back to the production area, and the valve 1041 for the redirecting tube for the production components' separation. The tube 1035 for production components' separation also contains the tube 1042 for redirecting production components back to the production sector in the device, the container 1043 for waste of production components' separation is equipped with the scale 1044, the valve 1045 and the pump 1046 for the redirecting tube of the production components back to the production area.

### 1. Inload Sector

An embodiment provides an inload sector. The inload sector may comprise one or more containers for intake of fluid. The inload sector may further comprise one or more tubes operational to carry fluid from the inload sector to the device sector. The inload sector may also comprise machinery and/or gadgetry operable to provide the device sector with fluids that participate in production process.

In an embodiment one or more containers may be of different shape, and may be made of different material. In an embodiment, each one of the containers may have one or more openings. The openings may be placed anywhere within the container. For inload sector, the openings may preferably be placed on the bottom of container. Placement of the openings may depend on the space available within a container. In an embodiment, the openings may be placed on the sides of the containers. Alternatively, the openings may be placed on the bottom and on the sides of the containers. In an embodiment, the openings may be plain. For example, the openings may be circular or oval in shape. The openings may be any size, shape or form.

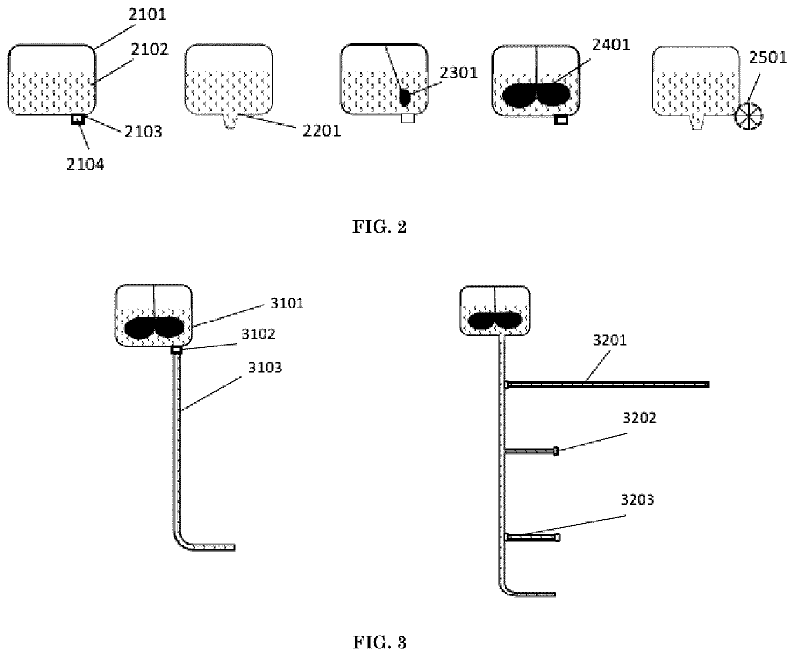

FIG. 2 are schematic drawings of various containers. In this figure, the container 2101 comprises solution 2102. The container includes a plain opening 2103 at the corner of its bottom and the valve 2104 on top of it. In an embodiment, the container includes a long opening 2201 in the middle of its bottom without a valve on its top. The container may comprise the stirring gadget 2301 or the mixing apparatus 2401 operable for stirring or mixing the solution. The container may be equipped with the pump 2501.

In an embodiment, the containers may be directly attached to openings on the device sector. The containers may, but don't have to be, equipped with one or more gadgets and/or apparatuses operable to enforce the flow of inload fluids into the device sector. In an embodiment, the gadgets may be stirring gadgets. In an embodiment, the stirring gadgets may be configured for manual use in order to enforce flow and/or to stir fluid contained within the container. In an embodiment, the apparatuses may be mixing apparatuses and/or gadgets. In an embodiment, the containers may be equipped with one or more pumps. In an embodiment, containers may not contain any apparatus, machine or gadget. From these containers fluid may flow without additional enforcement.

In an embodiment, containers may be connected to one or more tubes directly connected to one or more openings on the device sector. In an embodiment containers may be connected to one or more tubes that are connected to other tube or tubes that are connected to one or more openings on the device sector. On every part of each tube there may be a valve operable to stop and allow the flow of the fluid into the device sector. In an embodiment, there may be a valve on each opening of each filling container that is connected to one or more device's openings and/or tubes. The tubes may be equipped with one or more pumps

FIG. 3 is a schematic drawing of the containers connected to the tubes. The figure on the left shows the filling container 3101 that is connected to the tube 3103 The container is separated from the tube by the valve 3102. The figure on the right shows the container connected to a tube that is connected to other tubes. In this figure, the container is not separated from the vertical tube by a valve. However, the vertical tube is connected to the horizontal tube 3201 that is fitted with a valve on its joint with the vertical tube, and the tube 3202 is fitted with a valve on its end. In this figure, tube 3203 equipped with valves on its beginning and end. This figure shows that valves may be placed on different parts of tubes.

In an embodiment, the tubes' openings may be tipped up so that passing fluids may easily flow down into an appropriate section.

In an embodiment, tubes may, but don't have to, be placed on top part of the appropriate section connected with the inload sector. Preferably, tubes may be placed slight above the maximum fluid level for that section, so there is not reflux of the fluid back to the inload tube.

In an embodiment, inload tubes may be closed after inload of fluids. The tubes may be equipped with valves, screws, rubbers, caps or any other form of closing tools.

In an embodiment, one or more mount pads may be attached to the place, in which the inload sector and the device sector are being connected in order to ensure stability, secure adequate flow of one or more fluids and to prevent leakage and outside interference of various types.

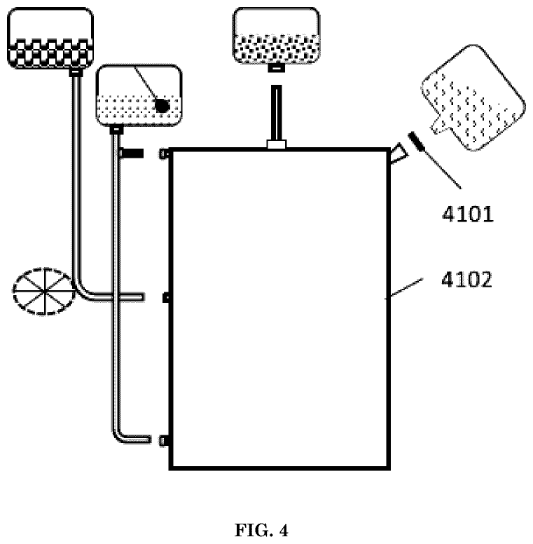

FIG. 4 illustrates an assembly of the inload sector and a device sector. This figure shows the device 4102 fitted with different types of pouring in equipment. In this figure, first on the left is a container that contains a tube equipped with a pump. The tube is configured to be inserted into the opening in the middle section on the device 4102. Second on the left is a container equipped with a stirring gadget and a tube connected to other tubes configured to be inserted into the valves of the openings within the upper and bottom sections of the device 4102. In the middle, there is a container configured to be placed on the tube coming out of the device 4102.

In other embodiments, there may be more pouring in openings for certain sections and these openings may be placed in different sides of the device section. FIG. 4 also shows a side container configured to be pushed into the opening of the device and then additionally secured with mount pad 4101.

### 2. Device Sector

An embodiment provides a device sector comprising at least one unit comprising a plurality of compartments to carry out cell-free reactions. The cell-free reactions may be synthesis or posttranslational modifications, or both.

In an embodiment, the device sector may be a bioreactor device. In an embodiment, the device sector may further comprise the device's moving machinery, apparatuses and gadgetry. The device sector may be a part of an already existing bioreactor.

The device sector may a part of any other suitable machine or system. In an embodiment the device sector may comprise more than one units. The units may be covered by an envelope or envelope-like structure.

### Unit Sections

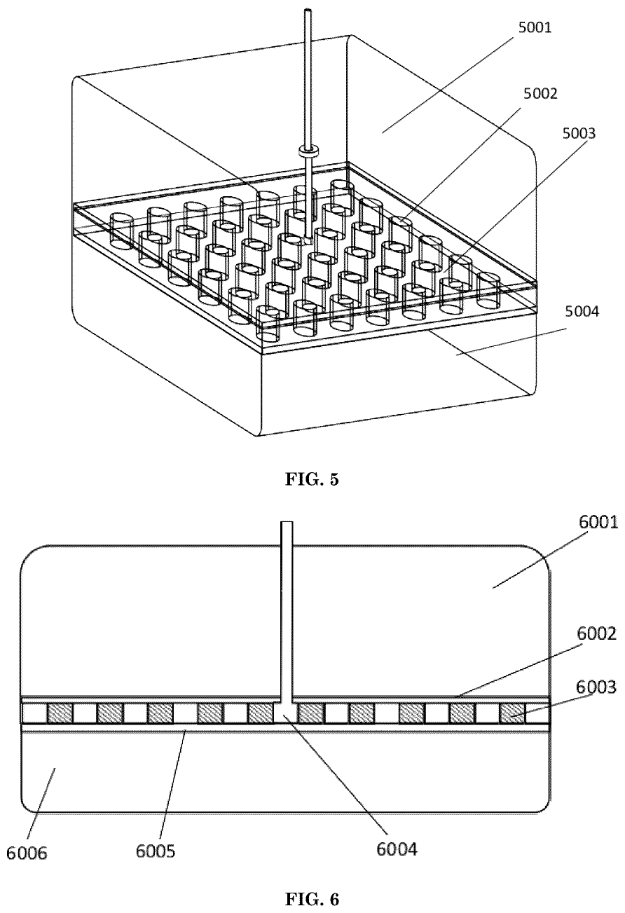

In an embodiment, the unit may consist of four sections. FIG. 5 illustrates front and side view of the unit. The unit comprises the upper section 5001, the middle section 5002, the side section 5003 and the bottom section 5004. In an embodiment, the unit may comprise a tridimensional grid and membranes. FIG. 6 is a cross section view of the unit that shows placement of the sections relative to membranes and each other, when the tridimensional grid is placed on top of the lower membrane. In this figure, the upper section 6001 is placed above the upper membrane 6002 and all other sections. The side section 6004 and the middle section 6003 are placed in between the membranes and among each other. The bottom section 6006 is placed bellow the lower membrane 6005 and all other sections.

Each unit may be assembled in a specific way, in which the sections are configured to complement each other. The upper and lower sections, also referred to herein as supporting sections, are configured to be filled with same or different fluids.

### 2.1 Upper Section

An embodiment provides an upper section of the device. Referring to FIG. 5, the upper section 5001 may be a space between the device envelope or envelope like structure and the upper membrane of the unit. In multiunit devices, the upper and bottom sections may be united. There may be more than one united upper and bottom section. In these embodiments, the upper section may be part of the unit section placed above the upper membrane and under the lower membrane of the unit section above it.

In the units, the components of synthesis and/or posttranslational modification have to be kept in compartments, so they may not be saturated with or flushed away with waste and/or for supporting fluids to be changed over time without having to stop reactions. The upper and lower membranes are configured to keep synthesis and/or posttranslational modification components inside the compartments, add necessities and release waste. The upper and lower membranes may be made of different materials, have different size, pore sizes and design in order to provide as much diversity as possible as well as to comply with laws of nature. The upper and lower membranes may be different within one unit, or different units.

### 2.2 Side Section

An embodiment provides a side section of the device. Referring to FIG. 5, the side section 5003 may consist of the inside of a scaffold. The side section may contain or may be placed under the upper membrane.

### 2.2.1 Scaffold

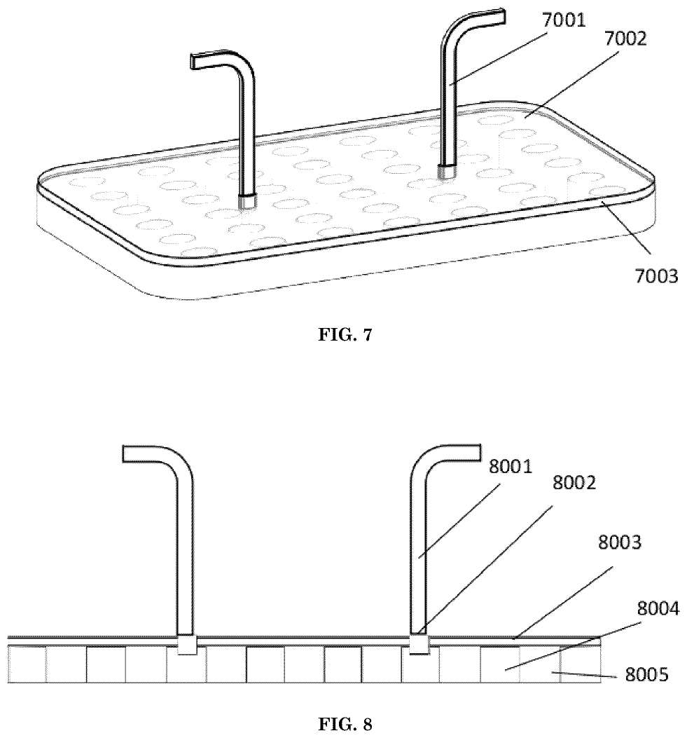

An embodiment provides a scaffold. As used herein, the scaffold is a structure in the middle of the unit. FIG. 7 is a front and side view of the side section of the unit that includes a scaffold. Referring to this figure, the scaffold consists of two tubes 7001, the upper membranes 7003 and the tridimensional grid 7002. The scaffold tubes 7001 may be connected to one or more tridimensional grids 7002.

In embodiment, the upper membrane may be an integral part of the scaffold. In embodiment, the upper membrane may be an individual part of the unit. In embodiment, the upper membrane may be an integral part of the scaffold and part of the unit. The upper membrane may be placed on top of the tridimensional grid. The scaffold tubes and the tridimensional grids may be connected by scaffold tube openings. In an embodiment, scaffold tube openings may be placed in the upper membrane. In another embodiment, the scaffold tubes openings may be placed in the tridimensional grid. In yet another embodiment, the scaffold tubes openings may be placed in the upper membrane stretching all the way to the tridimensional grid. Once assembled, a scaffold tube, its opening and the tridimensional grid may present a continuous structure that enables the flow of fluid or fluids, passing through it, to get to and/or go through the side section. This structure may enable fluids to be inloaded to and/or unloaded of the grid through scaffold tubes.

FIG. 8 is a cross section view of the scaffold assembly. Referring to this figure, the tubes 8001 are inserted into the tube openings 8002 placed in the upper membrane 8003. The tube 8001 ends in the side section 8004. This tube configuration enables fluid flow through the tubes into the side section. This figure also shows interrelationship between the middle section 8005 and the side section 8004 within the scaffold, i.e., their placement one among the other, when the tridimensional grid is filled with a production solution.

In an embodiment, the entire side section may be made of the same or different material. The side section may comprise the scaffold tube or tubes and/or the tridimensional grid or grids. In some embodiments, the entire side section may be made of the same material. In other embodiments, the scaffold tubes may be made of one type of material and the tridimensional grid may be made of another. In other embodiments, the scaffold tubes and top of the tridimensional grid may be made of one material and the grid structure's or structures' walls may be made of another. Also, in some embodiments, scaffold tubes, top of the grid's structure or structures and more or less of grid structure's or structures' walls may be made of one type of material and the rest of the grid's structure's or structures' walls may be made of another.

### 2.2.1.1 Scaffold Tubes

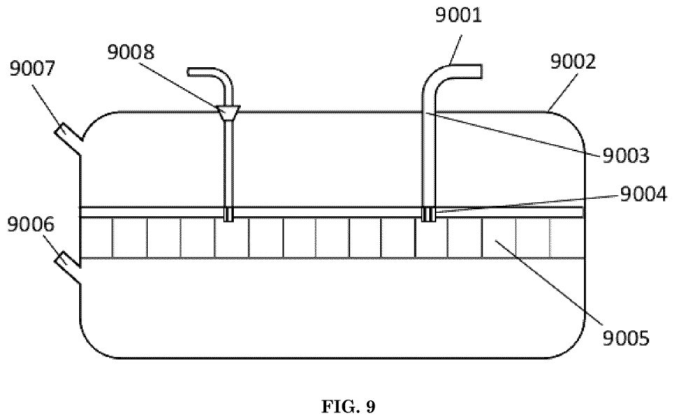

In an embodiment, the scaffold may comprise one or more tubes. FIG. 9 is a cross section view of the scaffold tubes that run through the unit. Two scaffold tubes 9001 are shown within the scaffold in this figure. The portions of these scaffold tubes are placed outside of the device envelope 9002 and stretch through scaffold tubes openings 9003. The tubes enter the tridimensional grid 9005 through the tridimensional grid scaffold tubes' openings 9004 and end on the top of the tridimensional grid 9005. Within the scaffold tube or tubes 9001 are placed in vertical position, while the tridimensional grid 9005 is placed in horizontal position. One part of the scaffold tube may be within the device envelope, while the other part may be outside of it. Two angular scaffold tubes may enter the device through the openings for scaffold tubes in the device envelope. One tube may be secured with a mount pad 9008 inserted between the tube and the scaffold tube opening and another tube may be placed into the device without a mount pad. The scaffold tubes may enter the tridimensional grid by its openings in form of bolts. On side of the envelope, there may be pouring in and pouring out openings 9007 for the upper, middle and bottom sections.

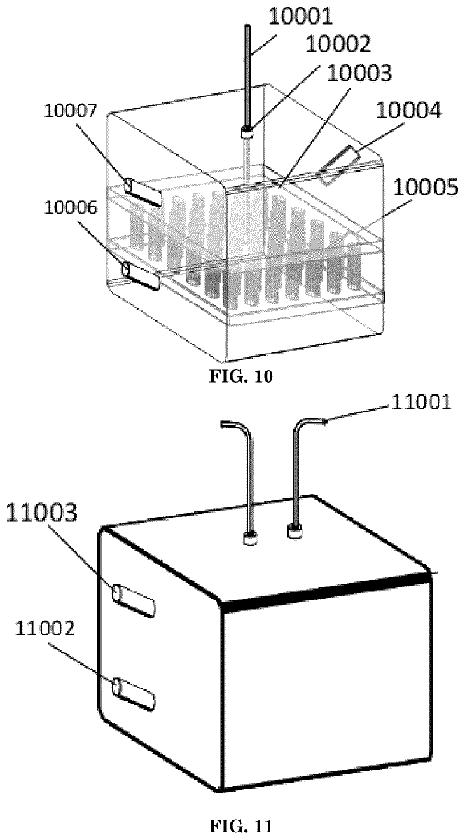

The outside part of the scaffold tubes may be big enough to be grasped by hands, machine and/or gadget and be operable to be moved up and down. The part of the scaffold tube being grasped may be a handle part. The handle part of the scaffold tube may be embodied in various forms as shown in FIGS. 10-13.

FIG. 10 is an outside view of the device through its clear envelope. Referring to this figure, the device includes only one straight scaffold tube 10001. The tube starts outside of the unit and ends at the tridimensional grid 10003. This tube is fitted with a mount pad 10002 at the top of the unit and bolted in the opening of the tridimensional grid. On sides of the envelope, there are four openings, two pouring in openings 1006 and two pouring out openings 1007 for the upper, middle and bottom section.

FIG. 11 illustrates an exterior of the device equipped with angular tubes. Referring to this figure, the tubes are fitted with mount pads at the top of the device. The handle part 11001 is an outside part of the scaffold tube. On one side of the envelope, there are two pouring in and pouring out openings: one opening for the upper middle sections 11003 and one opening for the bottom section 11002. In an embodiment, the handle parts may be curves of angled scaffold tubes. In an embodiment, the handle parts may be equipped with one or more scaffold tubes.

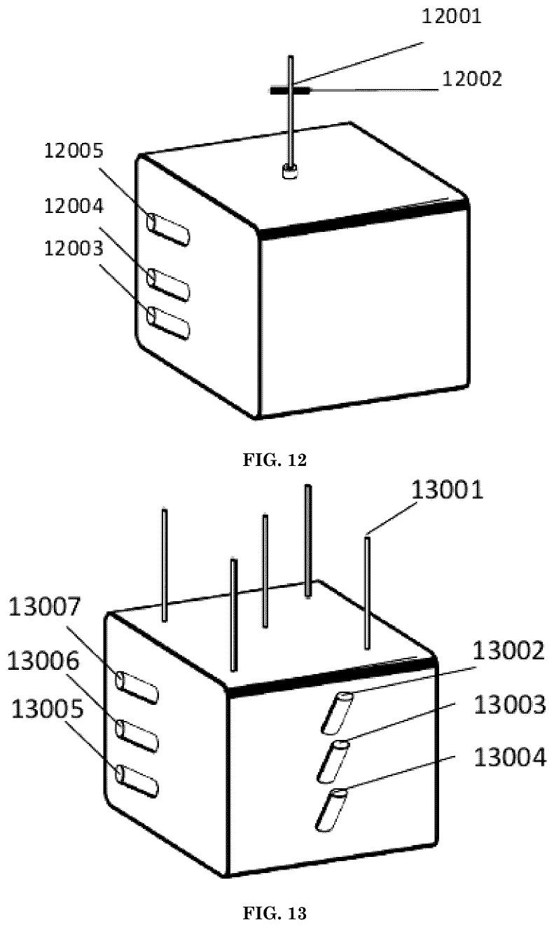

FIG. 12 illustrates an exterior of the device having pouring in and pouring out openings for each section. Referring to this figure, there is one straight scaffold tube 12001 equipped with a handle 12002 in its handle part. The scaffold tube is fitted with a mount pad at the joint with a device. On one side of the envelope, there are three pouring in and pouring out openings for the upper 12003, middle 12004 and bottom 12005 sections of the device.

In an embodiment, scaffold tubes may be of various shapes, forms, sizes, and designs. The scaffold tubes may be made of different materials. The scaffold tubes may satisfy other characteristics. In general, scaffold tubes should be firm and big enough to enable movement of the grid up and down and to provide enough space for smooth passing of fluids and in amount and speed required for reasonable functioning of the production process. If there is one scaffold tube, it may be preferably placed in part of the tridimensional grid that would enable parallel movements of all its parts. If there are more scaffold tubes, the tubes may be preferably laid out in a manner that would put equal pressure on every scaffold tube and enable parallel movements of all parts of the tridimensional grid 13001, such as shown in FIG. 13.

FIG. 13 illustrates an exterior of the device having multiple scaffold tubes. In this figure, there are several straight scaffold tubes 13001. In some embodiments, the scaffold tubes may include handles and/or poles. Referring to FIG. 13, the tubes are attached to the device without mount pads at its top. On two sides of the envelope, next to each other there are three pouring in openings for upper 13002, middle 13003 and bottom 13004 sections. There are also three pouring out openings for upper 13007, middle 13006 and bottom 13005 sections.

In an embodiment, there may be different scaffold tubes contained within one scaffold. In an embodiment, the scaffold tubes may differ in size. In an embodiment, the scaffold tubes may differ in shape. In some embodiments, the scaffold tubes may differ in material they are made of. In an embodiment, the scaffold tubes may be secured in place by mount pads. In an embodiment, the scaffold tubes may be secured in place without mount pads. In an embodiment, the scaffold tubes openings may be the size of the scaffold tube diameter and without mount pads. In an embodiment, the mount pads may not be included and the scaffold tubes' vertical position may be secured only by their placement in the tridimensional grids.

In an embodiment, the scaffold tubes may be made of one or more pieces. In some embodiments, the scaffold tubes may be made of one piece. In an embodiment, the scaffold tubes may be straight all over their length. In an embodiment, the scaffold tubes may be angular scaffold tubes, where angles are placed outside of the device's envelope. The angles may be more or less steep. The scaffold tubes design and placement may enable easy flow of fluids through them. In an embodiment, the scaffold tubes may have holes on them apart from top and end of the scaffold tube. These holes may serve to enable more efficient supply of fluids to the desired sections and may be placed only inside of that section on an adequate place within the scaffold tube.

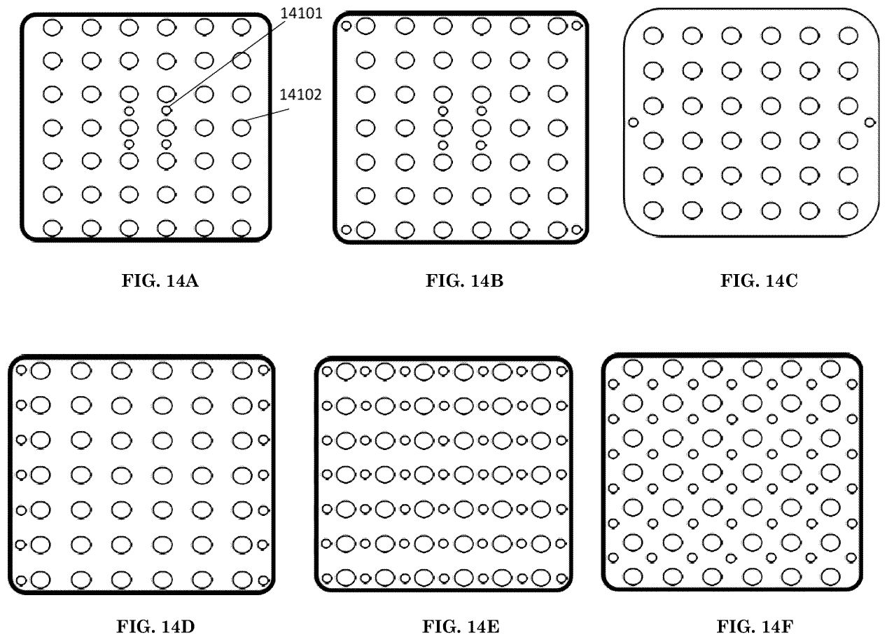

The scaffold tube or tubes, or more precisely their starting or end portions, as well as their openings may be placed anywhere on the surface of the grid. FIGS. 14A-14F illustrate positions of the scaffold tubes openings on the tridimensional grid. FIG. 14A illustrates four tube openings 14001 in the middle of the tridimensional grid containing wells 1402. FIG. 14B illustrates four scaffold tube openings in the middle and four scaffold tube openings in the corners of the tridimensional grid. FIG. 14C illustrates two scaffold tube openings at the ends of the tridimensional grid. FIG. 14D illustrates multiple scaffold tube openings across two ends of the tridimensional grid. FIG. 14E illustrates multiple scaffold tube openings positioned next to each well and across the end of the tridimensional grid. FIG. 14F illustrates many scaffold tube openings between wells and across the ends of the tridimensional grid.

The scaffold tube or the scaffold tubes may preferably be positioned in parallel to each other. In an embodiment, the scaffold tube or tubes may be placed in the middle of the grid, so that their distance from each other is equal to the distance from the ends of the grid as shown in FIGS. 14A and 14B. In an embodiment, the scaffold tube or tubes may be placed at the ends of the grid as shown in FIGS. 14B, 14C and 14D. In an embodiment, the scaffold tube or tubes may be placed all throughout the middle of the grid as shown in FIG. 14E. In an embodiment, there may be numerous scaffold tubes at the angles of each compartment of the grid as shown in FIG. 14F. Also, in some other embodiments, the scaffold tubes may be staggered in different shapes on the surface of the grid. There may be other arrangements for positioning scaffold tube or tubes within the device.

Top of the scaffold tube or tubes may indicate the beginning and/or the end of the side section. In a device with multiple units, different side sections may be connected with scaffold tubes. In this case, top of the scaffold tube that connects two side sections may mark the end of the side section of the upper section of these units. If there is more than one scaffold tube, there may be two or more ends or beginnings. At these ends or beginnings, inload and/or unload tubes may be attached.

### 2.2.1.2 Mount Pad

An embodiment provides a mount pad in-between the scaffold tube and the device envelope. As shown in FIG. 9, each scaffold tube may have a mount pad 9008 that closes the gap between that scaffold tube and the device envelope. The mount pad may be placed to make sure that the scaffold is not moved and/or to prevent contamination as shown in FIG. 9. The mount pads may be placed into the scaffold tubes openings. The mount pads may be hitched, twisted, screwed or in any other way placed into an appropriate opening. The mount pads may be made of any material, in any shape or form that may in a reasonable manner enable proper placement of the scaffold tube within the scaffold tube opening in the envelope. In an embodiment, the mount pad may be made of rubber. In an embodiment, the mount pad may be made of silicone material. In an embodiment, the mount pad may be made of plastic. In an embodiment, the mount pad may be made of stainless steel. In an embodiment, the mount pad may be a cylindrical item placed between the scaffold tube and the device's envelope. In an embodiment, the mount pad may be a screw that is bolted onto the proper part of the scaffold tube.

Besides securing the scaffold tube's placement in the right position, a mount pad or pads may also be used for any and/or all other elements of the machinery to be secured in their place. Referring to FIG. 4, a mount pad 4101 may secure proper placement of an inload container inside the inload opening in the device. In an embodiment, the mount pad may secure proper placement of the unload scaffold tube inside the unit's unload opening.

### 2.2.1.3 Tridimensional Grid

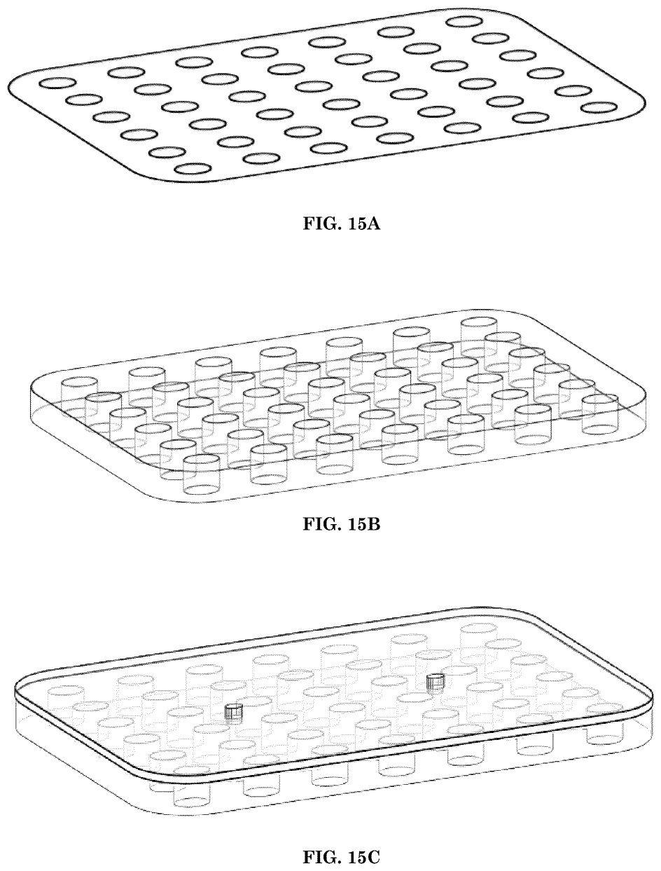

An embodiment provides a tridimensional grid comprising a plurality of compartments. The tridimensional grid may be a structure having a bottom, and in some embodiments, also an upper part in the form of a grid. FIGS. 15A-15C illustrate front and side views of tridimensional grid structures.

In an embodiment, the tridimensional grid plate may be a solid plate having one or more pieces cut out of the plate. The cut-outs may be all in the same or different shapes. FIG. 15A illustrates the grid plate in shape of a rectangle with round edges carrying six rows and seven columns of round shaped grid elements. In this figure, the plate is on the bottom of the tridimensional grid. Frames of the grid's plate and some of its cuttings may be developed into tridimensional structures by raising walls on top of them. FIG. 15B illustrates the grid plate and side walls. In this figure, on top of the grid plate are built-up side walls that connect the grid's plate with the upper part of the grid. FIG. 15C illustrates the tridimensional grid with an upper membrane. This figure shows the complete tridimensional grid with an upper membrane placed on its top. The upper part of the tridimensional grid may be in different forms. The upper part may be empty. The upper part may contain a frame that may, but does not have to, contain a membrane. The upper part may contain a grid's plate. The upper part may contain items, such as wires, walls and/or other elements that provide support for one or more scaffold tubes and/or their openings. The upper part may contain an upper membrane.

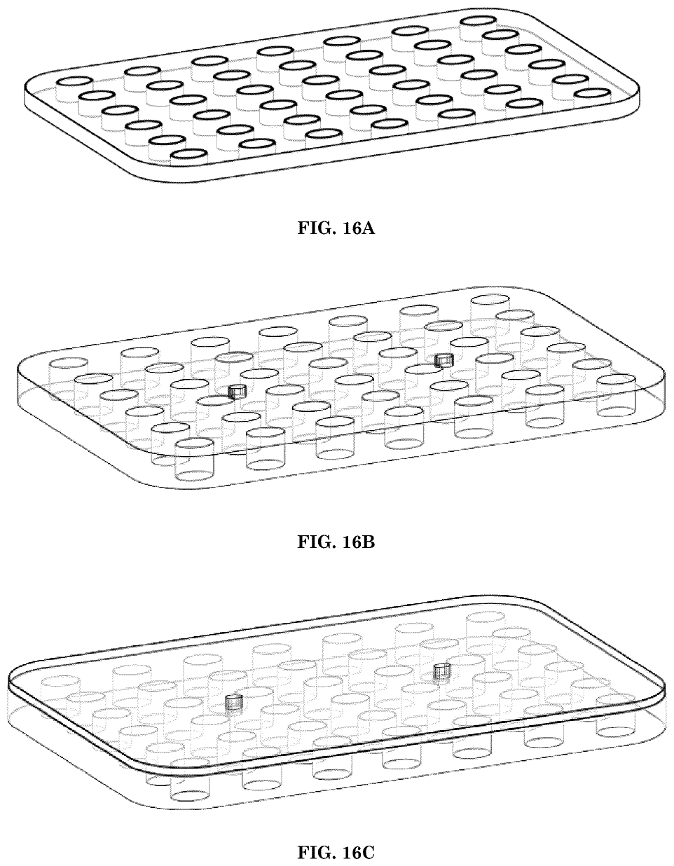

The top of the grid, or in some embodiments, on the top of the grid, may be an upper membrane that separates the middle and the side section from the upper section. FIGS. 16A-16C illustrate different kinds of the upper part of the tridimensional grid. In an embodiment, the top of the tridimensional grid may be hollow and the upper membrane may be placed on it. FIG. 16A illustrates an empty upper part of the tridimensional grid. In an embodiment, the upper membrane may be an integral part of the tridimensional grid's structure. FIG. 16B illustrates the upper membrane and the tridimensional grid made as one piece. This figure shows the upper part of the tridimensional grid is in the form of an upper membrane as its continuous integral part and that it is all made as one piece. In an embodiment, the tridimensional grid's top may be hollow and the upper membrane may be attached to the top of the grid. FIG. 16C illustrates an upper membrane attached to the tridimensional grid. This figure shows the upper part of tridimensional grid is in the form of an upper membrane, which presents its integral part that is attached to the rest of the tridimensional grid.

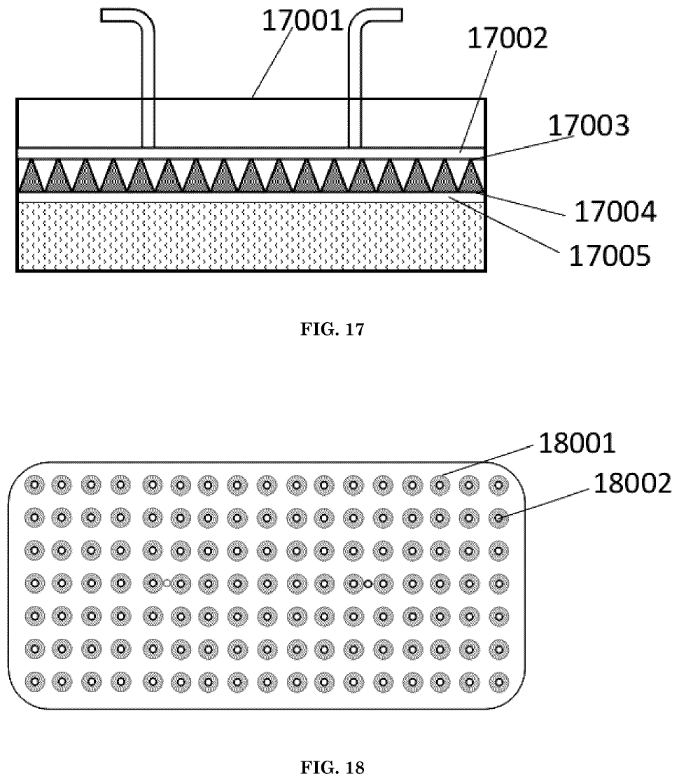

In an embodiment, the upper part of the grid may be different than the bottom part. In some embodiments, there may be different grid's elements present on the grid's plate and as semipermeable parts of an upper membrane. Taking this into consideration, in some embodiments, wells' walls may be tilted towards the narrower elements. Also, wells' walls may have different shapes and widenings and/or narrowing in some places. These configurations of the wells wall may affect the area around the wells in the tridimensional grid. The wells may also have different shapes and sizes. Wells may be in the shape of a spike, triangle, rectangle, or in any other shape. The shape of the wells may also affect the shape, size and volume of a side section, which may be narrowed and/or widened accordingly. FIG. 17 is a side view of the device unit having the tridimensional grid containing two different grid's plates. In this figure, the device 17001 contains the grid plate 17003 in the upper part of the tridimensional grid and the grid's plate 17004 in the bottom of the tridimensional grid. These plates are placed one on the top of the tridimensional grid straight under the upper membrane 17002 and the other on the bottom of the tridimensional grid, on the top of the lower membrane 17005. The upper grid plate contains grid's elements that are smaller in size than the grid's elements of the lower membrane. For this reason, the side wells' walls are tilted toward the upper grid's elements.

The grids' design may vary among different devices. The grids' design may vary within the same device. The grids' design may vary within the same tridimensional grid.

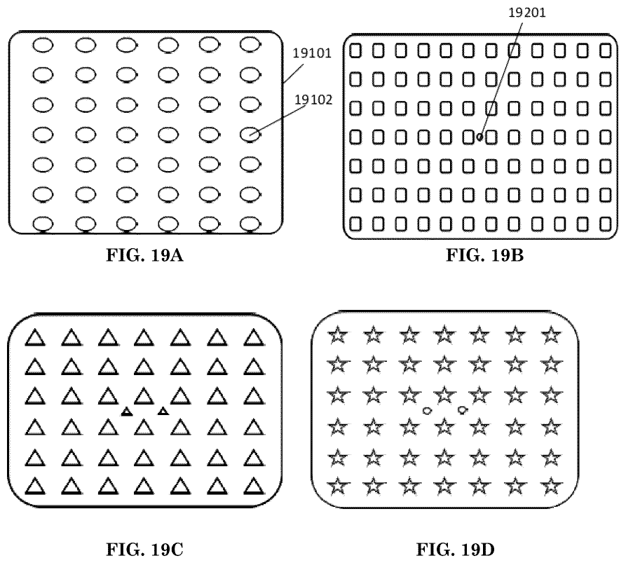

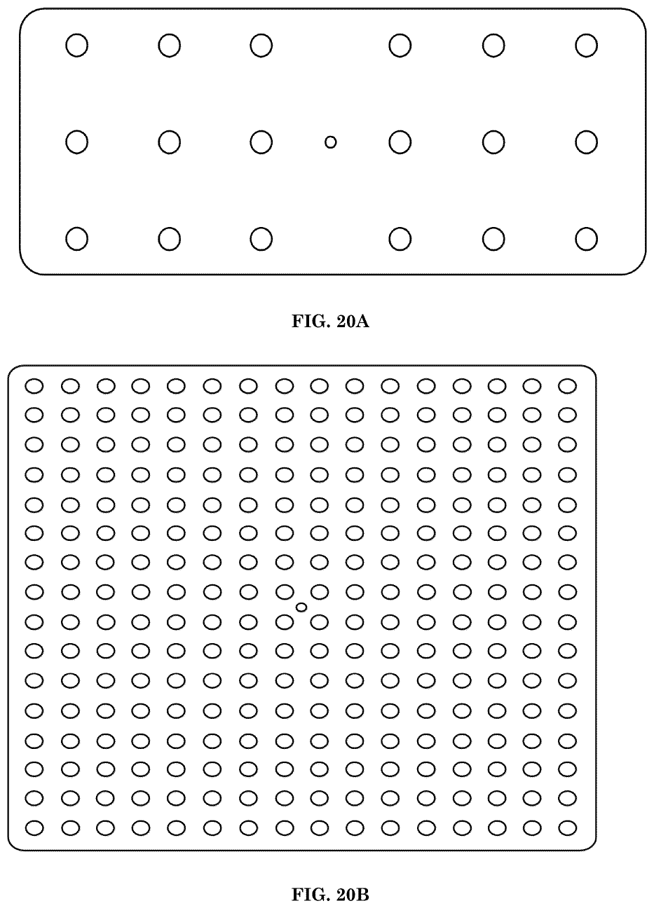

FIG. 18 is a top view of the tridimensional grid containing two different grid's plates. In this figure, the tridimensional grid contains the grid plate grid's element 18001 and the upper grid plate grid's element 8002. The top of the tridimensional grid contains the upper grid plate with narrow round shaped grid's elements that stretch down to the grid's elements in grid's plate in form of semipermeable wells' walls. Frames of the cut-out parts of the grid's plate are referred to herein as grid's elements. FIGS. 19A-19D illustrate various shapes of the grid elements. In some embodiments, grid's plates may contain only well openings, while in other embodiments grid's elements may also be scaffold tube openings. In some embodiments, the scaffold tube openings may be of same or of different shape as well openings. FIG. 19A illustrates round shaped grid's elements 19102 within the grid's plate 19101. FIG. 19B illustrates the rectangle shaped well openings and the round scaffold tube opening 19201. FIG. 19C illustrates the triangle shaped grid's elements. FIG. 19D illustrates the star shaped wells' openings and round scaffold tube openings. The grids' elements may have various designs and shapes. The number of wells in a tridimensional grid may also vary. The tridimensional grids with more wells may provide more production mixture to be processed, while grids with less wells inside them may provide more side section fluid for the production mixture. FIGS. 20A-20B illustrate the grid plates of different size, designs and number of well openings. FIG. 20A illustrates the grid plate with the low number of wells openings. Low number of wells openings may provide expanded space between the wells, which allows more the side section to be poured into that tridimensional grid. FIG. 20B illustrates the grid plate with the high number of wells' openings. Large number of wells and wells openings may provide wells' space, which may enable more production mixture to be processed. The inner and outer sides of the tridimensional grid's structure, i.e., its depth, may be its side walls.

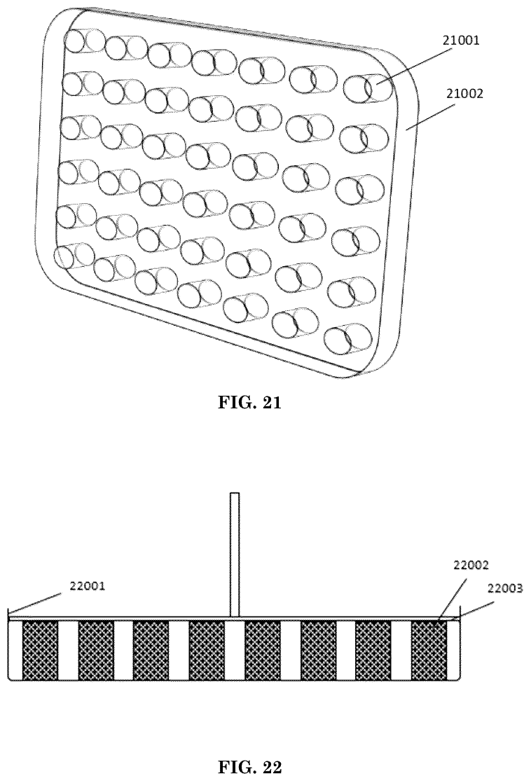

FIG. 21 is a contrasting left view of the side walls of the tridimensional grid. In this figure, the tridimensional grid contains the tridimensional grid's side wall 1001 and well's wall 21002. This figure shows the side walls surrounding the grid's elements and the side wall framing of the grid's plate. There may be one wall surrounding the frame of the grid's plate. The tridimensional structures that include side walls built up on top of grid's elements and having an upper part as top of the tridimensional grid and, in some embodiments, an upper membrane, are referred to herein as wells or holes. The side walls of the wells may be made of a semipermeable membrane. The side walls of the wells may provide mixture that is inside of the well with fluids that are inside of the tridimensional grid's structure and the other way around. Only materials that may penetrate pores of semipermeable membranes may be exchanged. The volume of the compartments and the side section within one tridimensional grid may depend on the dimensions of that tridimensional grid and the height and the width of the wells' walls of the tridimensional grid's structure. Preferably, the walls that surround grid's plate's frame are of the same height as the wells' walls. In some embodiments, the walls that surround the grid's plate's frame may be higher or lower than the wells' walls.

FIG. 22 is a cross section view of an upper membrane in the tridimensional grid. In this figure, the walls 22001 of the tridimensional grid's plate are higher than the wells walls 22002, and the upper membrane 22003 is placed into the tridimensional grid so it lays directly on top of the wells.

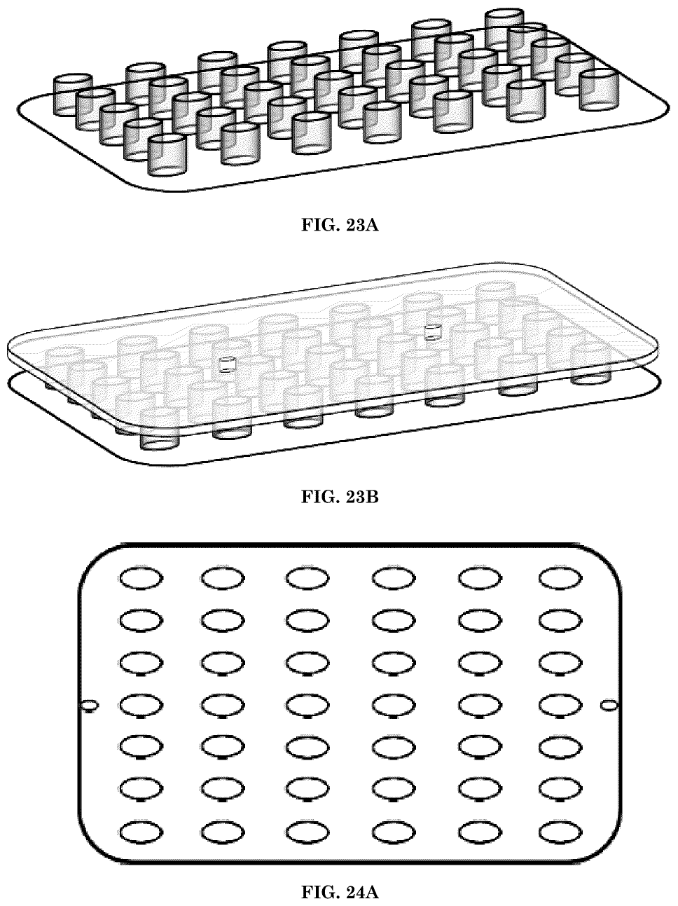

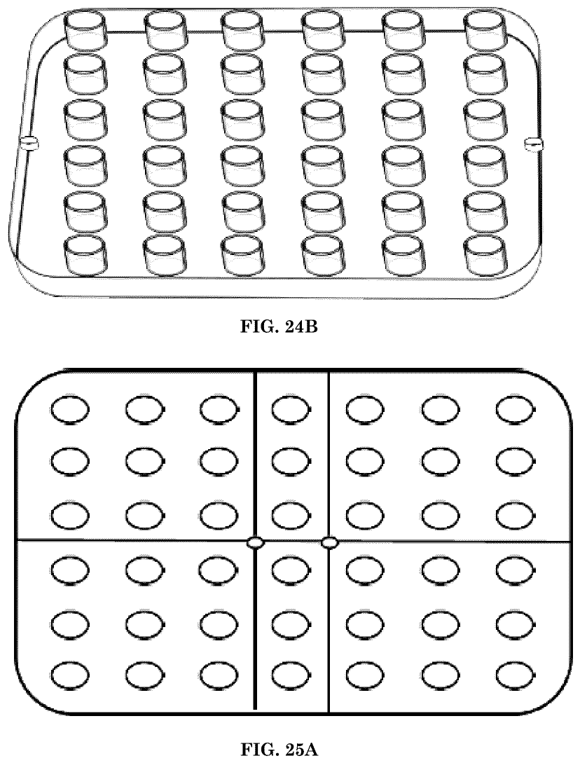

In an embodiment, there may be only the wells' walls within the tridimensional grid and none of the tridimensional grid's side walls. In an embodiment, the upper membrane may be placed on the wells' walls. FIGS. 23A-23B illustrate the tridimensional grids without the tridimensional grid's side wall. FIG. 23A illustrates the tridimensional grid containing only the grid's plate and the wells' walls. FIG. 23B illustrates the tridimensional grid containing only the grid's plate and wells' walls covered with an upper membrane

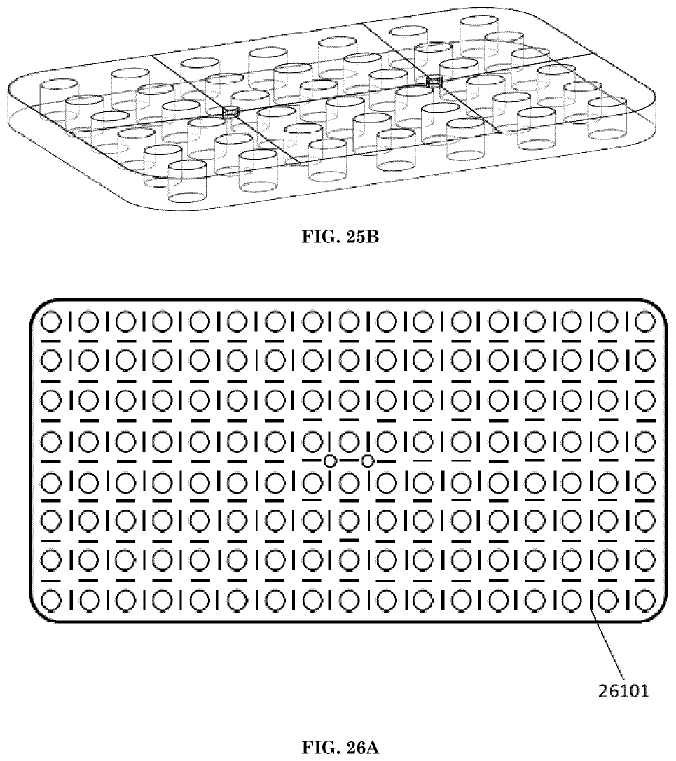

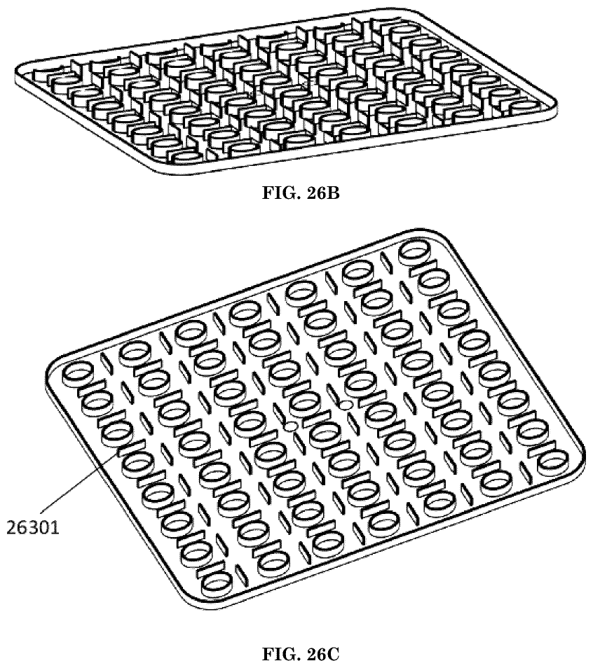

In an embodiment, scaffold's tubes openings may also be considered as the tridimensional grid's elements. In the upper membrane, there may be openings for the scaffold tube or tubes. In the tridimensional grid's structure, the scaffold's tubes' openings may, but don't have to, be present. FIGS. 24A-24B illustrate tridimensional grid with tube openings connected to the tridimensional grid's side wall. The scaffold tube openings are positioned at the left and right sides of the tridimensional grid's side wall. FIG. 24A is a top view of the tridimensional grid with tube openings positioned at the tridimensional grid's side wall. FIG. 24B is a front and side view of the tridimensional grid with tube openings positioned at the tridimensional grid's side wall. FIGS. 25A-25B illustrate the tridimensional grid with the tube openings connected with wires. Wires coming out of four sides of the tridimensional grid's wall are holding two scaffold tubes' openings at a proper place by the rings at their middle in which the scaffold tubes openings are placed in. FIG. 25A is a top view of the tridimensional grid having the tube openings connected with wires. FIG. 25B is a front and side view of the tridimensional grid having the tube openings connected with wires. The scaffold's tubes' openings may be integral parts of the tridimensional grid's structure attached to it as shown in FIGS. 24A-24B or may be kept in place by carrying walls or wires as shown in FIGS. 25A-25B. FIGS. 26A-26C illustrate separating walls between the wells. FIG. 26A is a top view of the grid with separating walls 2601 between the wells. FIG. 26B is a side and front view of the grid with separating walls between the wells. FIG. 26C is a top, side and front view of the grid with separating walls 26301 between the wells. As shown in these figures, the inside of a tridimensional grid may be hollow and it may, but does not have to, contain additional separating walls between the wells.

In an embodiment, the inside of a tridimensional grid's structure may be hollow. In an embodiment, there may be separators between each well. In an embodiment, the grid's elements may be rectangle-shaped and the separators may be placed in parallel with the walls of the rectangles. In an embodiment, the grid's elements may be round-shaped and the separators may be placed at a certain angle with the side walls of the tridimensional grid's structure. In that way, the providing platforms of the side section or sections may be divided into countless small providing platforms each providing same or different fluids and/or waste management options as the other ones. The walls may be the same height or shorter than other side walls of the grid. The walls may be attached to the grid's plate, the wells' walls and/or the upper part of the tridimensional grid.

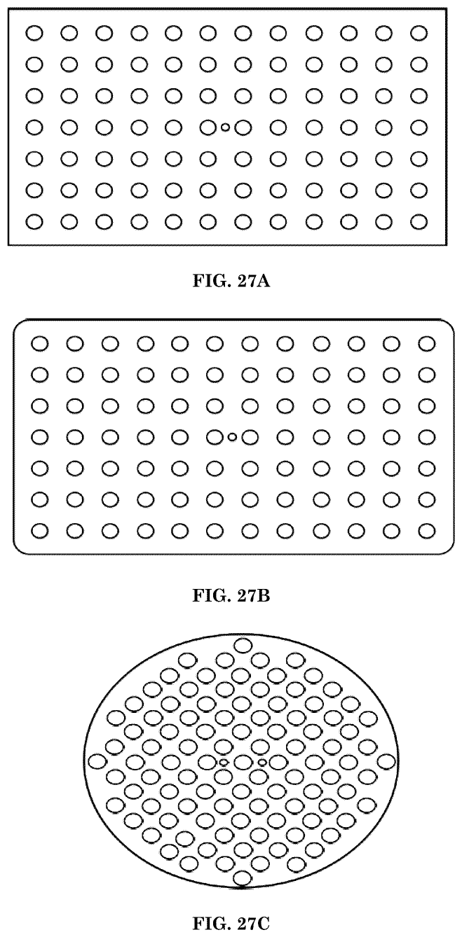

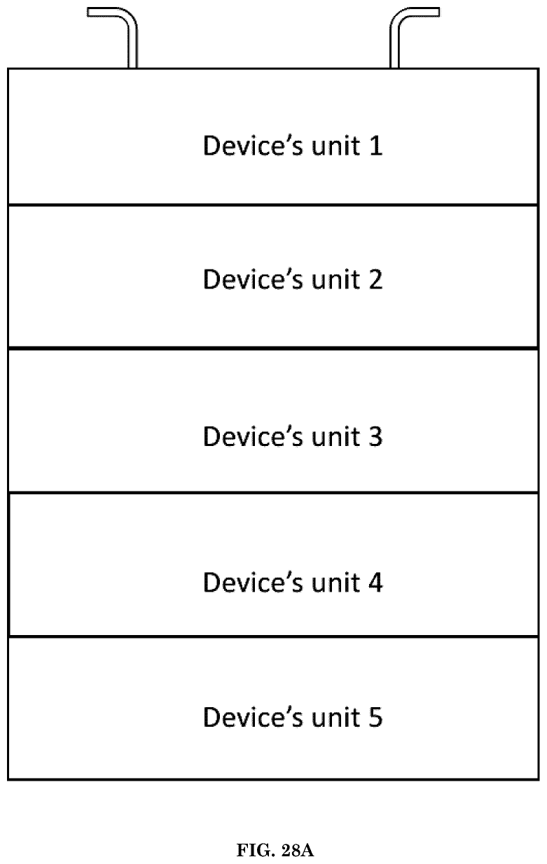

In an embodiment, the upper section and the side section may be united. In an embodiment, the wells' walls may be covered with caps that may, but do not have to be, made of semipermeable material. In an embodiment, the upper membrane may not be continuous, but may be in a discontinuous form, placed on top of each well's wall, that makes its part. In this embodiment, the tridimensional grid may, but does not have to, contain the tridimensional grid's side walls. FIGS. 27A-27C illustrate various shapes and designs of the grid's plate. The grid's plate frame and the entire grid's plate may have different shapes in order to accommodate the shape of a device. FIG. 27A illustrates the rectangle-shaped grid's plate. FIG. 27B illustrates the rectangle-with-round-edges-shaped grid's plate. FIG. 27C illustrates the round-shaped grid's plate. The tridimensional grid's size and shape may correspond to the size and shape of the device, or unit. The tridimensional grid's width may be almost as wide as the device, i.e., wide enough to stretch from one envelope's wall to the other. At the same time, the tridimensional grid's may be narrow enough to be moved up and down throughout the device. The tridimensional grid's height may provide enough space for the bottom and upper sections as it may be necessary for functioning of these sections, and to enable tridimensional grid's movement through the device. At the same time, tridimensional grid's height may provide enough space for the side and middle sections' rational functioning during the production process.

### 2.2.1.4 Upper and Lower Membranes

An embodiment provides an upper and lower membranes. The upper membrane may be placed in-between the upper section and the side and/or middle section. The lower membrane may be placed in-between the middle and/or side section and the bottom section.

In an embodiment, at least parts of the upper and lower membrane adjacent to the production mixture containing section and wells' walls may be in the form of semipermeable membranes.

In an embodiment, the upper and/or lower membrane may be attached, cast or in any other way connected to the handles so the upper and/or lower membranes may be moved separately. These handles may help move the entire membranes and/or carry certain parts of the membranes.

In an embodiment, parts of the scaffold tubes and/or the entire scaffold tubes may be connected to the upper membrane and the tridimensional grid in a way that the upper membrane cannot be moved separately from the tridimensional grid's structure. One example of this may be when there are scaffold tube's openings in the form of bolts on the upper membrane and the tridimensional grid beneath it. The bolted part of the scaffold tube may be bolted into both of these openings and the upper membrane and the tridimensional grid may be carried with it. In some embodiments, parts of the scaffold tubes and/or the entire scaffold tubes may be connected to the upper membrane and the tridimensional grid in a way that the upper membrane may be moved separately from the tridimensional grid's structure. In an embodiment, parts of the scaffold tubes and/or the entire scaffold tubes may be connected to the tridimensional grid and one or more handles may be connected to the upper membrane, so that the upper membrane may be moved separately from the tridimensional grid's structure. In an embodiment, the handles may be separate from each other. In an embodiment, handles may be tied together by poles, wires and/or any other connecting item. If the scaffold's tube or its part is connected only to the upper membrane, then that upper membrane may need to be integral part or attached to the tridimensional grid. If the scaffold tube or its part is connected only to the tridimensional grid, then the upper membrane may need to have one or more other tubes, handles and/or poles on it in order to be moved.

### 2.3. Middle Section

An embodiment provides a middle section comprising a plurality of the compartments to hold a production mixture. The compartments may be within the tridimensional grid. The compartments may be wells. Walls of the wells may be partially or entirely semipermeable.

Referring to FIG. 5, the middle section 5002 may be placed between the bottom and upper sections and, at times, among the side section 5003. The middle section may be on top of the lower membrane. When the tridimensional grid is pulled up, the middle section may be a space between the lower membrane and bottom of the tridimensional grid. When the tridimensional grid is placed on top of the lower membrane, the middle section may consist of wells that are inside of a tridimensional grid. These wells may be filled with middle section's fluid, also referred to herein as production mixture.

### 2.4 Bottom Section

An embodiment provides a bottom section of the device unit. Referring to FIG. 5, the bottom section 5004 is in most embodiments a space between the device's envelope and the lower membrane. The bottom section may be connected with the middle section and, at times, with the side section by a lower membrane that is placed on the top of the bottom section. In a multiunit device, one or more bottom and upper sections may be united. In this case, the bottom section may present the part of the device's unit that is placed under the lower membrane and above the upper membrane of device's unit beneath it.

### 2.5 Units

In an embodiment, the device sector may comprise one or more units. In an embodiment, a unit may comprise four sections, e.g., an upper section, a middle section, a side section and a bottom section. The upper section, the side section, and the bottom section are also referred to herein as supporting sections, i.e., sections that do not contain production mixture. In an embodiment, some of the supporting sections may be united.

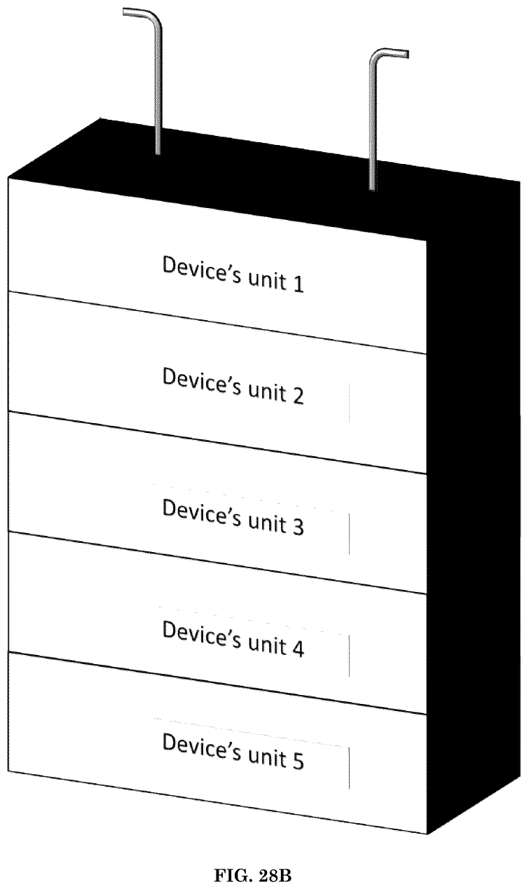

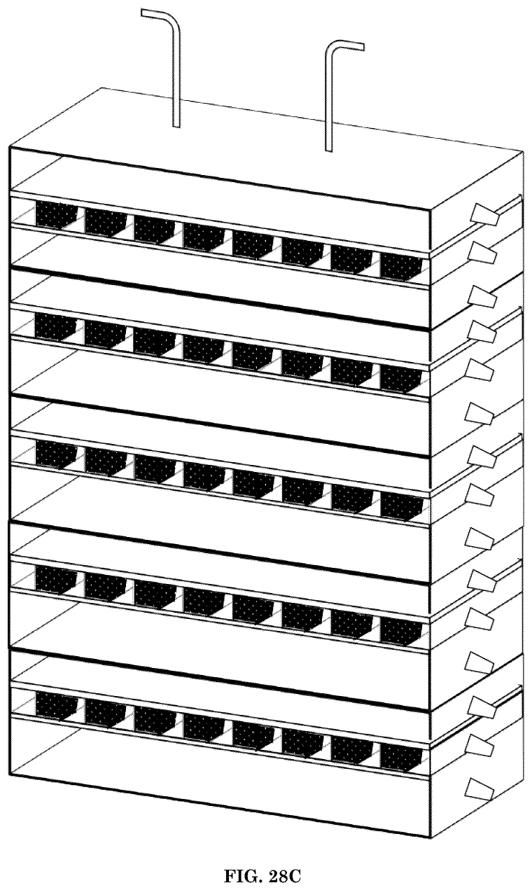

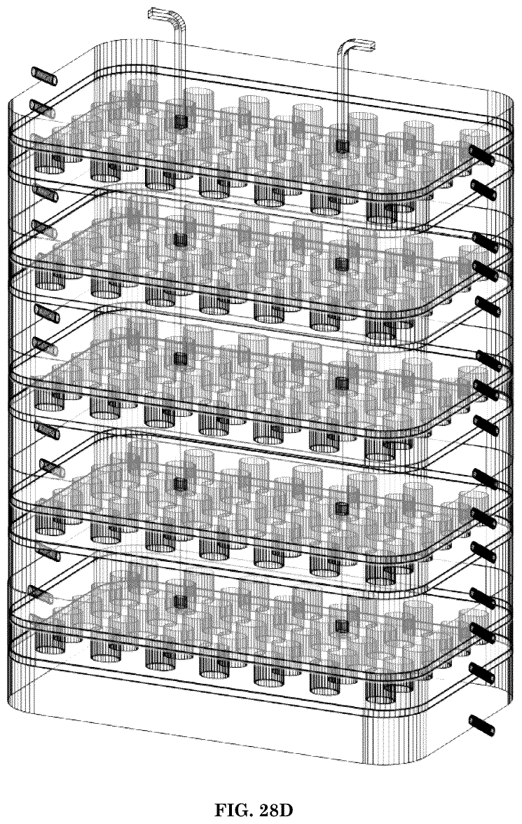

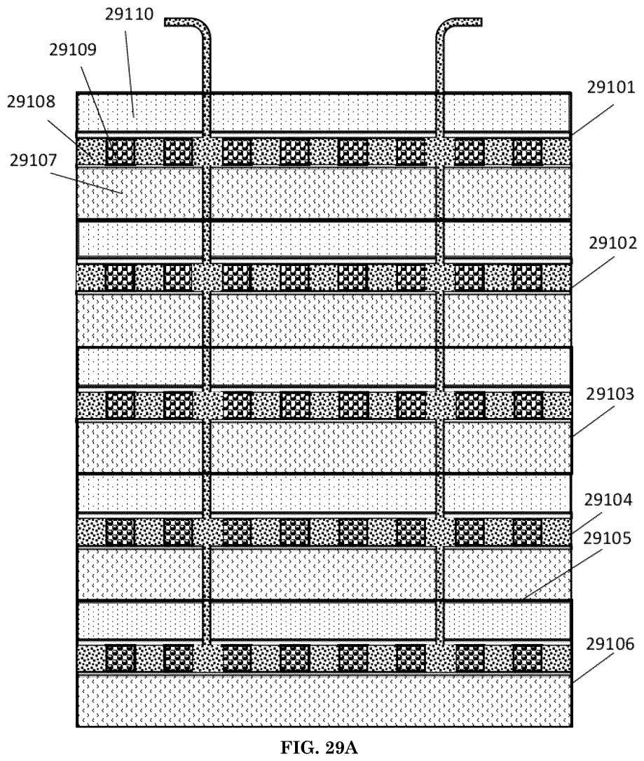

In an embodiment, the device sector may consist of a single unit. In an embodiment, the device sector may consist of multiple units. The multiple units may be placed one under another. The multiple units may be placed one next to another. The multiple units may be placed and distributed in space any other way. In devices made of multiple units, each unit may be marked by one or more numbers and/or letters. For example, device 1, device 2, device 3, etc. FIGS. 28A-28D illustrate different perspectives of multiunit devices. FIG. 28A is a scheme of multiunit device. This figure shows five units that are placed one on top of the other and having tubes going out of the device. FIG. 28B is a 3D exterior view of the multiunit device. This figure shows five units that are placed one on top of the other and having tubes going out of the device. FIG. 28C is a 3D exterior view of the empty multiunit device. FIG. 28D is a 3D exterior and interior view of the empty multiunit device.

In an embodiment, units may be marked in different ways. For example, the units may be marked starting from bottom to the top. The units may be marked from top to the bottom. In an embodiment, the units may be placed in next to each other and marked from the left to the right or in the opposite direction. In an embodiment, the units may be placed next to each other and one on top of the other in multiple layers, and may marked accordingly.

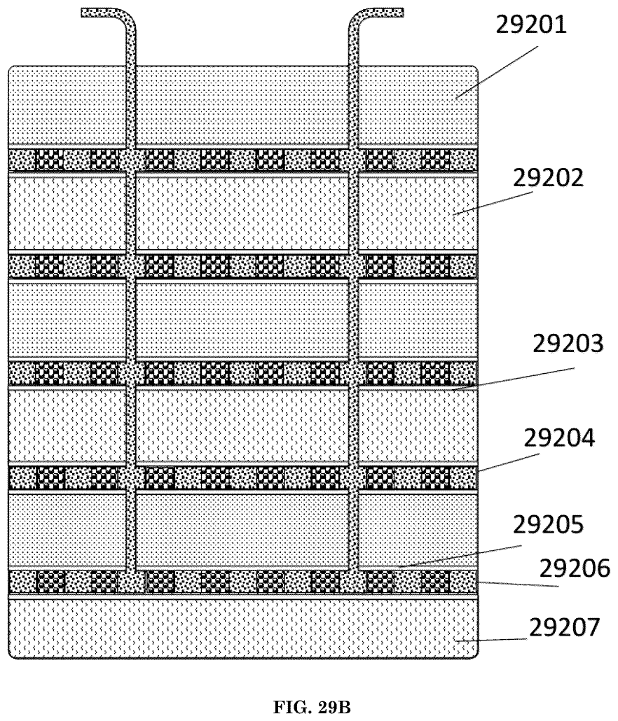

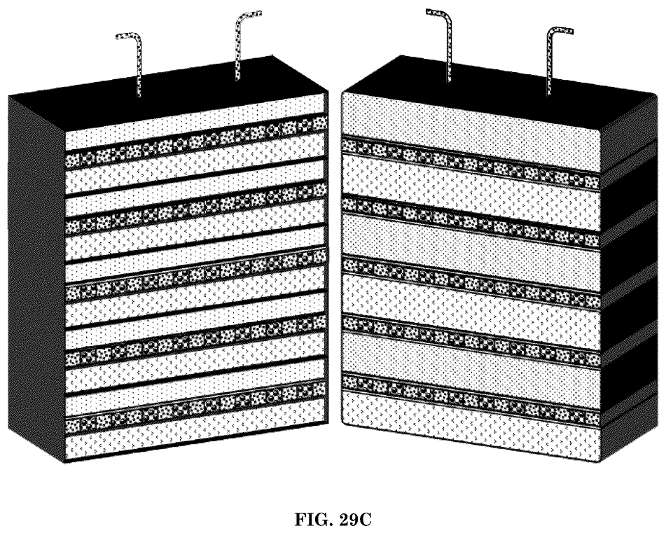

The multiunit devices consisting of units placed one on top of the other may be structured in different ways. FIGS. 29A-29C are the cross section views of different types of multiunit devices. In an embodiment, the upper units may contain the bottom section same as the bottom unit. FIG. 29A illustrates five units of the device having four sections separate for each unit (cross section view). This figure shows the device having five units, i.e., the top device unit 29101, the device unit 2—29102, the device unit 3—29103, the device unit 4—29104, and the bottom device unit—29106. In this device, each unit is separated from the other by its own envelope. Each unit in this drawings contains their own four sections, i.e., the bottom section 29107, the middle section 29108, the side section 29109, and the upper section 29110. The tridimensional grids of each of the units are connected through mutual scaffold tubes that stretch through all units and pass through all units' envelopes. The device includes the bottom wall 29105 of the unit's envelope.

In an embodiment, sections of the device may be united. FIG. 29B is a cross section view of the multiunit device containing mutual sections for several units. This figure shows the device having five units. In this device, every unit shares one of its sections with the unit above and/or below it. An entire device may be encapsulated in its own envelope, and units inside the device may be separated one from another by the envelope like structures. In this figure, the top unit has its own upper section 29201 that it does not share with other units. The upper and the bottom sections 29202 of two neighboring units are united. In such cases, the units may not be surrounded by the unit envelope but rather by an envelope like structure that is formed by the upper membrane 29205 of the unit beneath that unit as a bottom wall and the lower membrane 29203 of the unit 29204 above it as a top wall. The bottom unit 29206 contains the bottom section 29207 encapsulated into the bottom part of the device's envelope or envelope like structure. The upper units may be made of the lower membrane, middle, side and upper sections, while their bottom section may be an upper section of the unit beneath it or may continue to the upper section of the unit beneath it without clear separation. In some embodiments, the lower membranes, middle, side and upper sections may be sequentially placed onto the upper sections of the bottom and lower units all the way to the top of the device. Thus, in such cases where the bottom sections of the upper units are the upper sections of the units below them or they continue without clear separation, each device's unit may still contain all four sections, but some of them may be shared among the adjacent units.

FIG. 29C are tridimensional cross section views of the different multiunit devices. The figure shows the difference between the multiunit device with all four sections separate for each unit (left) and the multiunit device with mutual sections for some of the units (right).

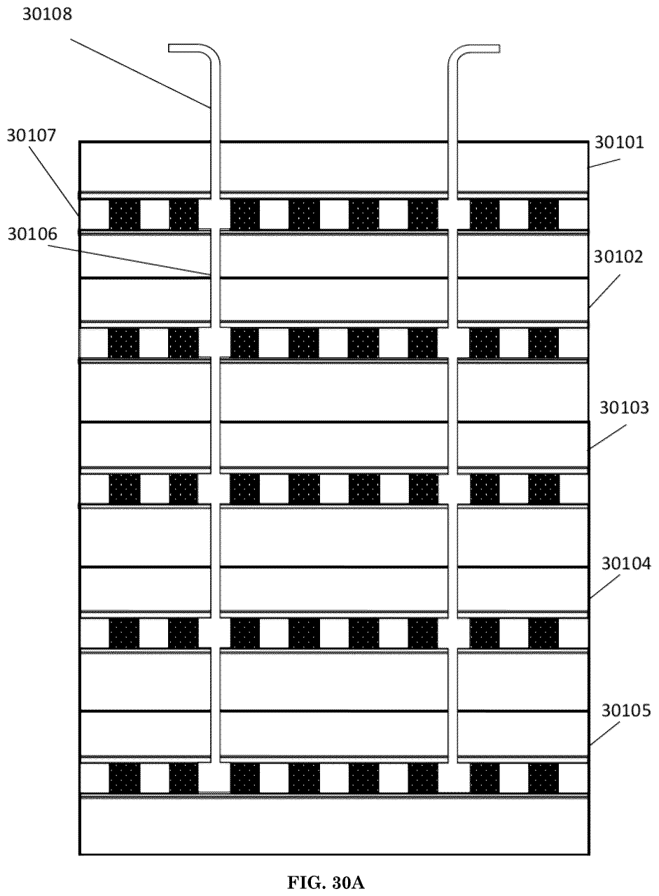

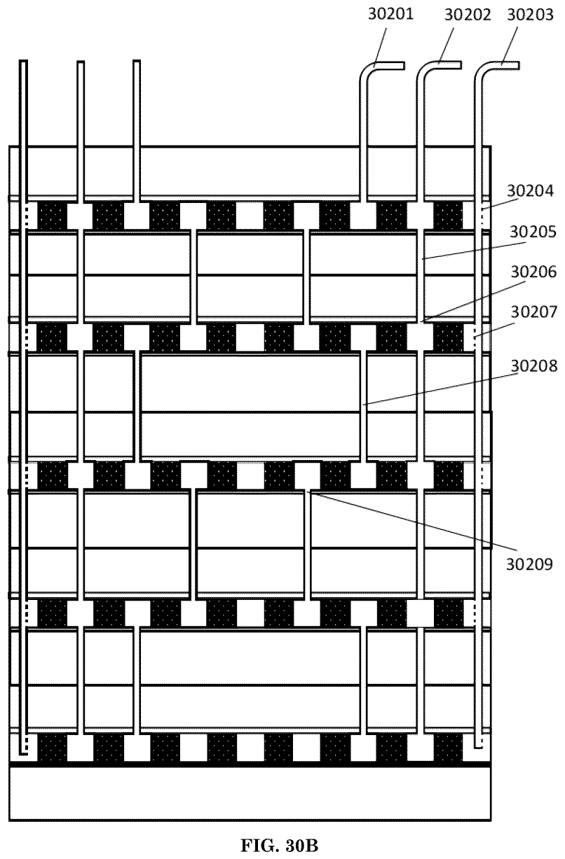

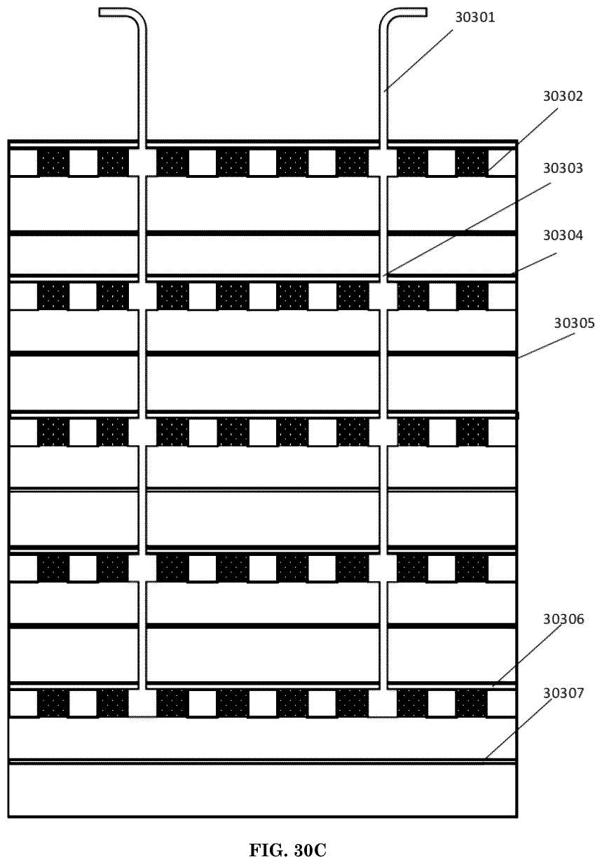

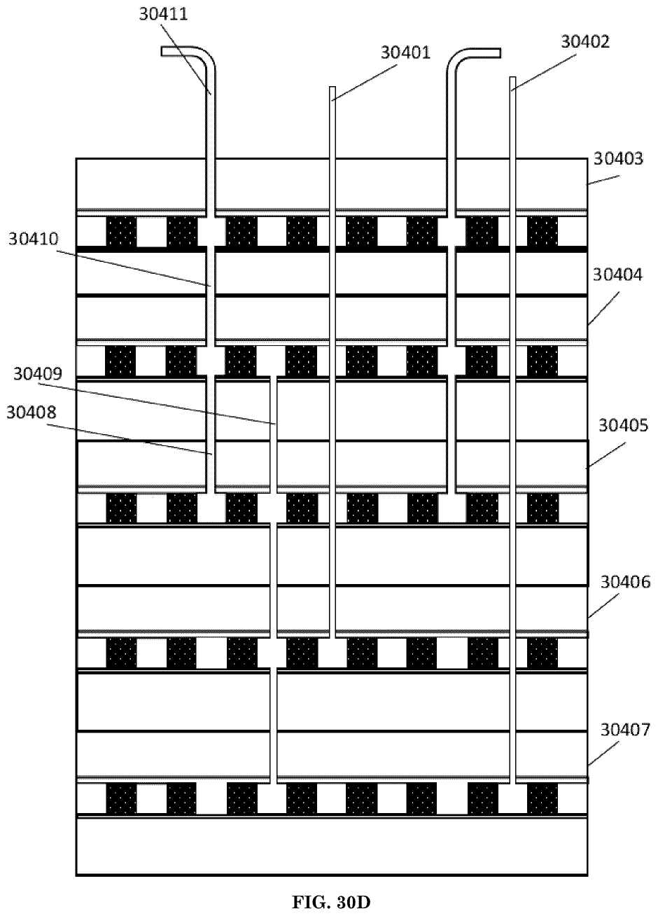

In multiunit devices, all side sections may, but do not have to be, united. When the side sections are united, one or more scaffold tubes and/or their parts may go through one or more envelopes and/or envelope like structures of the device. FIGS. 30A-30D are cross section views of various arrangements of scaffold tubes and tridimensional grids in multiunit devices. FIG. 30A is a cross section view of the tridimensional grids attached to the scaffold tubes within a multiunit device. This figure shows the device with five empty units i.e., device 1—30101, device 2—30102, device 3—30103, device 4—30104, and device 5—30105; and two angular scaffold tubes 30108 that go through all five units and connect all five tridimensional grids included in the units. Since each device's unit is encapsulated into its own envelope, e.g., envelope 1—30107, the scaffold tubes 30106 go through the openings on the bottom and/or top walls of the device units' envelopes.

If there is no scaffold tubes going through another device's unit then it may be two different devices. If there is at least one scaffold tube going through another device's unit, then it may be one device having its tridimensional grids united. In devices where all the tridimensional grid's structures are connected, they may be attached to one or more scaffold's tubes and/or their parts. The tridimensional grids may be attached to the scaffold tubes in at least three ways. In an embodiment, at least one scaffold tube may be connected to all the tridimensional grids within the device. FIG. 30B is a cross section view of the multiunit device with different types of scaffold tubes and their attachment to the tridimensional grid. Straight tubes are shown on the left, and angular versions of same or similar tubes are shown on the right. This figure shows the short scaffold tubes 30201, tube parts in different parts of the tridimensional grids and in straight strings, and long tubes 30203. The angular long tube has openings on its opposite sides, while the straight tube has openings on its one side. In this figure, the scaffold tubes may be made in one piece 30203. In an embodiment, the scaffold tubes or their parts may be tightly linked together so they are all in one piece. This arrangement is referred to herein as the long all-in-one scaffold tubes. These scaffold tubes may go through the tridimensional grid structures and the upper and lower membranes. This assembly may be achieved if these scaffold tubes and/or their parts have holes and/or openings, such as openings 30204 and 30207 shown in FIG. 30B, through which they have to deliver to and/or pull-out fluid or fluids from the inside of the tridimensional grid's structures. This assembly may be also achieved if the parts of the scaffold tubes are made of material that allows delivery to and/or pulling out fluid or fluids from the inside of the tridimensional grid's structures.

The parts of the scaffold tubes may connect different structures of the tridimensional grids. Each part of the scaffold tube may end at the start of the tridimensional grid's structure 30206 and started at the end of another tridimensional grid's structure 30209. The scaffold tubes 30205 may be placed one under the other or they may be placed on different parts of the tridimensional grid structures 30208. Depending on the length of the string of the parts of the scaffold's tubes beneath it. The top part of the scaffold's tube is referred to herein as a short scaffold tube 30201. If consecutive parts of the scaffold tube go from the top of the tridimensional grid to the bottom tridimensional grid, connect each structure of the tridimensional grid and form a string, then the entire string is referred to herein as a long scaffold tube in parts 30202.

In an embodiment where all tridimensional grids of a multiunit device are connected, all the tridimensional grids' structures may be configured to be filled by fluids inloaded into one or more scaffold tubes.

Also, all tridimensional grids of the device may be operable to be moved up and down within their own device's unit by pulling one or more scaffold tubes, poles and/or any other similar items at the same time. FIG. 30C is a cross section view the tridimensional grids configured to be pulled up with the scaffold tubes. In this figure, the device includes the long scaffold tube 30201 and the tridimensional grid 30202. The long tube passes through the envelope 30203 of the units 1 and 2, the bottom wall of the first unit's and top wall of the second unit's envelope 30204, the device unit 230205, the upper membrane 30206 and the lower membrane 30207. Since all tridimensional grids of the five-unit device shown in FIG. 30A are connected by the scaffold tubes, FIG. 30C shows the assembly where these tridimensional grids are pulled up together at once by pulling scaffold tubes up. FIG. 30D is a cross section view of the arrangement of the scaffold tubes and the tridimensional grids within the multiunit device. In this figure, the device includes multiple units, i.e., the device unit 1—30403, the device unit 2—3040, the device unit 3—30405, the device unit 4—30406, and the device unit 5—30407. The device further includes the scaffold tube 30401, the scaffold tube 30402, the tube part 30408, the string of four tube parts 30409, the string of the short scaffold tube and two tube parts 30410, and the short scaffold tube 30411. This figure shows different types of scaffold tubes that are not attached to all tridimensional grids within the device. There are two strings of short angular tubes and two tubes' parts. Two angular tubes are attached to the tridimensional grid in the device unit 1. Two tube parts are attached to the tridimensional grids in the device units 1 and 2 and two tube parts are attached to the tridimensional grids in the device units 2 and 3. On the left side of the device, there is a string of three tube parts that are attached to the tridimensional grids inside of the device units 2, 3, 4 and 5. In the middle of the device, there is the scaffold tube attached to the tridimensional grid in the device unit 4. On the right side of the device, there is the scaffold tube attached to the tridimensional grid in the device unit 5. This figure shows that there may be one or more tridimensional grids. As may be observed in this figure, the grids and/or scaffold tubes 30401 and 30402 do not have to be connected to all other tridimensional grids' structures of the device. If one or more scaffold's tube's parts 30408 are placed one underneath the other or one underneath the other and short scaffold's tube 30411, these tubes, referred to herein as a string, do not connect all tridimensional grids present within the device. This figure further shows the arrangement of the scaffold's tubes' parts 30409 or short scaffold tubes 30410 that are positioned straight one underneath the other within the device.

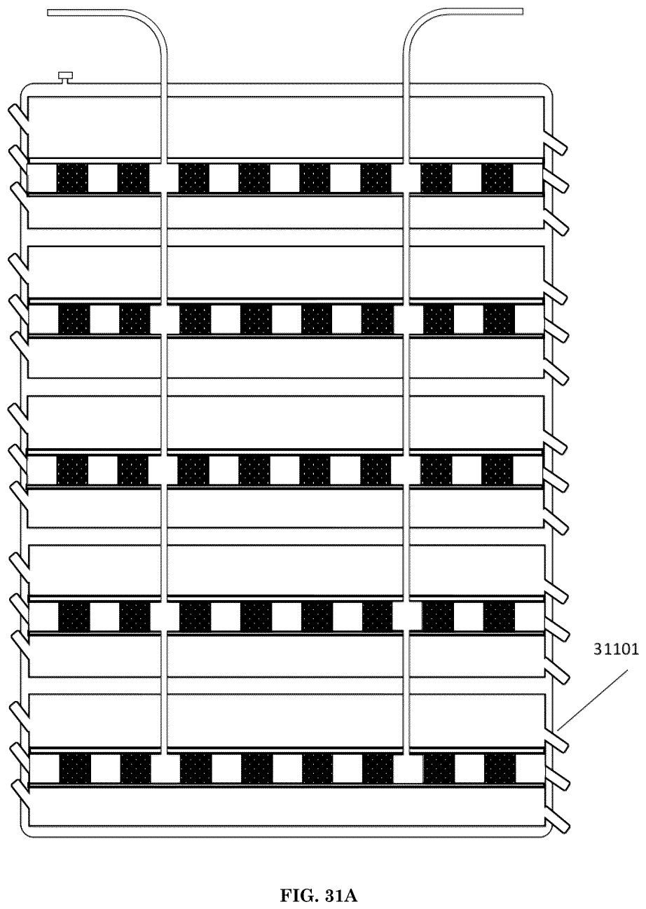

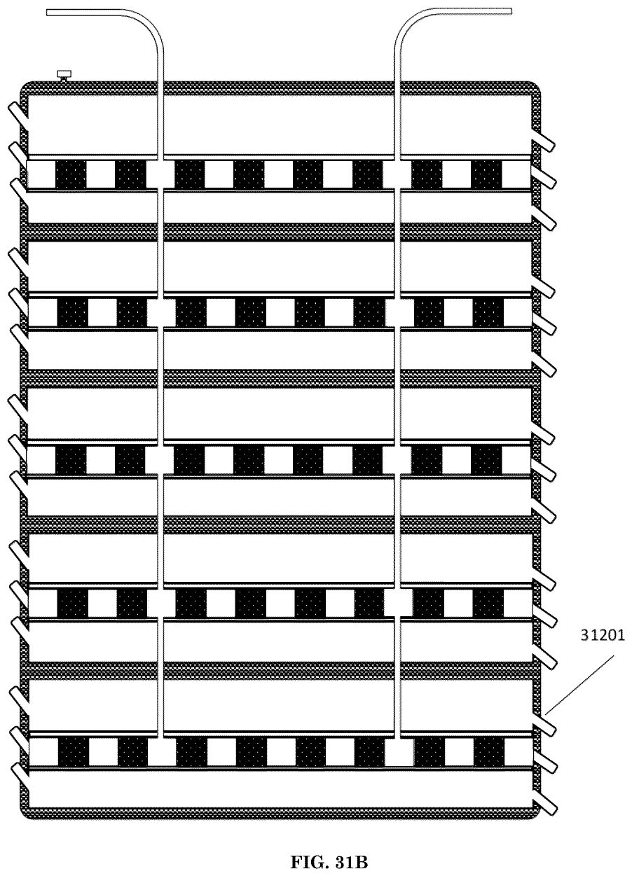

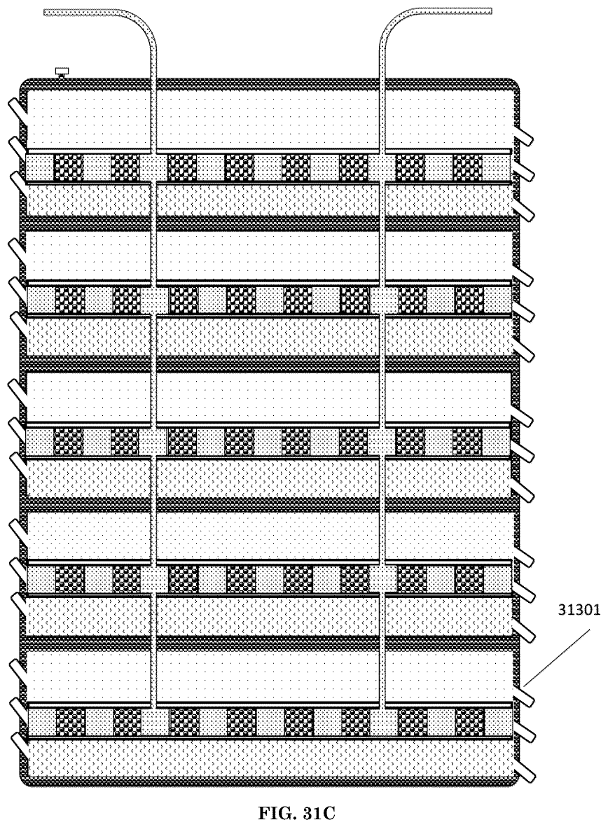

In an embodiment, there may be separation of the envelope's walls by a layer, which is placed between the adjacent units to prevent mixing of their contents. This layer is referred to herein as an impermeable layer. FIGS. 31A-31C are the cross section views of the multiunit devices having impermeable layers. FIG. 31A is a cross section view of the empty five-unit device with impermeable layers 31101 surrounding each unit. Referring to this figure, each of the impermeable layers has two holes inside it, through which two scaffold tubes are passing. FIG. 31B is a cross section view of the device having impermeable layers 31201 filled with medium. In this figure, the impermeable layers divide the device units and prevent penetration of any molecule from the upper unit into the bottom one and otherwise. Heat or cold or any other energy medium may flow through the impermeable layer without penetrating into the device's units while the device is empty.

FIG. 31C is a cross section view of the filled five-unit device having impermeable layers 31013. In this figure, the impermeable layers divide device's units and prevent penetration of any molecule from the upper unit into the bottom one and otherwise. Heat or cold medium may flow through the impermeable layer without penetrating into the device's units while device is loaded.

In an embodiment, impenetrable layer may be provided if the device consists of one or more units having four sections as shown in FIGS. 31A and 31B. In an embodiment, one or more scaffold's tubes, their parts and/or similar items, may go through one or more impermeable layers contained in the device. In an embodiment, this layer may present one of the envelope's walls or walls of the envelope like structure. In multiunit devices, where units are placed one on top of the other, these layers may be bottom walls. In an embodiment, the impermeable layer may be added to any, some or all walls of an envelope. Besides preventing mixing of fluids between units and/or the device surroundings, the impermeable layer may be configured to provide the desired temperature within the device and its content, whether cooling or heating. The temperature of the entire device or its specific part may be altered by providing suitable medium into the impermeable layer.

In an embodiment, the design of the device's envelope in may provide the double wall structure only for some parts of the device's unit. In an embodiment, the design of the device's envelope may provide the double wall structure for all parts of the device units. For the impermeable layer, there may be one or more openings in the device's envelope to inload and/or unload medium without affecting other processes within the device. The device is configured to inload or unload medium from the impermeable layer at any part of the production process. For example, the device may be configured to inload heating medium during the production process in order to speed up reactions by speeding the movements of molecules present in the device.

In multiunit devices, different units within one device may have different impermeable layers. One or more units may have only one wall equipped with an impermeable layer. One or more units may have more walls equipped with an impermeable layer, while one or more units may have all walls equipped with impermeable layers. In a preferred embodiment, every envelope's wall may be equipped with an impermeable layer.

In multiunit devices, the tridimensional grid's structures may be connected not only with scaffold's tube or scaffold's tubes but also with other elements. Other elements may be one or more supportive and/or connecting poles.

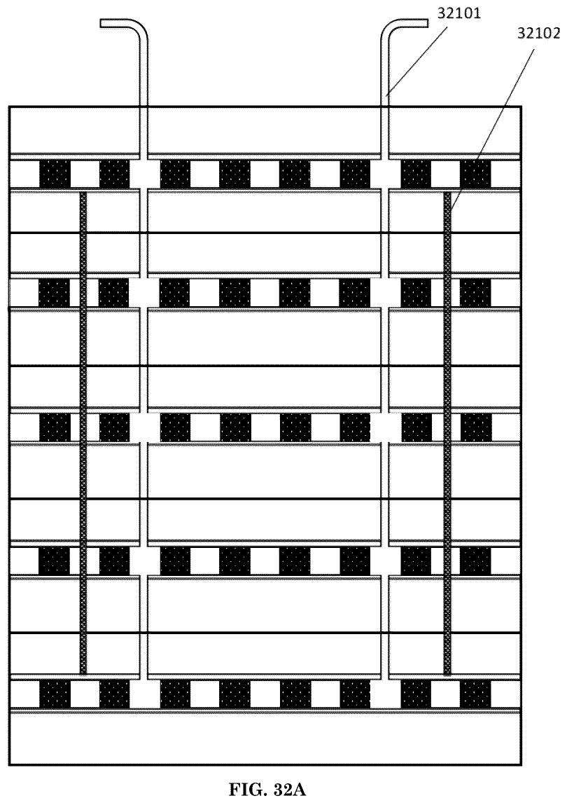

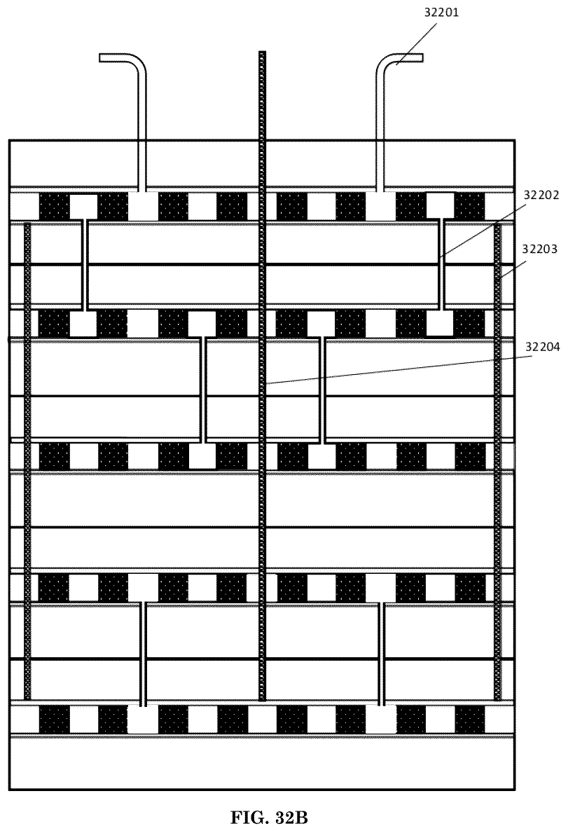

FIGS. 32A-32B illustrate long poles within a multiunit device. FIG. 32A illustrates the long supportive poles 32102 and the long scaffold tube 3210. This figure shows two long supportive poles stretching from the device unit 1 to the device unit 5. FIG. 32B illustrates long connecting and supportive poles. In this figure, the device includes the short scaffold tube 32201 and the scaffold tube part 32202. Two long supportive poles 32203 stretch from the device unit 1 to the device unit 5. The device also has one long connecting (capturing) pole 32304 in its middle.

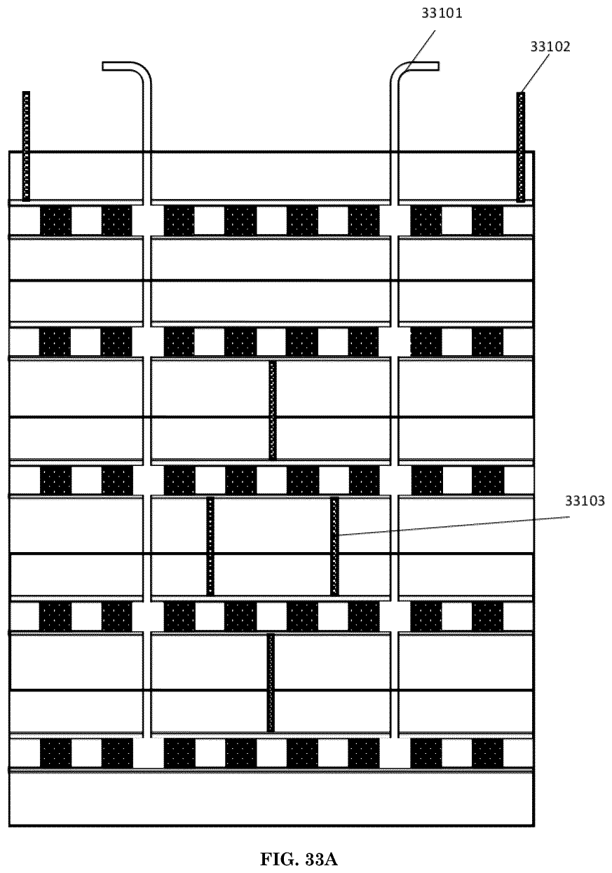

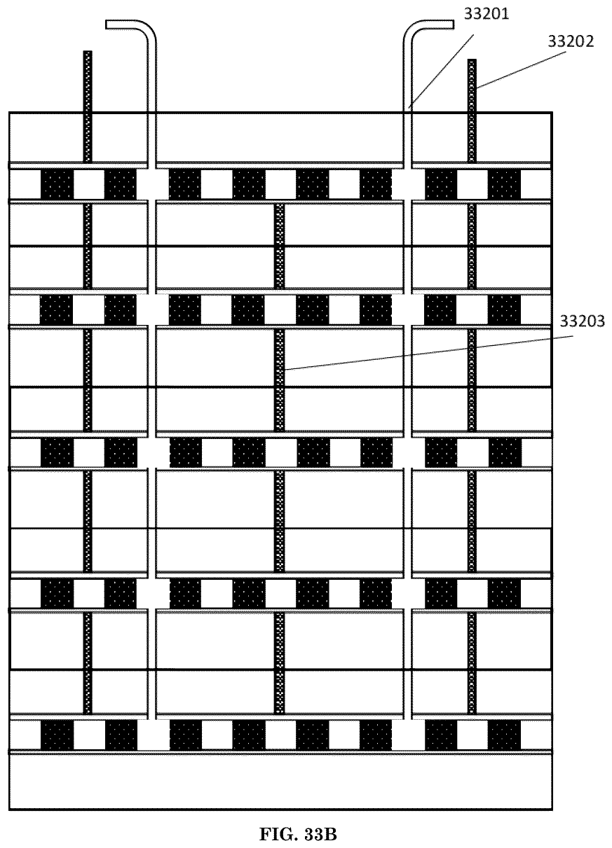

FIGS. 33A-33B illustrate short poles. FIG. 33A illustrates short connecting and supportive poles. This figure shows two short connecting poles 33102 attached the ends to the tridimensional grid of the device's unit 1. This figure also shows four supportive short poles 33103 attached to the tridimensional grids in the device units 2, 3, 4 and 5. In this figure, one of the poles is attached to the tridimensional grids in the device units 2 and 3, another pole is attached to the tridimensional grids in devices 4 and 5 and two poles are attached to the tridimensional grids in device units 3 and 4. The device shown in the figure also has the long scaffold tube 33101. FIG. 33B illustrates strings of poles. This figure shows two strings of short connecting poles 33202 and four short supportive poles 33203 at two ends of the tridimensional grids. The device also includes the long scaffold tube 33201. The poles, such as shown in FIGS. 32A and 32B, that go through multiple tridimensional grids of a device all in one piece are referred to herein as long poles. The poles, such as shown in FIGS. 33A and 33B, that are placed in different parts of tridimensional grids are referred to herein as short poles. Two or more short poles, such as shown in FIG. 33B, that are placed straight one under another are referred to herein as a string. The poles may be configured to be supportive and/or connecting. Supportive poles may be configured to link two or more tridimensional grids and in that way, to enforce the device's structure, and thus, to provide support. Connecting poles may be poles that are attached and/or go through one or more tridimensional grids and have external part of the pole that goes outside of the device. These poles are referred to herein as connecting poles because they are configured to connect a person, machinery and/or gadget they are connected to outside of the device with any item they are connected to in the inside of a device. One pole may, but does not have to, be supportive and connecting at the same time. In an embodiment, the tridimensional grid's structures may be connected with the supportive, connecting pole and the scaffold tube. In an embodiment, the tridimensional grid's structures may be connected with the supportive, connecting pole and the scaffold tubes. In an embodiment, the tridimensional grid's structures may be connected with the supportive, connecting poles.

### 2.6 Envelope

An embodiment provides an envelope or an envelope like structure. The term “envelope” or “envelope like structure” refers to everything that may create walls of a device or device's unit. It may form upper and bottom sections. In an embodiment, an envelope or an envelope like structure may surround the side section in a way that leaves little empty space between itself and the tridimensional grid's structure, and at the same time may provide enough space for the tridimensional grid's structure to move up and down from the top to the middle of the device and inversely. The device may, but doesn't have to, be placed in a physical envelope made exclusively for that purpose. It may be assembled into an improvised envelope like structure where conditions are appropriate for its creation. The upper, the side and the middle section may have to be in one part of the envelope, while the bottom section may, but does not have to be, in the same part of the envelope. In an embodiment, the upper, the side and the middle section may be placed in one envelope, while the bottom section may be attached to them. In an embodiment, the upper, the side, the middle and the bottom section may be all placed in one envelope.

The device or multiple devices, or units, may be placed in a simple or in more or less complex envelope and/or envelopes. A single or multiunit device may be placed in an envelope and/or machine. In an embodiment, the device may be placed in an envelope. In an embodiment, that envelope may be placed in a machine. In an embodiment, the device may be a part of a machine, whose parts create an envelope like structure for the placement of the device. In the latter case, parts of the machine may be placed in such way that they construct envelope's parts for the bottom section and/or for the upper, the side and the middle sections. In an embodiment, the device may be placed in multiple envelopes.

Envelopes may have different structures, sizes, shapes and may be made of different materials. In an embodiment, the envelope may be in the form of a flask containing one or multiunit device. In an embodiment, the envelope may be a simple structure. In a preferred embodiment, an envelope may contain openings for inload and/or unload of fluids by inload and/or unload items.

The device may be a part of more or less complicated machines. Each unit may be placed in one envelope. Multiple units may be placed in one envelope.

The device's envelope or envelope like structure may have its walls. Thus, there may be top, bottom and side walls. The top wall may be a wall that is placed on the top of the device or unit. The external parts of the scaffold's tube or scaffold's tubes, pole or poles and all other external scaffold's tubes and/or other items that may be coming out of the device through its top wall. The bottom wall may be a wall that is placed on the bottom of the device. The external parts of the scaffold's tube or scaffold's tubes, pole or poles and all other external scaffold's tubes, poles and/or other items may be coming out of the device through its bottom wall. In multiunit devices, the top and bottom walls may be walls that are placed on top or bottom units of the device. The side walls may be walls between the top and the bottom of the device and may present sides of the device by surrounding its inner parts and sections.

2.7 Moving Apparatuses, Machinery and/or Gadgetry

In an embodiment embodiments, the moving apparatus may be a simple handle or handles operable to move manually. In an embodiment, the moving apparatus may be a complex electric machine operable to move the tubes and therefore the entire scaffold with it. In an embodiment, the moving apparatus may be electric. In an embodiment, the moving apparatus may be automatized.

An embodiment provides apparatuses, machinery and/or gadgetry operable to enable shaking and/or mixing in many different ways. The type of the apparatuses, machinery and/or gadgetry may depend on the type of shaking and/or mixing that enhances device's performances and/or one or more synthesis and/or posttranslational modifications' reactions. The adequate apparatuses, machinery and/or gadgetry may be applied.

Also, the device may include stirring gadgets and/or pumps to enable stirring, mixing and/or pumping flow of fluids inside of the device. These gadgets may be configured to operate with least interference with synthesis and posttranslational modifications within the device.

### 3. Unload Sector

An embodiment provides an unload or pouring out sector. The unload sector may contain waste containers and unload tubes. The unload sector may also contain apparatuses, machinery and/or gadgetry operable for unloading.

The unload sector may include various containers. The containers may be of different shape. The containers may be made of different material. The containers may satisfy any other characteristics. The container may have one or more openings placed anywhere on the container. For the unload sector, the openings may be preferably placed on the top of the container. The placement of the opening may depend on the space available for the unloading container. The opening may be placed in the middle and/or on one or more the sides of the unloading containers.

In an embodiment, the openings on the unloading containers may be plain. In an embodiment, the openings on the unloading containers may be long or any other size, shape or form. The unloading containers may be configured for collecting waste, elute, one or more production components, products and/or any other content of interest.

In an embodiment, the unloading containers may be directly attached to the openings on the device. The unloading containers may, but do not have to be, equipped with one or more machines and/or gadgets that enforce the flow of fluids to be unloaded into the unloading containers.

In an embodiment, the apparatuses of the unload sector may be stirring machines. In an embodiment, the apparatuses may be stirring gadgets operable to be used manually to enforce flow. In an embodiment, the apparatuses may be mixing apparatuses and/or gadgets. In an embodiment, the devices and/or any tubes of the unload sector may be equipped with one or more pumps. In an embodiment, the devices' sectors that need to be removed may not contain any apparatus, machine or gadget and from them fluid may flow into unload containers without additional enforcement.

In an embodiment, the unloading containers may be connected to one or more tubes that are directly connected to one or more openings on the device. In an embodiment, the unloading containers may be connected to one or more tubes that may be connected to other tube or tubes that are connected to one or more openings on the device. On every part of each tube there may be a valve configured to stop and/or allow flow of the fluid into the unloading container. In an embodiment, there may be a valve on each opening of each unloading container that is connected to one or more device's openings and/or tubes.

The unloading openings may be positioned within any section. Preferably, they may be positioned within every one of four sections separately. The unload tubes may be configured to unload fluids from the sections. The unload tubes of the bottom, upper and/or side section may be joined together in an unload tube. Also, if the device is made of multiple units, all the unload tubes of the upper, side and/or bottom sections of the same and/or different units may be joined together. The unload tubes may be joined together at the end in one big unloading tube.

In an embodiment, valves on one or more device's openings may be configured to control the unload of fluids. When the valves are closed, fluids may be held inside the device and once the valves are opened, fluids may be unloaded from the device.

One or more mount pads may be attached to the place in which the unload sector and the device are being connected to ensure stability, secure adequate flow of one or more fluids and prevent leakage and outside interference of various types.

### 4. Separation and Recycle Sectors

An embodiment provides a bioreactor system comprising a separation sector. The separation sector may comprise separation machinery. The separation machinery may be placed following the device as shown on FIGS. 1B and 1C. Referring to FIG. 1C, the device further comprises tubes leading to the first line of separation tube 1007. The first line of separation tube is equipped with the detection device 1008. The first line of separation tube is also fitted with the upper valve 1009 and the lower valve 1011 on the redirecting tube 1010 for this line. The first line of separation tube further comprises pump 1012 for the redirecting tube 1010. The tube 1013 of the first line of separation is connected with the cell free unload tube by a valve on its top.

The separation sector may comprise the separation tube. The separation tube may comprise chromatographs, e.g., configured for affinitive chromatography. The separation sector may further comprise devices configured for monitoring quantity and quality of the desired product within a separating sector. The monitoring devices may be configured to perform spectrophotometry, or circular dichroism.

In an embodiment, the separation sector may be connected to a recycle sector. In an embodiment, the recycle sector may comprise the recycle pipeline as shown on FIGS. 1B and 1C. The separation line of the recycle sector is referred to as “Separation of production components” tube on FIG. 1B. Referring to FIG. 1C, the recycle pipeline or its part 1035 may contain one or more separation tubes 1037, or may be divided into more tubes, where each one of them may contain a separation line. This line may also be equipped with a signal detector, and a pump 1046. The production components may be directed through the recycle tube 1042 into the appropriate inload container back into the production. This may be done with the help of one or more pumps 1046. There may be a valve in a place where the recycle tube is connected to the input production mixture inload container.

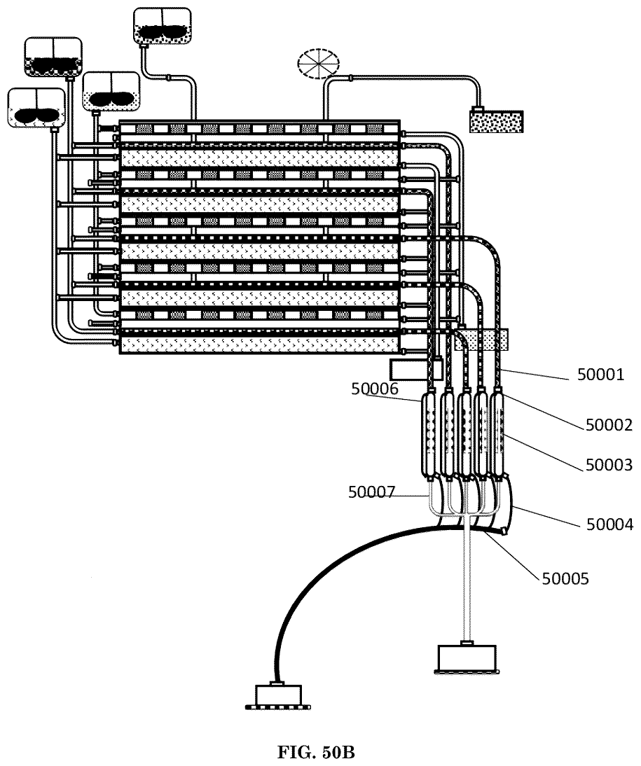

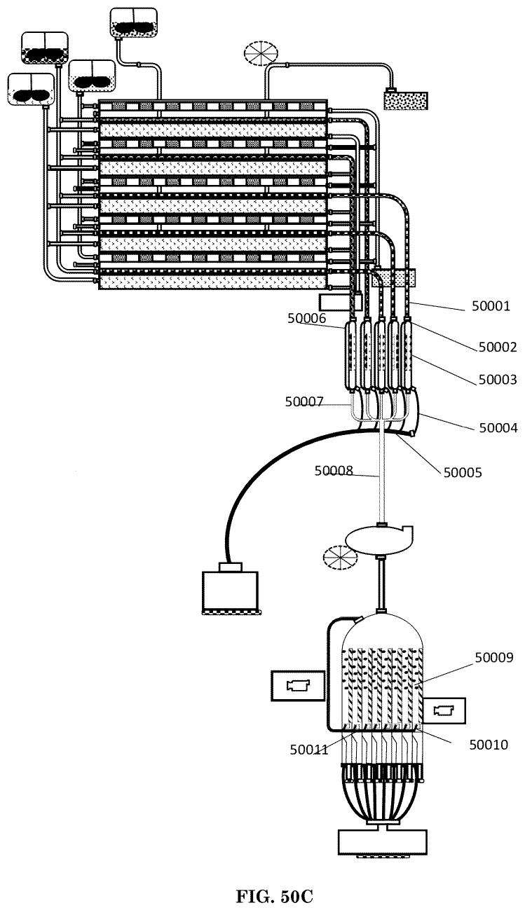

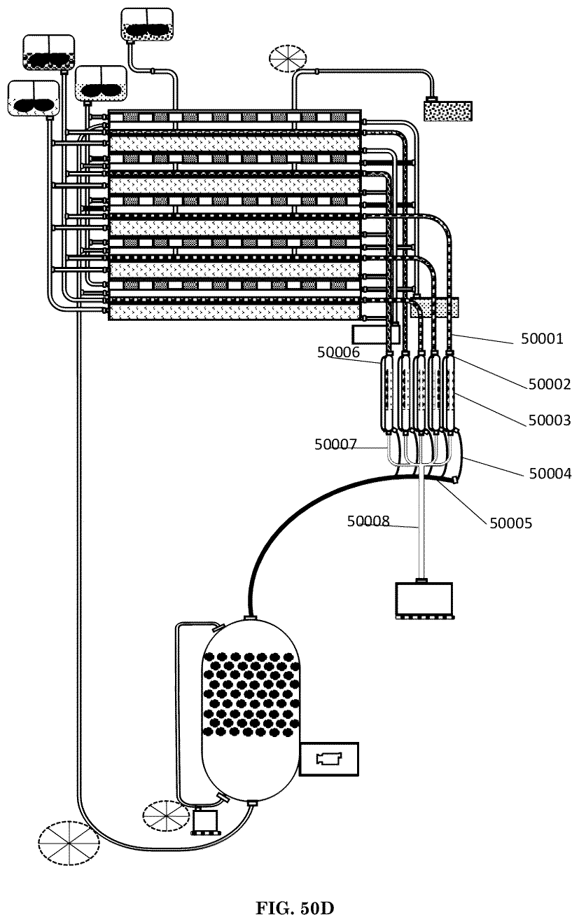

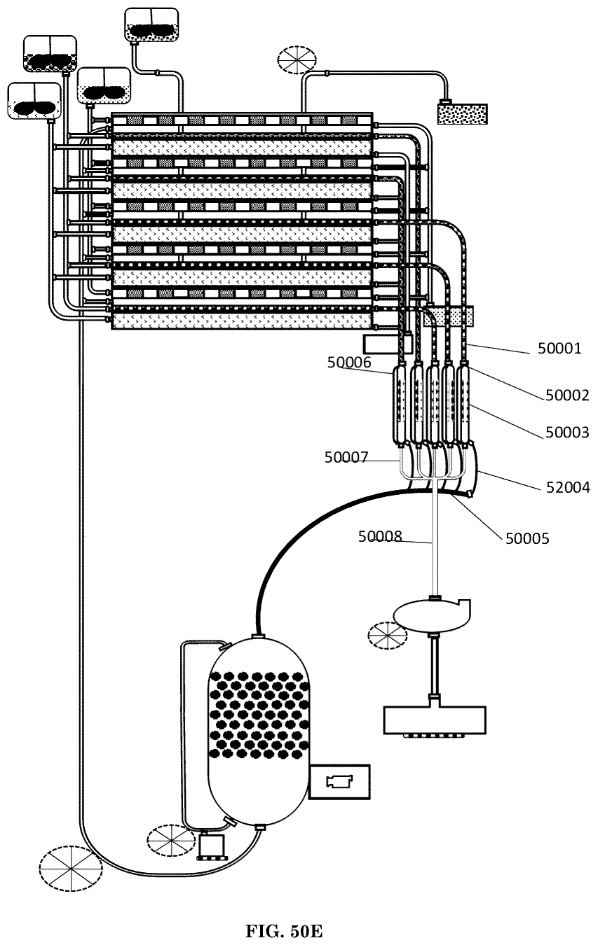

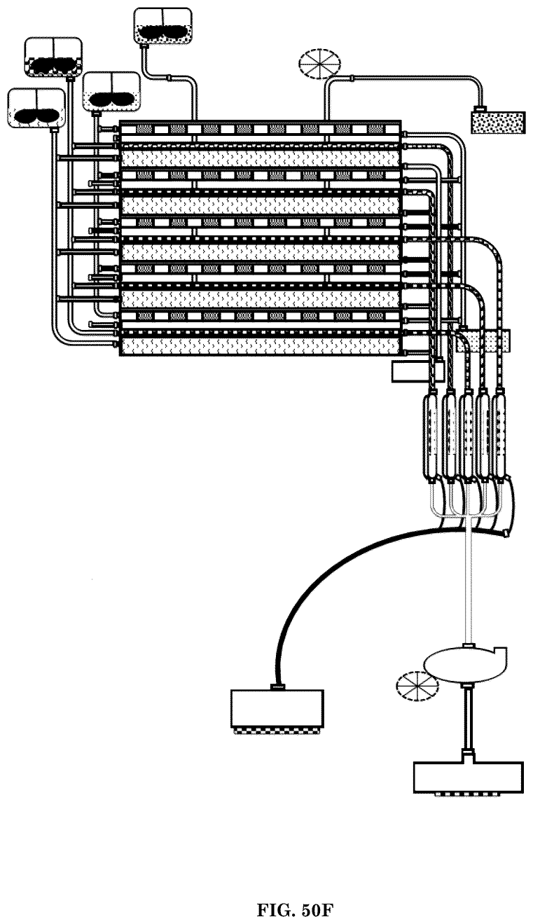

The steps of the separation and recycle methods and functioning of the separtion machinery are further described at least in FIGS. 50A-50C and section entitled “Methods of use” herein.

### 5. Desired Product Sector

A bioreactor system may comprise a desired product sector. The desired product sector may comprise an altering well and the second line of separation as shown on FIGS. 1B and 1C. The altering well may be configured for chemical, biological and physical treatment of the desired product. The altering well may be equipped with a pump, and connected to the second line of separation. The second line of separation may be a tube. Referring to FIG. 1C, the second line of separation tube includes the redirecting tube 1024 with valves on its bottom and top, and the pump 1025. The second line of separation tube also includes the valve 1026 on the normal flow (closed), normal flow part 1027 of the two ended tube, widening 1028 of the two ended tube, vial 1029 and small scale 1030 measuring vial's weight. The pipe 1031 is configured to carry liquid to the container 1032. The scale 1033 is operable to measure liquid in the container. The second line of separation may also comprise chromatographs, e.g., configured for size exclusion chromatography. The separation sector may further comprise devices configured for monitoring quantity and quality of the desired product within a separating sector. The monitoring devices may be configured to perform spectrophotometry, or circular dichroism.

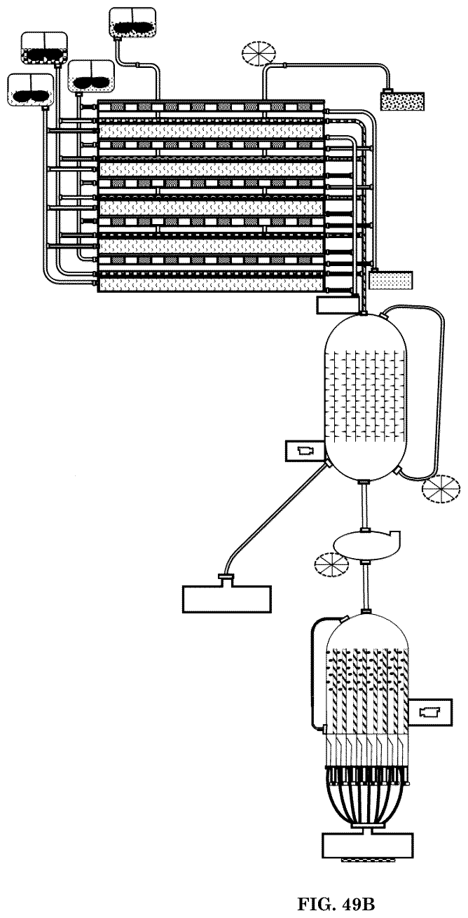

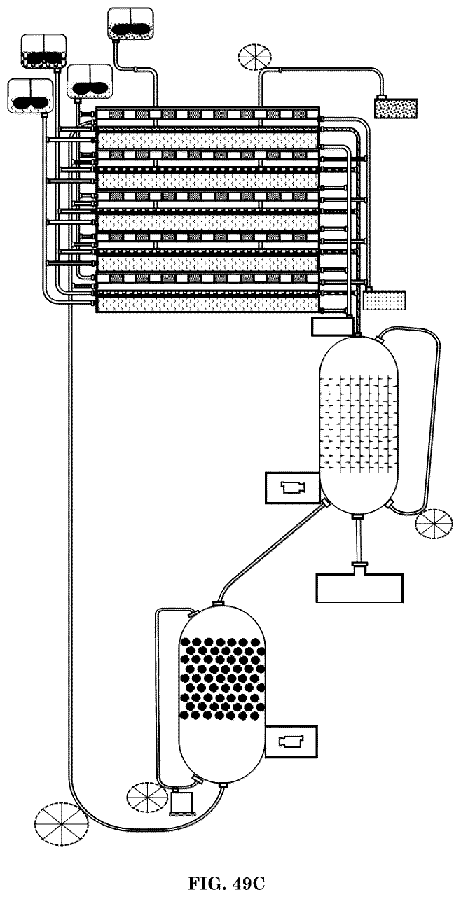

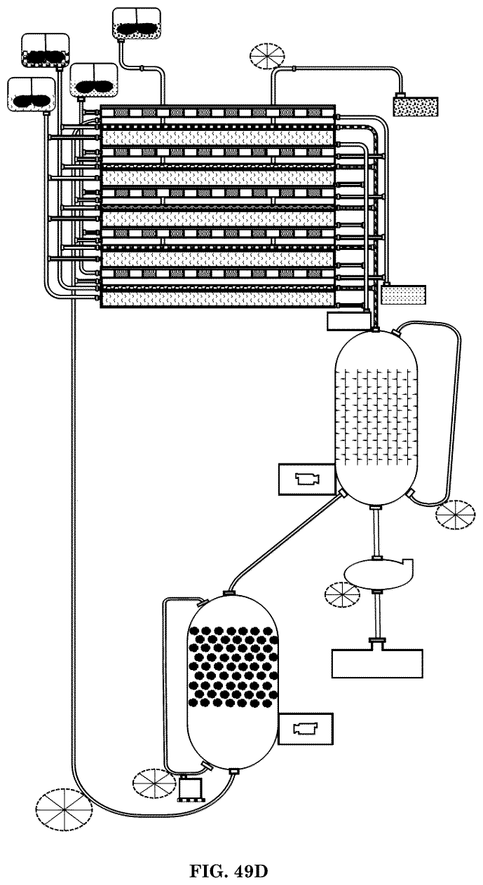

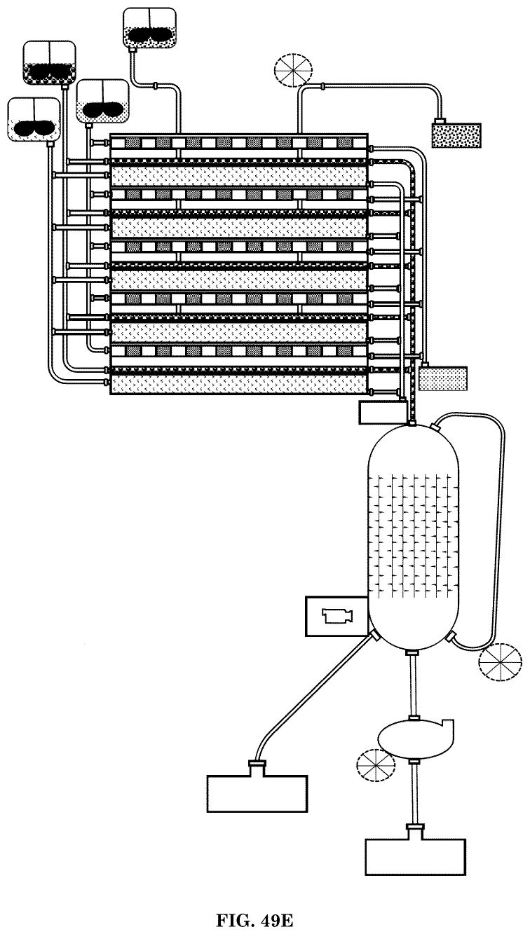

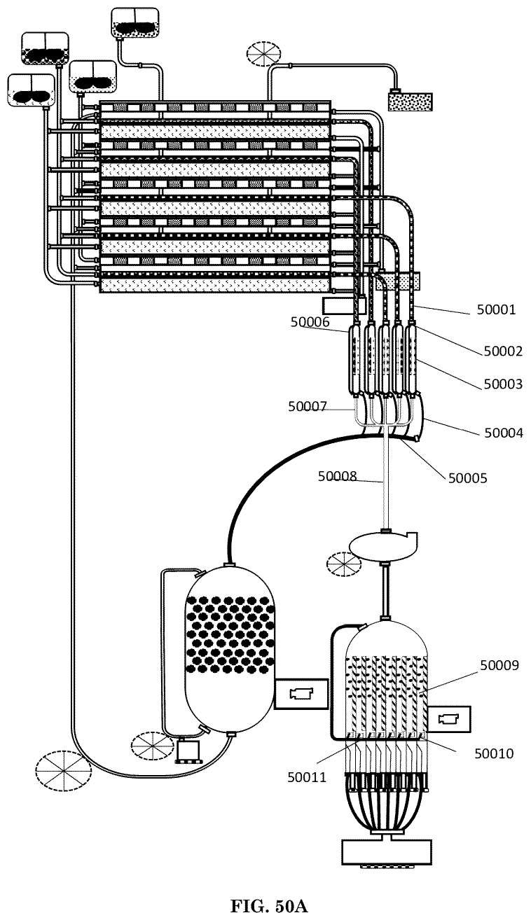

The steps of purification/separation methods for the desired products and functioning of the separation machinery are further described at least in FIGS. 49A, 49C, 50A and 50C and section entitled “Methods of use” herein.

### II. Materials and Assembly of the Device

In embodiments described herein, the device and/or its parts may be made of different materials.

The materials may include, but not be limited to, plastic, glass, cellulose, silicone or metal. In a preferred embodiment, the material may be inox. The materials may be natural or seminatural materials. There may be any other materials.

In embodiments, membranes may also be made of different materials. These materials may have different pore sizes and other qualities, but, no matter the differences, preferably, the membranes may be made of semipermeable materials.

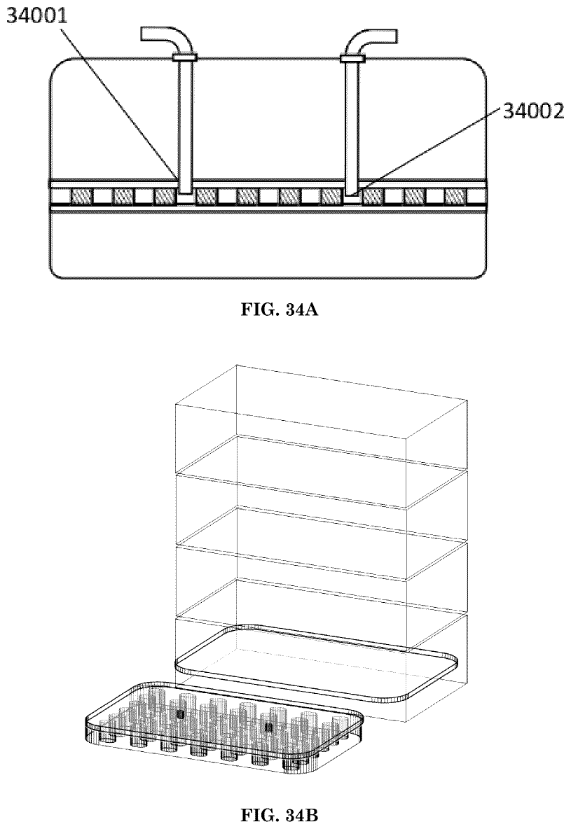

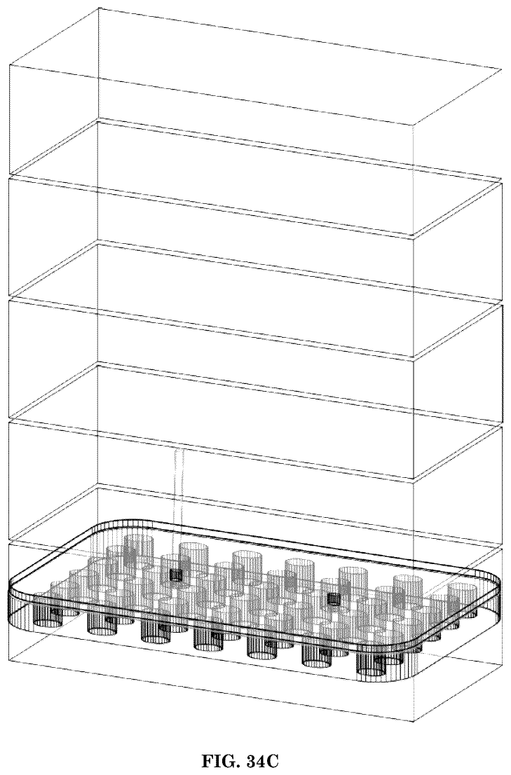

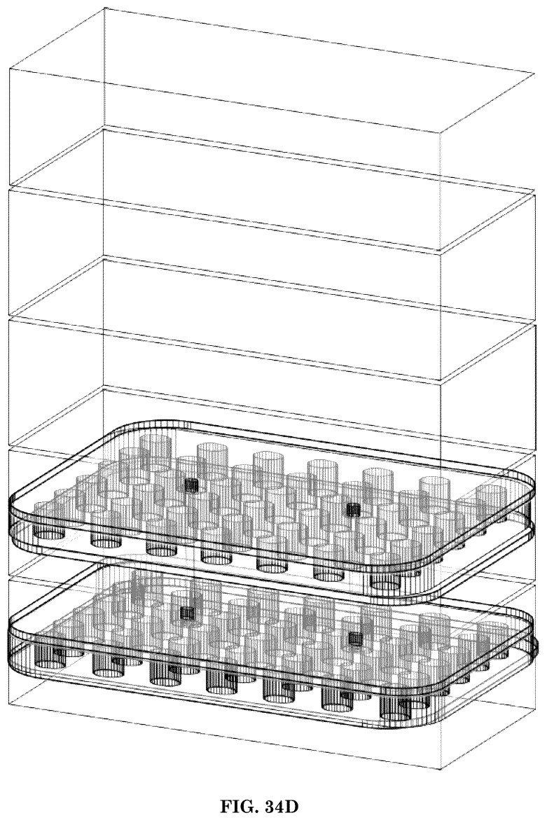

The device in embodiments herein may be made by assembling parts or by casting parts together. FIGS. 34A-34D illustrate scaffold tubes wedged in the upper membrane and the grid. In order to place scaffold tubes into the tridimensional grid, they may be wedged through the wedging openings in the tridimensional grid. FIG. 34A is a 2D cross section view of the scaffold tubes 34002 wedged into the wedging openings 34001 in the upper membrane and the grid. FIGS. 34B-34BD are 3D views of the assembly of the multiunit devices by wedging. FIG. 34B illustrates the lower membrane wedged in the bottom unit of the device. FIG. 34C illustrates the scaffold tube part wedged in the upper membrane and the grid in the bottom unit. FIG. 34D illustrates the scaffold tubes' parts wedged connecting two tridimensional grids from two device units.

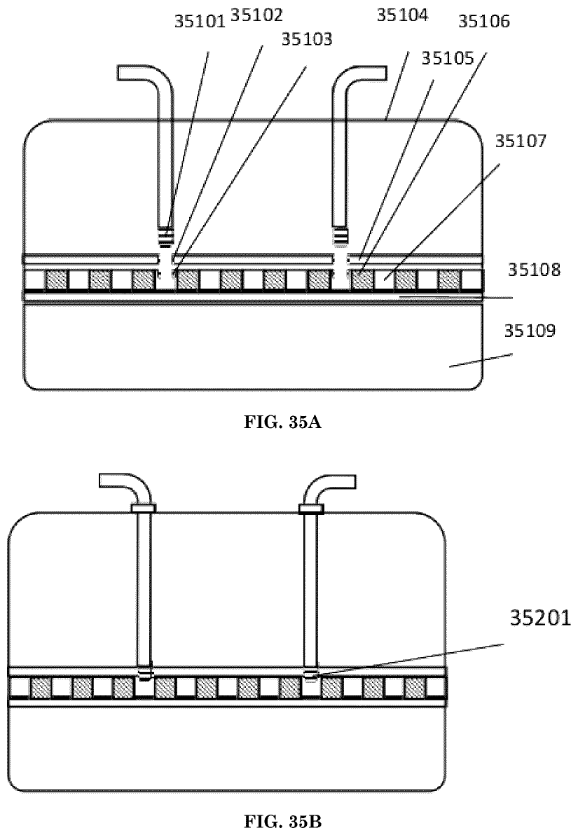

FIGS. 35A-35B are assembly views of the scaffold tubes bolted in the upper membrane and the grid. FIG. 35A illustrates assembly of the device. In this figure, the inside bolt 35101 and the outside bolt on the upper membrane 35102, the outside bolt in the tridimensional grid 35103, the upper envelope part 35104, the upper membrane 35105, the well 35106, the area around wells 35107, the lower membrane 35108, and the lower envelope part 35109. This figure shows assembling the side section by bolting parts of two scaffold tubes into the bolted openings into the tridimensional grid and the upper membrane. FIG. 35B illustrates the scaffold tubes bolted into their places. In this figure, two scaffold tubes are placed into their proper place by bolting them with the twisted bolt 35201 into the upper membrane and the tridimensional grid.

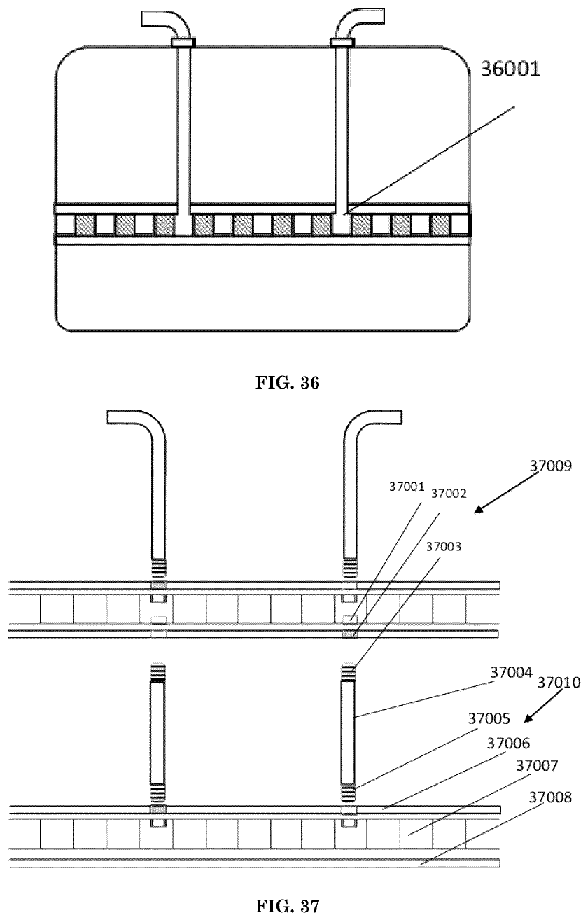

FIG. 36 illustrates scaffold tube 36001 cast with the upper membrane and the grid. In this figure, scaffold tube and tridimensional grid joint in one piece. Scaffold tube may be made by 3d printing or by any other technique casted into side section of tridimensional grid.

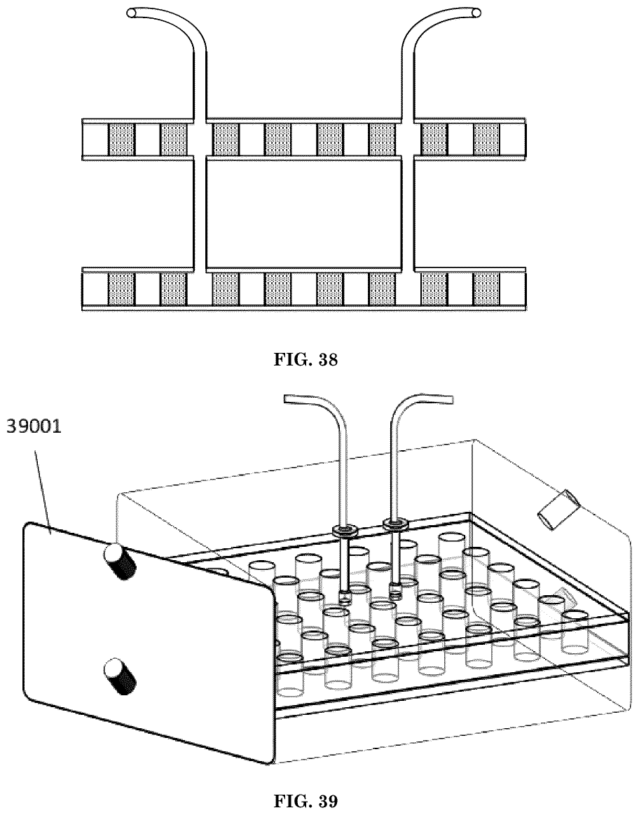

FIG. 37 is an assembly view of the bolted multi grids. In this figure, two devices, i.e., the device 1—37009 and the device 2—37010, are bolted together. In this assembly, the down outside bolt in the well plate of the device 1—37001, the outside bolt in the lower membrane of the device 1—37002, the upper inside bolt of the pipe—37003, the pipe—37004, the lower inside bolt of the pipe—37005, the upper membrane of the device 2—37006, the area around the wells of the device 2—37007, and the lower membrane of the device 2—37008. This figure shows two short scaffold tubes bolted into the bolted openings in the upper membrane and the upper tridimensional grid. Referring to this figure, two tube parts are bolted into the bolted openings on the lower membrane and the bottom side of the same tridimensional grid and in the bolted openings on the upper membrane and the upper side of another tridimensional grid. In that way these two tridimensional grids are joined together. FIG. 38 is an assembly view of the casted multi grids. In this figure, two short scaffold tubes are casted into the upper tridimensional grid. Referring to this figure, two tube parts are casted onto the bottom side of the same tridimensional grid and onto the upper side of another tridimensional grid. In that way these two tridimensional grids are joined together.

FIGS. 36 and 38 show the devices or their parts that may be made by 3d printing 36001. The devices or their parts may be assembled together in numerous ways.

An exemplary device having an envelope's wall serving as a door 39001 is shown in FIG. 39. One entire side wall of the envelope may be fully opened and may serve as a door to that device. The door may be opened and the necessary objects may be placed in the inside of the envelope. The lower membrane may be placed first. It may be inserted between the envelope walls or it may be placed onto little holders that are made in places specific for lower membrane to be placed on.

The tridimensional grid may be placed next together or separately with the upper membrane.

If the scaffold tube or tubes and/or other objects are cast to the tridimensional grid it may be necessary to place the scaffold tube or tubes through the openings on the envelope. In an embodiment, additional scaffold tubes' parts may be added to the scaffold tubes. In an embodiment, scaffold tubes may be made of flexible material so that the scaffold may be placed between a lower membrane and top of an envelope. In other embodiments, the scaffold may be placed first so the scaffold tubes may pass through the openings followed by placement of the lower membrane. If the scaffold tube or tubes and/or other objects are separately made, they may be wedged into the upper membrane's opening 34001, 34002 and/or tridimensional grid's opening as shown in FIG. 34. In an embodiment, the side section's openings' parts may be made in form of bolts 35101-35109, so that scaffold's tubes may be bolted into the upper membrane and/or tridimensional grid when pushed through the opening on the envelope or before that 37001-37010 as shown in FIGS. 35 and 37.

In an embodiment, the device may be assembled from the upper and lower part of the envelope. In such embodiment, the lower membrane may be placed in the lower part which contains the bottom section and the upper part or scaffold that may be assembled in it. In an embodiment, the device may be put together when the lower or upper part of the envelope fits into the widening of the other intended for that purpose.

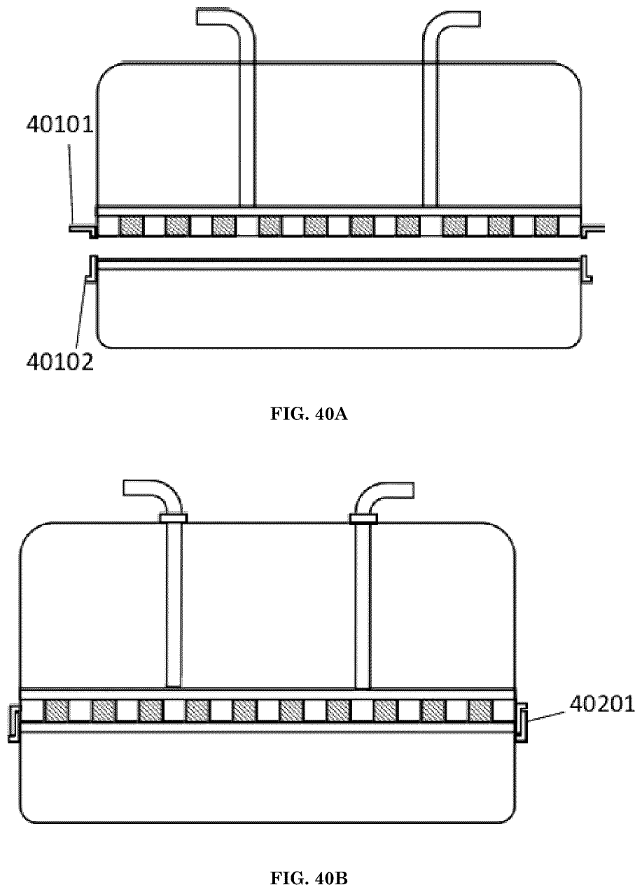

FIGS. 40A-40B illustrate a device closed by two locks each on one side of the device. FIG. 40A is an assembly view of the opened-position device divided in two parts. In this figure, two locks, i.e., the upper lock part 40101 and the lower lock part 40102, each on one side of the device are placed on the external sides of the device envelope parts. By pushing down the upper lock parts, they are configured to clamp with the lower lock parts. In an embodiment, the two parts of the envelope may be locked together by one, two or more locks. In an embodiment with two locks, the envelope may be made of the lower part 40101 and the upper part 40102. FIG. 40B illustrates closed locks. Referring to this figure, the device envelope, the entire device assembly and the position of its envelope parts is secured by two closed envelope locks 40201 on the sides of the device. In an embodiment with one lock, the envelope may be whole on one side and opened on the other, which allows it to be more or less opened while assembling the device.

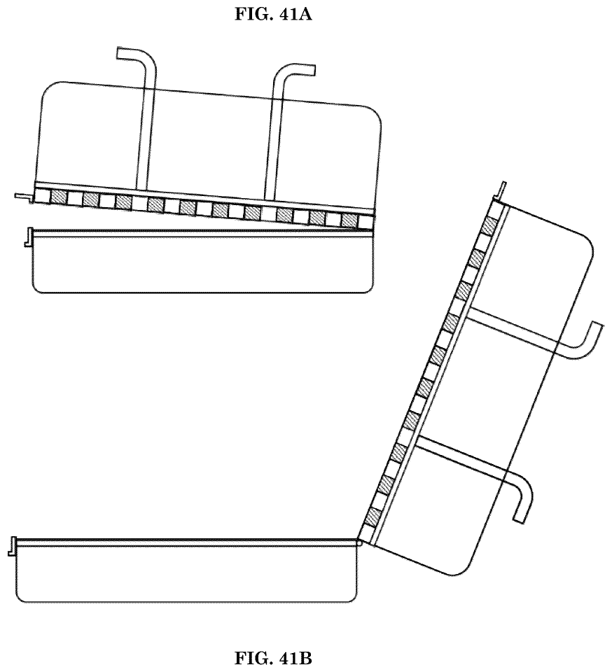

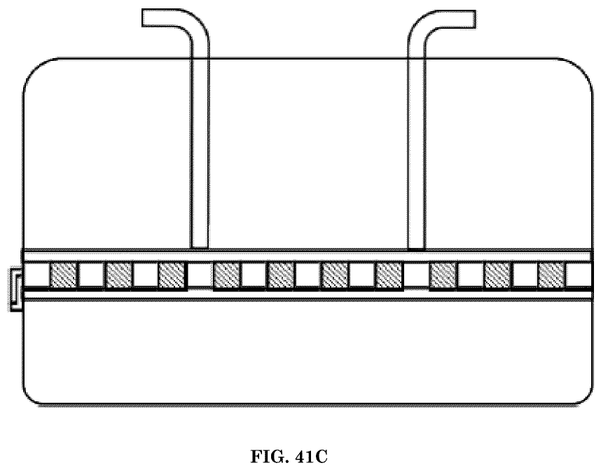

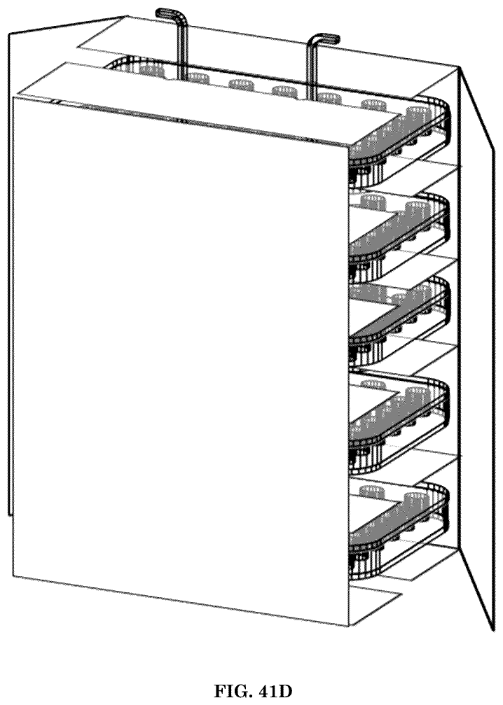

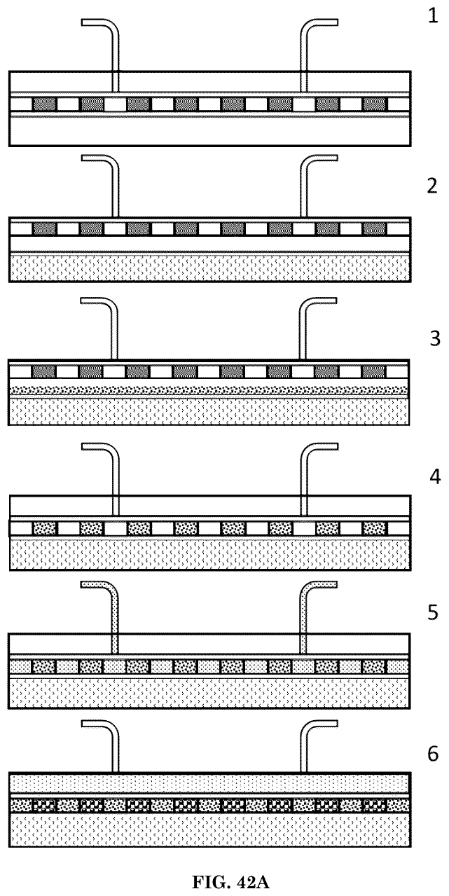

FIGS. 41A-41D illustrate a device that opens only on one side. In the drawings, the device is encapsulated in an envelope that may be opened only on one side. FIG. 41A illustrates a device slightly open. This figure shows one lock attached to the device envelope one lock. In an embodiment, the envelope may only be slightly opened and items may be inserted into it through that small opening. FIG. 41B illustrates a device wide open. This figure shows one lock attached to the device envelope. In an embodiment, the envelope may be widely opened and items may be inserted into it by their full width. FIG. 41C illustrates a device closed. In this position, the device envelope and the entire device may be assembled and position of its envelope parts may be secured by the closed envelope lock on one side of the device. FIG. 41D illustrates wrapping the envelopes walls around the scaffold.

Multiunit devices in embodiments herein may be made or assembled in different ways. In an embodiment, multiple units devices may be assembled in a similar way as one-unit devices with adequate modifications.

In an embodiment, the entire device's side wall may be opened. Through the opened side wall in each device's unit a lower membrane may be inserted or placed on top of holders and then a tridimensional grid may be placed on top of it. One or more scaffold tubes and/or poles connecting two tridimensional grids may be bolted into the bolted openings on the upper membranes and/or tridimensional grids. In order to bolt two tridimensional grids to the tube's part, the upper grid may have to be moved up or the lower membrane of the lower units may have to be added later.

In an embodiment in which the entire device's side wall is opened, the tridimensional grid may be placed in the bottom unit. From this grid one or more scaffold's tube's parts, coming from inside of the tube's part that is already placed in that tridimensional grid, may be configured to be pulled up. The tubes may be configured to be inserted into the tridimensional grid of the unit above it, that is being placed into that unit. This structures may be repeated all the way to the top unit.

In an embodiment, the scaffold tube's parts of the top unit may be configured to be pulled up and pulled through the openings on the top of the envelope.

In an embodiment, the scaffold tubes of the top device's unit may be inserted, bolted and/or in any other way firmly placed into the opening onto the upper membrane and/or the tridimensional grid of the device's top unit.

Similarly to that, in other embodiments in which the entire device's side wall is opened, the tridimensional grid from any device's unit, i.e., top, middle or in-between unit, may be placed in its unit, and parts of scaffold's tubes may be configured to be pulled up and/or down from it and may be inserted, bolted and/or in any other way firmly placed into openings of other one or more membranes and/or tridimensional grids.

In an embodiment, tridimensional grids and one or more scaffold tubes, tubes' parts and/or poles may be first attached to each other and then one or more envelopes may be wrapped around that structure. These structures may be assembled in various ways.

In an embodiment, an envelope may be assembled from two parts. In an embodiment, an envelope may be assembled from multiple parts as shown in FIG. 41D. In an embodiment, one envelope may be spread to two sides and then assembled back together around the formed structure. In an embodiment, each wall of the envelope may be added on top and/or next to other forming an envelope around the formed structure. In an embodiment, there may be one or more locks that hold the envelope's parts together. In an embodiment, there may be one or more widenings of one envelope's part in which other part may be inserted or in any other way firmly placed into.

In an embodiment, only small part of device's side wall may be opened. In an embodiment, the opening may be at the top, middle or anywhere on the side wall. The opening may have to be big enough so that every upper membrane, if not attached to it or is not integral part of the tridimensional grid, the tridimensional grid and the lower membrane may be placed into the envelope in the adequate way. Through the opening then the upper membrane, if not attached or integral part of the tridimensional grid, the tridimensional grid and the lower membrane may be placed in adequate way. For example, if the opening is in the bottom of the side wall then the upper membrane, if not attached or integral part of the tridimensional grid, and the tridimensional grid may be configured to be placed into an envelope. The envelope may be turned in adequate way, so the tridimensional grid may be placed on top of the envelope. Through the scaffold tube's or tubes' openings on top of the envelope, one or more scaffold tubes may be bolted, inserted or in any other way firmly placed into scaffold tubes' openings in the upper membrane and/or the tridimensional grid that is inside of an envelope. Once attached, the upper membrane and/or the tridimensional grid may be kept on top of the envelope by one or more scaffold tubes configured to hold or be pulled up. Subsequently, a lower membrane may be placed in its suitable place somewhere under the tridimensional grid.

In an embodiment, the lower membrane may be inserted there. In an embodiment, holders may be included in the envelope's walls so they are released, glued in a proper place. In an embodiment, the lower membrane may be pushed in its place in way that it bypasses holders. The lower membrane may be placed on top of the holders.

In case of the one-unit devices, the opening of the side wall may be closed at the end of device assembly.

In case of the multiunit devices, the assembled scaffold may be pushed onto the lower membrane and then one or more scaffold's tube parts, scaffold's tubes and/or poles may be attached to the openings in the tridimensional grid through the openings on the lower membrane. One or more poles may be attached only to one or more openings on the lower membrane and one or more scaffold's tubes and/or poles may be attached to one or more openings on the bottom of the device's unit envelope.

In an embodiment, following the attachment of the scaffold tubes and/or poles, the bottom of the device's envelope and/or impermeable layer may be added through the opening on the side wall of the device's envelope. Subsequently, the upper membrane, if not attached or integral part of the tridimensional grid, and the tridimensional grid may be placed below them, so that every scaffold tube and/or pole may be placed into its belonging opening on the upper membrane and/or the tridimensional grid. This structure may be repeated until all device's units are assembled and then opening on the device's side wall of the envelope may be closed. A similar approach may apply to all other openings on the device's envelope's side wall, with adjustments in terms of placing items into envelope in logical order for purpose of assembling a device.

In embodiment, only the op and/or bottom wall of the device's envelope may be opened. In an embodiment, the entire top and/or bottom wall may be opened. In an embodiment, the top and/or bottom wall of device's envelope may be partially opened.

Any of these openings may have to be big enough so that every upper membrane, if not attached or integral part of tridimensional grid, the tridimensional grid and the lower membrane may be placed into the envelope, through it. In an embodiment, the opening or the entire top wall of device may have first to be opened, if applicable. If the entire top wall of device is open, in some cases holders of the lower membrane may be inserted into its openings in one or more inner sides of the envelope. In an embodiment, the holders may be glued, attached, bolted or in any other way firmly placed into their belonging place. The lower membrane may be placed in its suitable place by being inserted into it or by being placed on top of the holders. In an embodiment, the lower membrane may be placed in its suitable place with or without the holders.

In an embodiment, the lower membrane may, but does not have to, contain one or more scaffold tubes, poles or any other applicable item already placed onto it and it may be placed in its suitable place together with them facing down and passing through their belonging openings in the bottom wall of device. Also, in some embodiments, one or more scaffold's tubes, poles or any other applicable items may be inserted, bolted or in any other firm way placed into their belonging openings on the lower membrane through the openings in the bottom wall of the envelope. Subsequently, the tridimensional grid may be placed on top of it, with or without the upper membrane as its attached or integral part. If upper membrane is not attached or integral part of the tridimensional grid, then it may be added on the top of the tridimensional grid. Subsequently, one or more scaffold tubes, scaffold tube's or tubes' parts, poles and/or any other similar item may be placed into their belonging openings in the upper membrane and/or the tridimensional grid. In case of the one-unit devices, the opened wall may then be closed and one or more of these scaffold tubes, poles and/or other similar items may be added to the device through one or more openings on the top wall of the device. In an embodiment, one or more of these scaffold tubes, poles and/or other similar items may be added to the device by placing them into their belonging openings and then closing the opened top wall. In case of one-unit devices, that may be the complete device assembly. In case of the multiunit devices, after placing the tridimensional grid and/or the upper membrane, the holders of top wall of that device's unit, the top wall of that unit, the impermeable layer, the holders of the lower membrane of the upper unit or the lower membrane of the upper device's unit may be added into suitable places. This structure may be repeated until all device's units are assembled and then top wall of the device is closed. Similar approach may be applied if the bottom wall is the one that is opened or if both top and bottom walls are opened, just it may be necessary to add items in logical order for purpose of assembling a device.

In cases where only part of the top and or bottom wall is opened it may be necessary to push items through that device's wall's opening and to place them in the suitable place in logical order for purpose of assembling a device.

There are many more ways in which device may be assembled, depending on its material, complexity, dimensions, design, purpose, availability of machinery for its creation. There may be other ways to assemble the devices of the embodiments herein.

III. Fluids within the Bioreactor System

As described in embodiments herein, there may be many different kinds of fluids that are present in the system. The fluids flowing through the system are referred to as substances, solutions and mixtures. Mixtures are combinations of two or more substances and/or fluids. Fluids may be of different types based of the role they have in fabrication and production process. Fluids may be also characterized based on their placement within the device and their properties.

Two main categories of fluids flowing within the system may be production and supportive fluids. Production fluids may be used in production process, while supporting fluids may be used to support production process. Production fluids, on the basis of their role in production process, may be input, output or resulting fluids. Fabrication fluids may be fluids that include production components' and/or desired product's fluids.

Input fluid may be a production fluid that is introduced into device in order for one or more synthesis and/or posttranslational modifications to be performed by it. Synthesis fluid may be a fluid introduced into the device in order for one or more synthesis to be performed in it. Posttranslational modification fluid may be a fluid introduced into the device in order for one or more posttranslational modifications to be performed by it.

Output fluid may be a production fluid at the moment when and after each one of every synthesis and/or one or more posttranslational modifications are over, before it is released from the wells by pulling the tridimensional grid up. There may be many different output fluids created from one input fluid. Each one of them may be different and may be created after every synthesis and/or posttranslational modification happening in an input fluid. Resulting fluid may be a production fluid at the time when and after all synthesis and/or posttranslational modifications are done, the tridimensional grid is pulled up and wells' content is mixed together. Preferably, one input fluid has only one resulting fluid.

Supporting fluid may be a fluid that contains one or more necessities or serves for removal of waste. Supporting fluid may contain one or more necessities, Supporting fluid may contain wastes.

As used herein, necessity is any substance, fluid, item, component, molecule, atom, ion and/or element necessary for any part of production process.

As used herein, waste is any material, substance, fluid, by-product, component, molecule, atom, ion and/or element that is unwanted, unusable and/or unrequired, serves no purpose for production process and/or needs to be eliminated or discarded in order to enable completion of a process.

Waste fluid may be a fluid that is intended for adsorbing, solvating, clearing, eluting and/or in any other form removing of waste from the invention.

Elutes are specific types of supporting fluids that may be used in production process within chromatography and/or other reactions where necessary, but may also be used after and/or before production in order to elute any unwanted substance present in invention.

On the basis of where they are placed within the device, fluids may be placed into the upper, bottom, middle and side sections.

On the basis of characteristics of their content, fluids are referred herein as cell-free, because they do not contain cells in their traditional complete form.

### IV. Methods of Use

An embodiment provides a method of producing a biological product. The method may be a cell-free production by using a bioreactor system as depicted on FIG. 1A.

### Inload or Pouring in Process

In an embodiment, fluid may be inloaded into the filing container, or containers provided within the “Pouring in sector.” The inloading fluid may comprise a cell-free biological material. In an embodiment, the filing container or containers are configured to hold fluids with and/or without stirring. The filing container or containers may have different accessories for inloading fluids into the device. In an embodiment, the filing container or containers may be configured to enable direct fluid flow from the filling container into the device through the device's opening.

In an embodiment, the filing container or containers may be equipped with a stirring machine that enforces fluid flow. In an embodiment, the filing container or containers may comprise one or more tubes to transfer fluid from the filling container to the device. In an embodiment, the filing container or containers may comprise a mixing machine to enforce transfer of fluids via one or more tubes to the device.

In an embodiment, an inload sector may have one or more valves placed within the sector to control fluid flow with opening and/or closing as appropriate. In an embodiment, the valves may be placed on one or more filling containers' openings to regulate fluid containment and/or flow. In an embodiment, the fluids may be mixed and/or stirred, while valves are closed. Once amount of stirring and/or mixing is satisfactory, valves may be opened and fluid may be inloaded into the device. In an embodiment, the device may have valves on one or more device's openings to control the inload of fluids. When the device's valves are closed, fluids may be held outside of the device and once they are opened, fluids may be inloaded into the device.

### Providing Platforms

In an embodiment, the method may comprise adding at least one supporting solution to each one of the plurality of the compartments to form a production mixture. One or more supporting solutions may be added via providing platforms. An embodiment provides one or more providing platforms configured to provide fluids to the middle section of the “Device sector.” The middle section may contain the production mixture inloaded into each compartment, i.e., well of the middle section. The middle section may be connected to the upper and bottom sections of the device through the portion of the membranes placed in-between these sections. The one or more production platforms may provide production mixtures inside the compartments of the middle section with support fluids contained in the surrounding sections. The one or more productions platform may provide space to remove waste products from the compartments.

The fluids of the production platforms may pass through pores of the walls of the wells and/or upper and lower membranes that are made of semipermeable materials. The pores may be large enough for waste molecules to be released and may allow entry of supporting molecules through them, but at the same time may be small enough to hold major production components inside the compartments. For example, if the production process is translation, ribosomes and/or transport RNA should not be able to pass through the pores of semipermeable materials. For example, if the production process is transcription, messenger RNA and/or DNA should not be able to pass through pores of semipermeable materials.

The production mixture may, preferably, be inloaded into the middle section. Each well may present one compartment. Other three sections, i.e., the upper, side and bottom sections, may be filled with same or different fluids. Each of the providing platforms may carry the same or different fluids as the other providing platform. The fluid or fluids may be changed over time.

Three sections, other than section containing the production mixture, are referred to herein as supporting sections, as they carry supporting fluids. These fluids may contain necessities required for the production process. These necessities may include substances, or compounds, or both substances and compounds, required for the production process. The necessities may also include a space for removing waste products. By dialysis these necessity compounds and/or substances may get into compartments. Also, by dialysis wastes and other molecules may exit the compartments and return, be kept in the supporting section or carried away by supporting fluid.

In an embodiment, the upper section may be more or less empty. The upper section may be empty or partially empty so gasses that are formed during production may be released into this section. In an embodiment, other sections may be empty. In an embodiment, some of the sections may be empty in order to be filled by fluid coming out of another supporting section.

### Production in the Device Sector

In an embodiment, the method may provide conditions suitable for one or more chemical reactions within the plurality of the compartments for transforming the production mixture into a resulting mixture. The conditions suitable for one or more chemical reactions may be provided during a production process.

In one or more embodiments herein, the “Device sector” may be set up for the production process. The production process may be synthesis or posttranslational modifications. The production process may be synthesis and posttranslational modification. The device sector may be filled with the production mixture or mixtures. The bottom section or sections of the device may preferably be configured to be filled first and to be filled to their tops with an appropriate content and/or contents. In multiunit devices where the device's units are separated with bottom and/or top wall of units' envelopes or envelope like structures, all the bottom sections may be configured to be filled at the same time. At the time of one or more bottom sections being filled or after that, the side section, or in multiunit device sections, may be configured to be pulled up and the tridimensional grid or grids may be placed above the area provided for the production mixture. In an embodiment, the tridimensional grid may be operable to be pulled up all the way up to the envelope's or envelope like structure's top wall. After that, the middle of the device may be configured to be filled with production mixture or mixtures to exactly determined volume and height.

Once the input production mixture or mixtures are inloaded onto the lower membrane, the tridimensional grid's structure or structures may be operable to be dragged down into the middle of the device by one or more scaffold's tubes and/or one or more poles, and to form compartments in the middle, and to put the side section in appropriate space.

As the tridimensional grid's structure or tridimensional grids' structures are operable to be pushed down to the lower membrane or membranes, the production mixture or mixtures may be distributed into the wells of the tridimensional grid's structure or structures. This way each of the wells of the tridimensional grid or grids may be configured to get filled with the production mixture or mixtures at the same time.

Each well of the grid filled with the input and one or more output production mixtures may present one compartment. As the grid's elements may be filled with the mixture or mixtures, the tridimensional structure or structures may be under pressure and therefore may be pushing the surrounding production mixture or mixtures down into the wells. The levels of the production mixture or mixtures may be risen inside the wells, and the compartments may be filled to the top of the tridimensional grid's or grids' wells' walls.

As the upper membrane is placed on the top or within the top of the tridimensional grid's structure or structures, it may also be placed on the top of each compartment and it may separate the production mixture or mixtures from the upper section or sections. The side section or sections may be configured to be filled with fluid or fluids at the same time as the input production mixture or mixtures are inloaded into the middle of the device or device's units. The side section or sections may be configured to be filled with fluid or fluids after the input production mixture or mixtures are inloaded into the middle of the device or device's units. The side section or sections may be configured to be filled with fluid or fluids when the tridimensional grid's structure or tridimensional grids' structures are placed into the middle of the device or device's units.

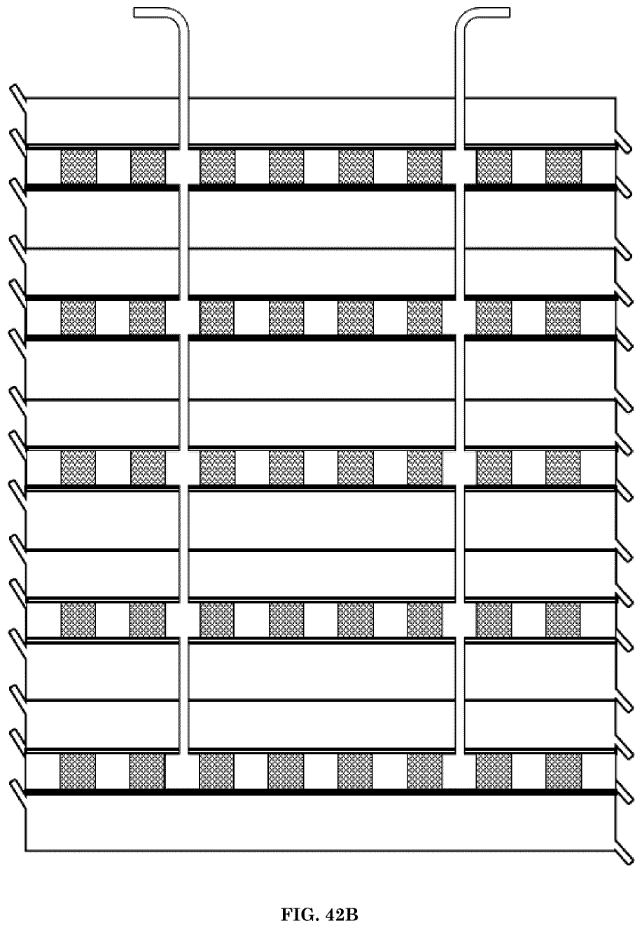

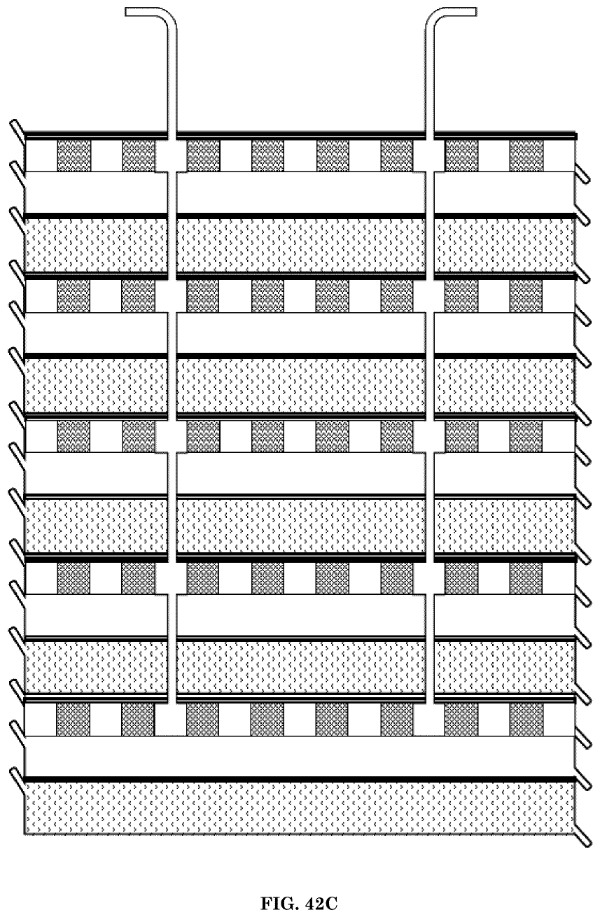

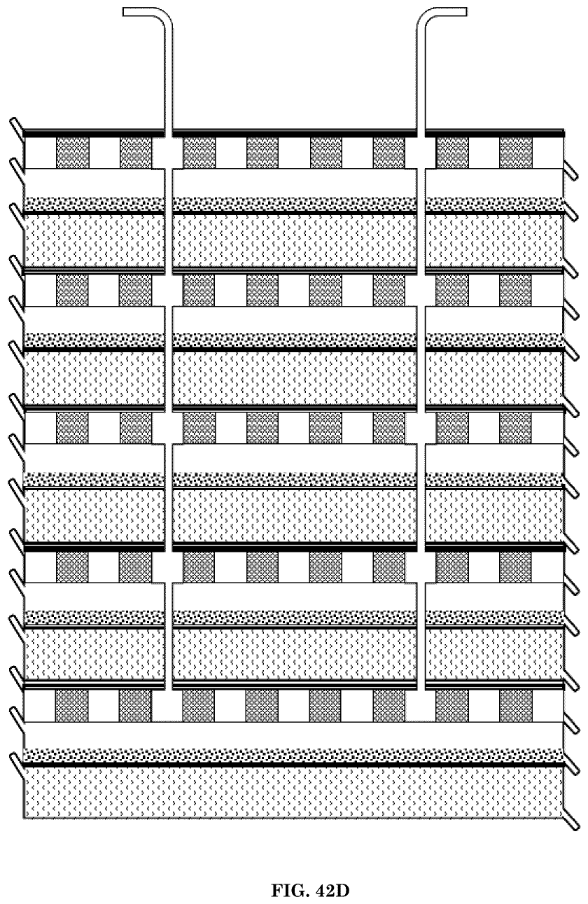

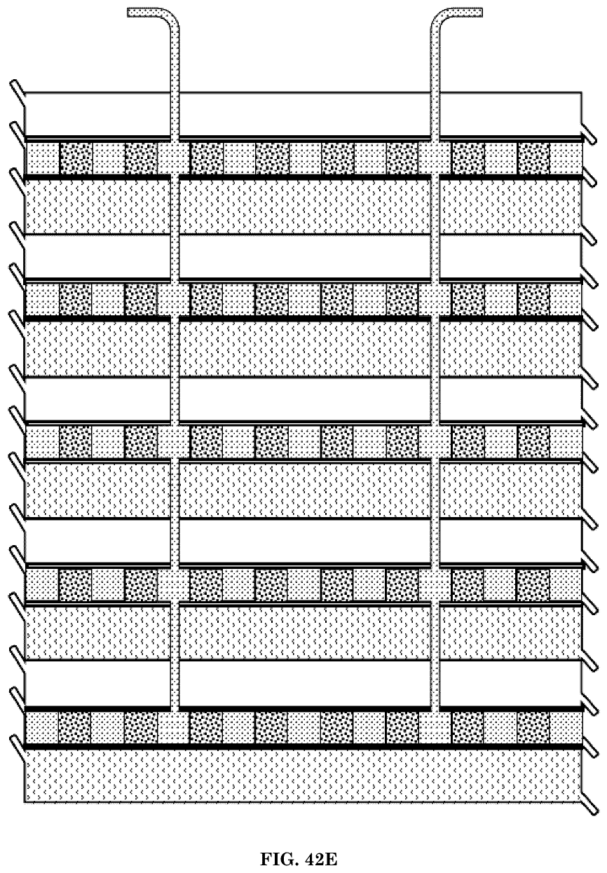

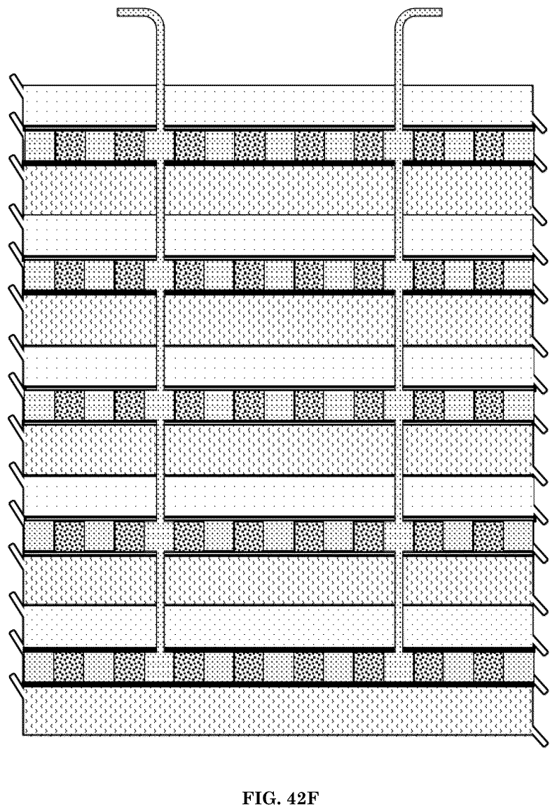

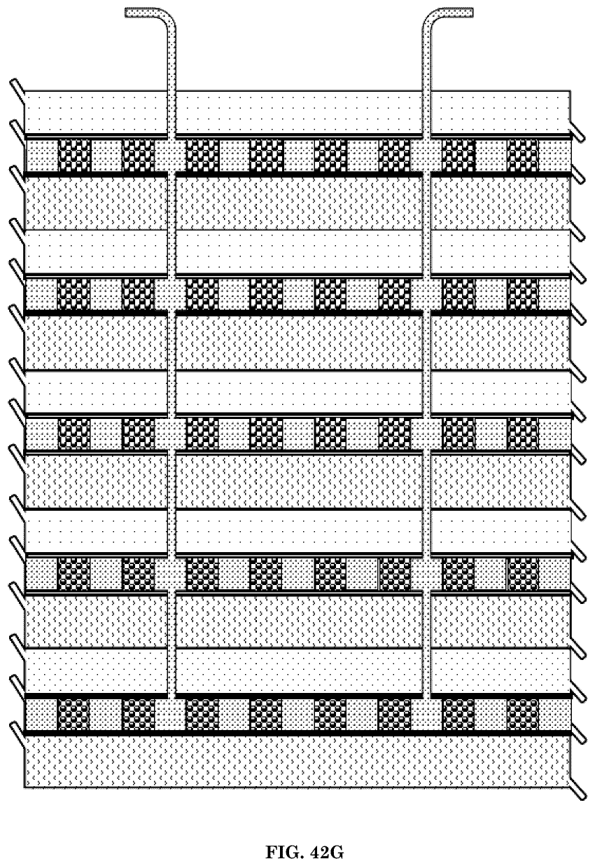

FIGS. 42A-42G illustrate different setups the devices. FIG. 42A is a cross section view of the one-unit device set up for synthesis and posttranslational modifications. In this figure, an empty device 1 is a starting point where the tridimensional grid is placed on top of its lower membrane. The schematic drawing of the device 2 shows the bottom section filled in with solution, and the grid pulled up by its scaffold tubes. The schematic drawing of the device 3 shows the middle of the device filled with cell free production mixture. As the production mixture is being poured in, the mixture is evenly distributed on top of the lower membrane. The schematic drawing of the device 4 shows the production mixture encapsulated inside the wells, forming compartments that are surrounded by the upper membrane, lower membrane and side walls provided by tridimensional grid's wells' walls the middle section and its compartments. This may be achieved by pushing down the scaffold and placing it onto the lower membrane. The schematic drawing of the device 5 shows the side section being filled by poured in solution through two scaffold tubes present in the device. The schematic drawing of the device 6 shows the upper section filled by solution poured onto the upper membrane. There may be some changes in setting up the devices to be filled with solutions and/or their flow during the process. The solution or solutions may be proper for a specific type of the performed production.

FIGS. 42B-42G illustrate setting up the multiunit devices for synthesis and posttranslational modifications. FIG. 42B is a cross section view of an empty device set up for starting the production process. In this device, the tridimensional grids are placed on top of its lower membranes. FIG. 42C is a cross section view of the device with its bottom sections filled with fluid and grids being pulled up by the scaffold's tubes. FIG. 42D is a cross section view of device with the cell-free production mixtures inloaded into the middle of the units and evenly distributed on tops of the lower membranes. FIG. 42E is a cross section view of the filled-in compartments of the middle sections and the grid of the device. This figure shows that when the scaffold is pushed down and placed onto lower membranes, the production mixtures are encapsulated inside the wells, forming compartments that are surrounded by the upper membranes, the lower membranes and the side walls provided by the tridimensional grids' wells' walls. The device is configured for pouring in solution through two scaffold tubes, whereas the side sections are filled with fluid proper to the specific type of production performed. FIG. 42F is a cross section view of the device having the upper section filled with fluid inloaded onto the upper membranes. There may be changes of fluids and/or their flow paths through the device. FIG. 42G is a cross section view of the device having all sections filled and products formed.

The tridimensional grid's structure or structures may be filled in through one or more of scaffold tubes, whose beginning or beginnings may be anywhere outside of a device. The scaffold tubes may preferably be on the top of the device as they enter it through the top wall of the envelope.

In a preferred setting, the device is configured in such way that flow of fluid is normal and not being enforced by any kind of pump, as it would be if beginning of the scaffold tube or tubes would be at the bottom or in some cases on any side or sides of device. In this setting, no matter how small or how large volume of the production mixture is in the device, the device is configured to provide significant control over production of the desired product by filling-in wells, creating compartments, placing from even the tiniest possible to the largest imaginable volumes of production mixture in them and surrounding them with supporting fluids in amounts and contents suitable to needs of specific production process that is being done and that may also be changeable over time.

In an embodiment, the device may have an upper membrane being held up while the tridimensional grid's structure is being pushed down into the middle section. At the same time, or in some cases after that, the device may be further configured to have an upper membrane being placed on the top, or in some embodiments, inside of the tridimensional grid's structure. When the upper membrane is placed on top, or in some embodiments inside of the tridimensional grid, the upper membrane may be configured to separate the side and the middle section from the upper section.

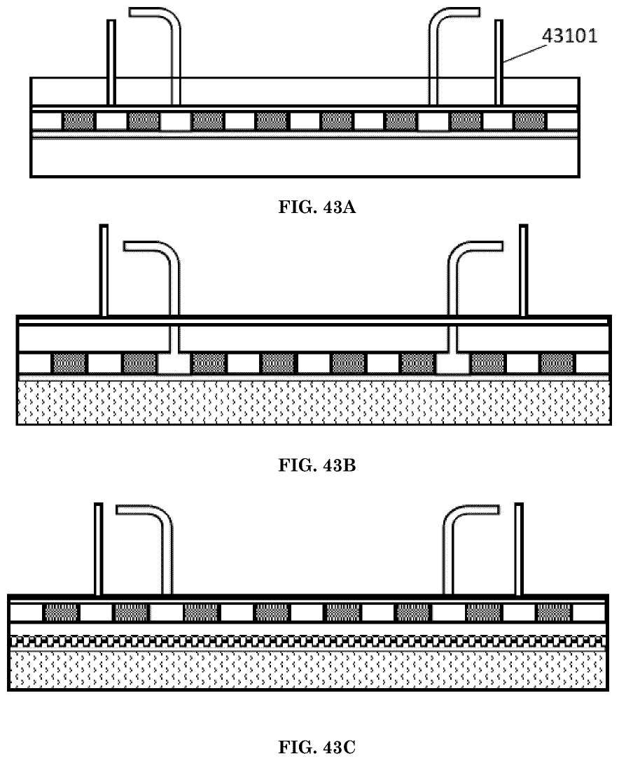

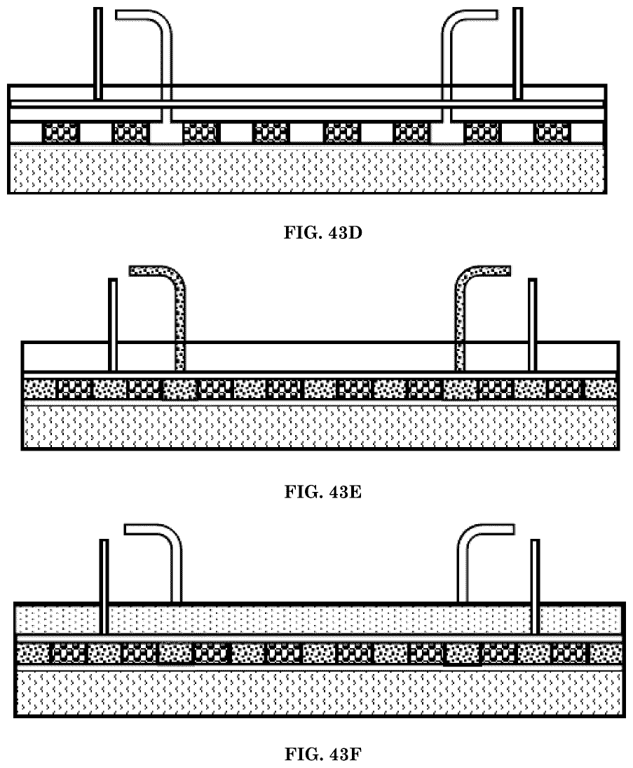

FIGS. 43A-43F illustrate a device with a movable upper membrane. In the drawings, the upper membrane is independent from the tridimensional grid and is operable to be moved separately from it by two handles it is equipped with. FIG. 43A is a cross section view of an empty device with the movable upper membrane equipped with a handle 43101. This figure shows a starting point of the production where the grid is placed on top of its lower membrane and the upper membrane is placed on top of the grid. FIG. 43B is a cross section view of the device having its tridimensional grid down and the upper membrane pulled up. In this figure, the bottom section is filled with a solution, and the tridimensional grid is still on top of the lower membrane. In this setting, the upper membrane is operable to be pulled up in the upper section by pulling up its handles. FIG. 43C is a cross section view of the device having a production mixture poured in the middle section. In this setting, the poured-in production mixture is evenly distributed on top of the lower membrane and the tridimensional grid is operable to be pulled up by pulling its two scaffold tubes up while the upper membrane is kept up. FIG. 43D is a cross section view of a middle section in compartments of the device. The device is configured to distribute the production mixture into the wells by pushing down the scaffold and placing it onto lower membrane. The production mixture in the wells is surrounded by a lower membrane and side walls provided by the tridimensional grid wells' walls. When the tridimensional grid is pushed down, the upper membrane is configured to be pushed down. FIG. 43E is a cross section view of the device having production mixture in the wells covered with the upper membrane. In this device, the upper membrane is down, placed on top of the wells. The side section is filled with solution poured in through two scaffold tubes present in the device. FIG. 43F illustrates the device having an upper section filled with solution poured onto the upper membrane. This device is fully set up for synthesis and/or posttranslational modifications. There may be some changing of solutions and/or their flow during the process. In some other embodiments, the upper membrane may contain or may consist of parts that are placed on tops of the wells.

In some of such embodiments, the membrane parts may be equal in shape and size with the grid's elements they are placed above. These parts of upper membrane may have handles 44001 attached to them. In that way they are operable to be pushed all the way to the bottom of the wells and to form a united structure with the bottom of the tridimensional grid's structure. Once the tridimensional grid is placed on the top of the production mixture, the above-mentioned parts of the upper membrane may be pulled up by the handles 44001 attached to them and, in that way, they may pull the production mixture up into the wells.

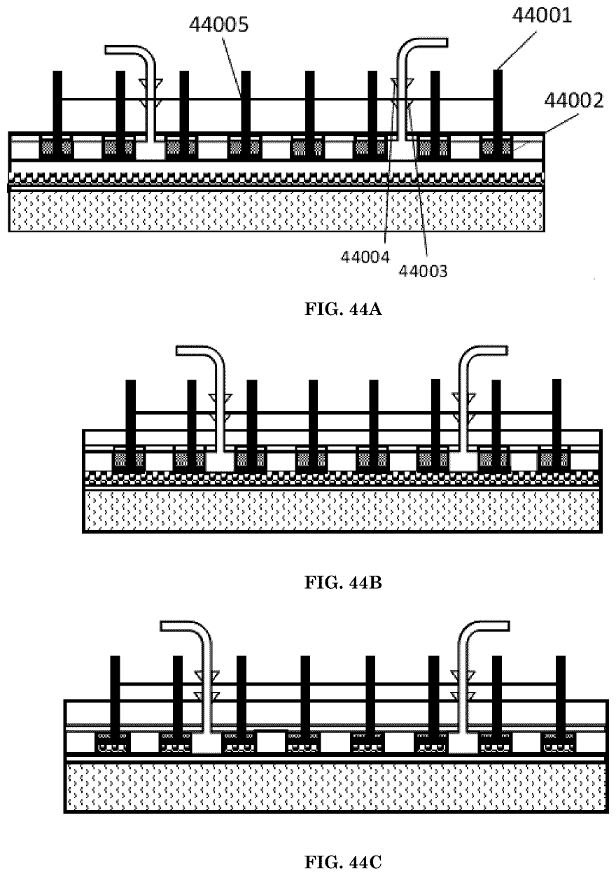

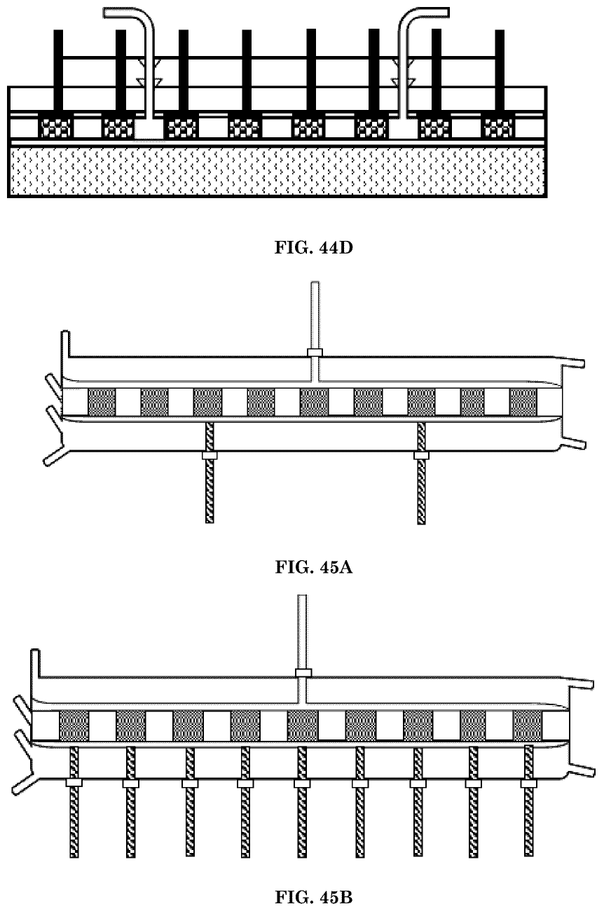

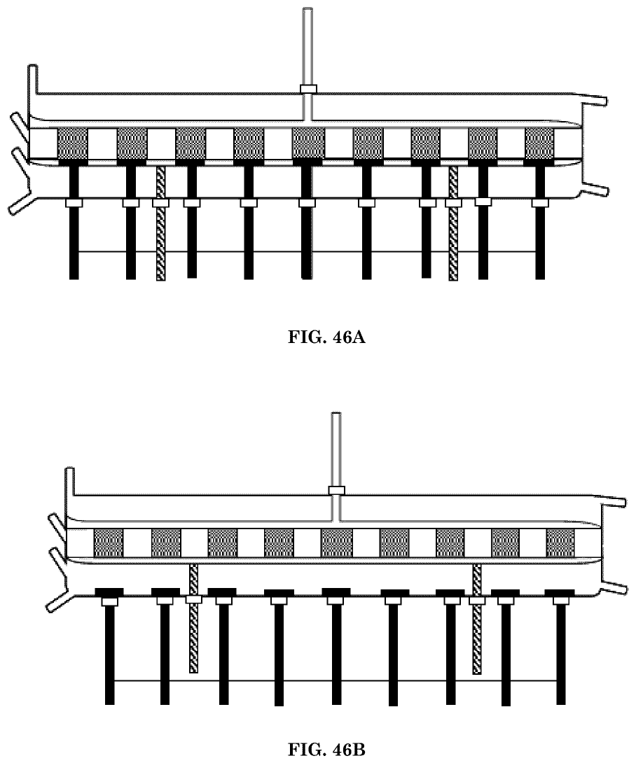

FIGS. 44A-44D illustrate devices set up for pulling production mixture into compartments of the device with movable parts of the upper membrane. In the drawings, parts of the upper membrane placed above wells of the grid are operable to be moved independently from it and are equipped with handles. The upper membrane may be attached to the tridimensional grid beneath it and handles may be linked with wire. When the upper membrane moves, all handles may be moved with it. Two sets of two holders may be attached to the scaffold tubes. The wire when placed on holders may enable two positions for parts of the upper membrane. Lower holders may be equipped with handles at the level that places upper membrane's parts into bottom of the wells. Upper holders are equipped with handles at the level that places the upper membrane's parts into top of wells. The rest of the setups may be the same as in the previous two figures. FIG. 44A illustrates a device having the tridimensional grid up. In this figure, the handle 44001 carries part of the upper membrane 44002. The handles are linked by the wire 44005. The device also includes the lower wire holder 44003 and the upper wire holder 44004. Once the bottom and middle sections are filled with suitable solutions, the tridimensional grid is placed in the upper section. When parts of the upper membrane are placed in bottoms of the wells, the wire connecting them is placed on top of the lower handles. FIG. 44B illustrates the device's setup, in which the tridimensional grid is on the top of the production mixture. In this setup, the tridimensional grid with all of its parts is operable to be pushed down by pushing down two scaffold tubes present in the device. It is placed on top of the production mixture. In this setup, parts of the upper membrane are arranged as they are arranged in the previous setup. FIG. 44C illustrates the device's setup for pulling the production mixture into the wells. While the tridimensional grid is still being pushed down, parts of the upper membrane are configured to be pulled up by the handles attached to them. In this setup, the production mixture is pulled into the wells. Parts of the upper membrane are configured to be pulled up by the handles by pulling up the wire that hold them together. FIG. 44D illustrates the device's setup for pulling the production mixture into the wells. At this setup, the tridimensional grid is placed on top of the lower membrane. Parts of the upper membrane are configured to be pulled up to the top of the wells. The wells hold the production mixture, and form compartments. The wire that holds handles together is placed on the upper holders attached to the scaffold tubes.

In an embodiment, the movable parts of the upper membrane may be equipped with rubber or any other material that enforce placement of the movable parts of the upper membrane in desired positions.

In an embodiment, handles of the movable parts of the upper membrane may be connected by the wire. In some of such embodiments, the scaffold tube or tubes may be equipped with holders that may hold the wire in at least these two positions. Thus, when the movable parts of the upper membrane should be at the bottom of the wells, the wire connecting handles may be placed on the lower holders on the scaffold tubes, and when the movable parts of the upper membrane should be at the top of the wells, the wire connecting handles may be placed on the upper holders on the scaffold tubes.

In an embodiment, the device may comprise an upper membrane that is independent from the tridimensional grid. In this setup, the upper section of the device may be equipped at its bottom with parts of the upper membrane. Instead of or in addition to handles attached to the upper membranes, there may be one or more scaffold tubes operable to move the parts up and down. The scaffold tubes may serve as inload and/or unload scaffold tubes for the upper section. In this setup, the upper section may be configured to be placed only on tops of the wells. Thus, each well may have its own upper section that may be the same or different than the others.

In an embodiment, the bottom section may be set up similarly. In an embodiment, parts of the lower membrane that are not placed under the wells may not be semipermeable. In an embodiment, portions of the impermeable material identical in length and width to the semipermeable parts of the lower membrane under the wells may be equipped with handles that may, but don't have to, be linked by the wire or any other item used for that purpose. This setup may allow starting or stopping the diffusion between the middle and bottom sections as necessary and may enable smooth flow of the resulting production mixture on top of the lower membrane if its other parts are impermeable. In an embodiment, the items may be bigger than parts under the wells and may be placed next to each other so they form a unified impermeable structure. Once synthesis and/or posttranslational modifications are over and enough fluid is unloaded from the bottom section, these parts may be operable to be pushed up under the lower membrane.

In an embodiment, if these items are as big as the lower membrane, they may replace the lower membrane, and the lower membrane may be removed.

In an embodiment, parts of the bottom section may be made of semipermeable parts of the lower membrane. Parts of the lower membrane may be equipped with the handles and/or scaffold tubes that serve as inload and/or unload tubes and/or handles. The setup may be similar to the setup provided for the upper membrane's and section's parts, where each well may have its own bottom section. The difference may be that these parts are configured to be filled first and that in these and such embodiments the rest of lower membrane may not be semipermeable, but may be made of impermeable material.

FIGS. 45A-45B illustrate poles holding the lower membrane. FIG. 45A illustrates a device with two poles on the lower membrane. FIG. 45B illustrates a device with numerous poles on the lower membrane.

In an embodiment, the structure or structures of the tridimensional grid may be properly placed into the middle section or sections. In this embodiment, the mount pad or pads may also be properly placed so that the grid or grids do not move during the pouring of the upper section or sections and/or production reactions and in order to prevent contamination. In this setting, the upper section or sections may be configured to be filled with fluid or fluids or left empty.

In an embodiment, the upper and bottom sections of two or more units may be not separated by bottom and/or top wall of units' envelopes or envelope like structures. In this embodiment, the way fluids inloaded into the device may differ from other embodiments where the upper and bottom sections of two or more units are separated by bottom and/or top wall of units' envelopes or envelope like structures. Fluids may, but don't have to, be first inloaded in the bottom unit of the bottom section of the multiunit devices. In this setting, the production mixture may be, simultaneously or sequentially, inloaded onto every lower membrane in the device. There may be one or more items configured to stop leakage of production mixture through semipermeable membrane. If the bottom section of the bottom unit of the device is not inloaded, all units may have these items. Otherwise, these items may not be needed.

In an embodiment, these items may include an impermeable lower membrane instead of the semipermeable lower membrane. In this setting, an impermeable membrane may be inside the device. The input production mixtures may be poured onto the membrane while the tridimensional grid may be placed on top of them. The input production mixtures may be divided into the compartments, the side sections may be filled with fluids, and the united upper and bottom sections may also be filled with fluids. Then, the impermeable lower membrane may further be back substituted with a semipermeable lower membrane, or a membrane with semipermeable openings beneath wells. The amount of fluids in the united upper and bottom sections may need to be adequate and correspond to the level at which a semipermeable lower membrane is placed. This setup may require impermeable items that have handles. These items may be placed under the wells while the united bottom and upper sections are being filled and removed during the production. The handles may be banded together. In an embodiment, there may be a stick that include handles operable to be moved left or right in order to be moved from the bellow wells. In an embodiment, the handles may be placed on a stick that may be operable to be turned back and forth in order to place the impermeable items under the wells or to move them away into the united upper and bottom sections in order for production to be done, i.e., make fluids from the bottom section to be able to pass through the semipermeable membrane that is at the bottom of the wells.

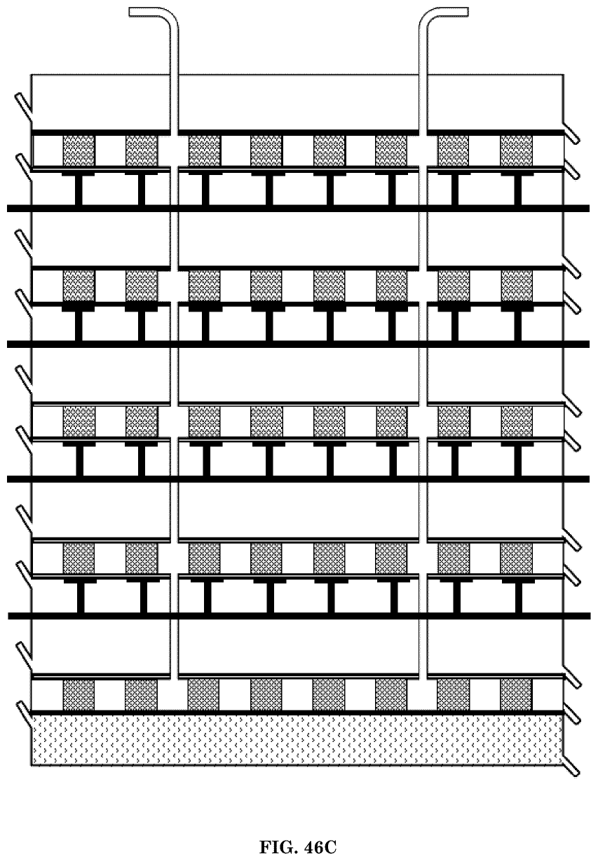

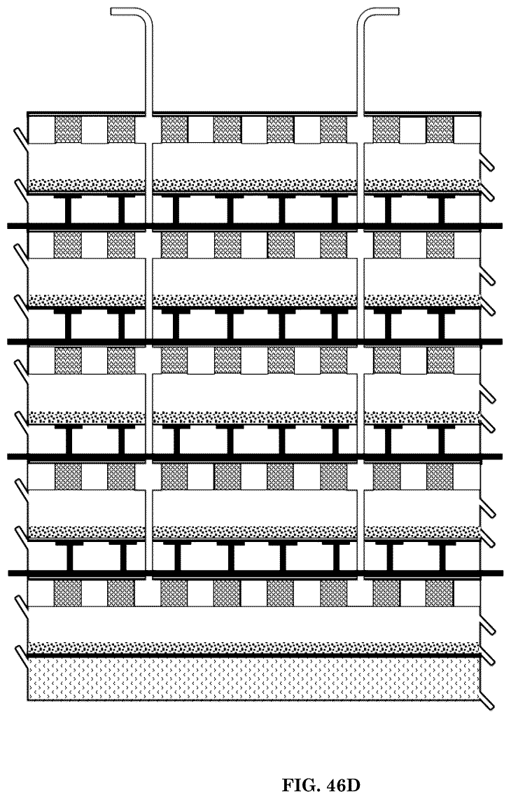

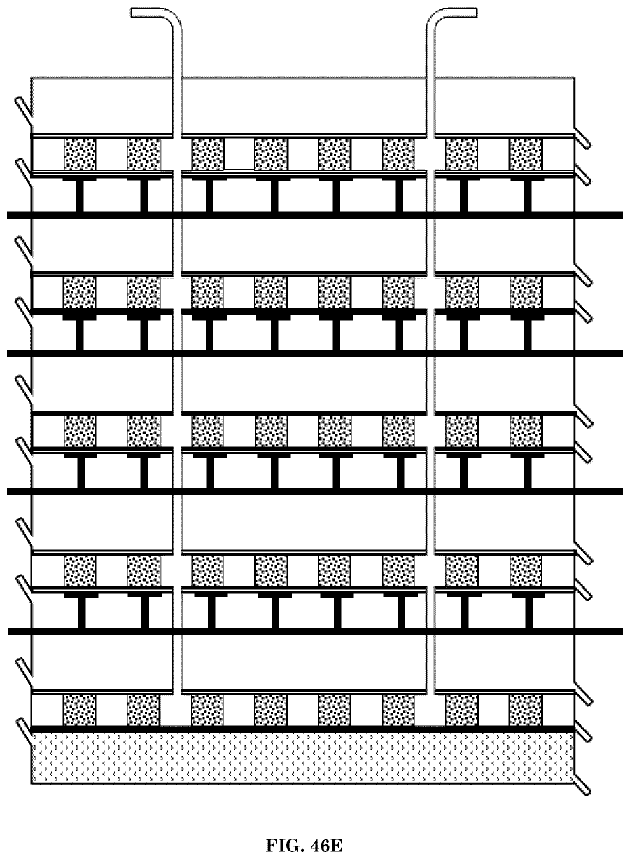

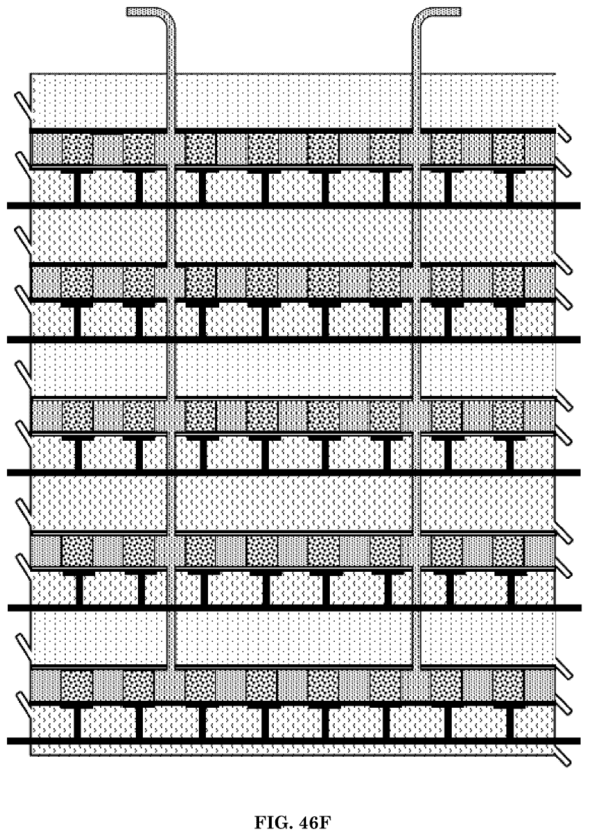

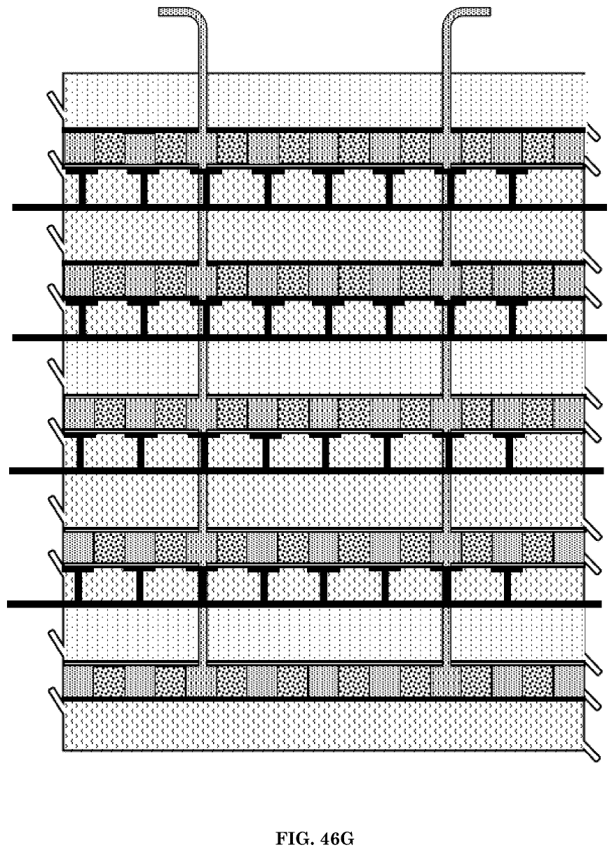

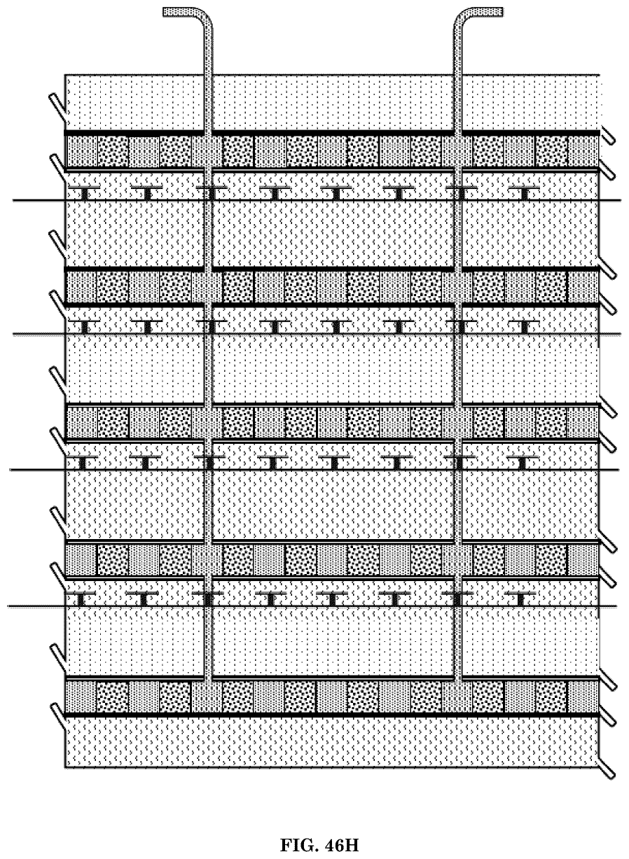

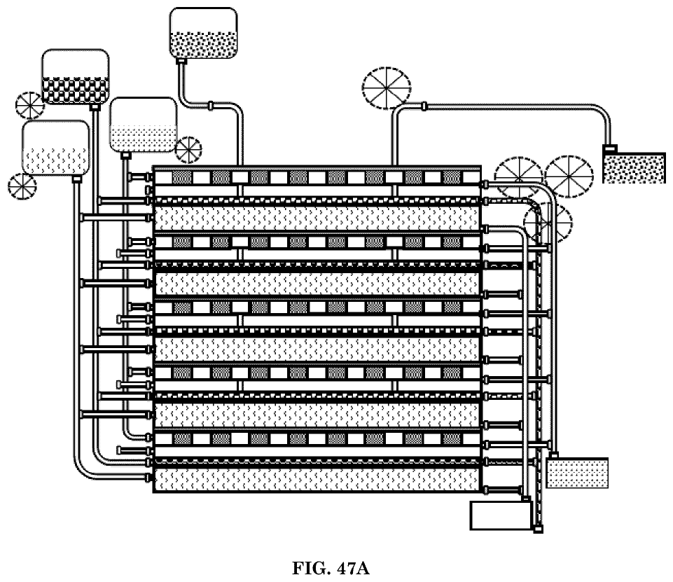

FIGS. 46A-46H illustrate impermeable items for the lower membrane in various devices' setups. FIGS. 46A-46B illustrate the impermeable items for the lower membrane in a one-unit device set up for pouring out. FIG. 46A illustrates the impermeable items up on the membrane. FIG. 46B illustrates the impermeable items down in the bottom section. FIGS. 46C-46H illustrate the impermeable items for the lower membrane in a multiunit device where the impermeable items enable functioning of the device having the upper and bottom sections of several units united. FIG. 46C illustrates an empty multiunit device having the upper and bottom sections of several units united. In this figure, only a bottom section of the bottom unit is filled. FIG. 46D illustrates a setup for filling production mixtures into an empty multiunit device having the upper and bottom sections of several units united, where the impermeable items ensure there is no leakage of production mixture. FIG. 46E illustrates a setup for placing production mixtures into the wells, where the impermeable items ensure there is no leakage of production mixture. FIG. 46F illustrates a setup for filling all sections with supporting fluids. In this figure, the impermeable items ensure there is no leakage of the production mixture. FIG. 46G illustrates a setup for impermeable items to be moved left from the wells. Once fluids are filled, leakage of the production mixture is not possible anymore, so the impermeable items may be moved in order for the production mixture to get in contact with fluids from the united bottom and upper sections. FIG. 46H illustrates a setup for the impermeable items to be turned away from the wells into the bottom sections.

Synthesis and/or Posttranslational Modifications

Once everything is set in place, as described above, the device section is configured for the start of the product's or products' synthesis and/or one or more posttranslational modifications, preferably, within the wells. The semipermeable portions of the supporting sections are operable for performing dialysis. Molecules from the fluids may go in and/or out of the wells in the middle section by passing through the semipermeable membrane. In that way all the created, added, waste and/or necessary molecules, may be exchanged between the production and some of the supporting sections, if they are capable of going through pores in the semipermeable membrane. Quantity, quality, type and the motility of the fluids in the supporting sections platforms may be changed during the process.

The device may enable the change of the fluid's or fluids' components over time by introducing new substances, solutions and/or mixtures into the supporting sections and/or by removing the old ones. The pumps may be operable to enable the fluid's or fluids' motility, i.e., unload existing and/or by introducing new fluids into the sections.

In an embodiment, the device may be configured to removing in whole or part of the fluids by opening exit or exits, i.e., unload valve or valves of the sections and/or by introducing new fluids into through the entrance or entrances, i.e., the inload valve or valves of the sections. One or more pumps may be part of and/or attached to any part of the supporting sections and/or any inload and/or unload tube, container or any other item used for that purpose. The device may be operable for supporting fluids to move through supporting sections which may also enable moving fluids inside the wells by tangential flow. Force, speed and amount of this movement may be adjusted by adjusting the movement of supporting fluids.

When gases are introduced into a section, they may have the ability, depending on sizes of their particles, to pass through some or all of the semipermeable membranes present in the device and, therefore, travel through some or all four sections of the device.

### Dismantling the Device

Once the product synthesis and/or post-translation or modifications is finished, the upper section or sections may be either empty or get unloaded. The mount pad or pads may be adjusted so that the upper membranes' handles, scaffold's tubes and/or poles may be moved. In an embodiment, the upper sections may be completely unloaded by sliding down the tilted upper membrane. The entire one or more tridimensional grids or one or more sides and then other sides may be dragged up, so that the middle section or sections may be disengaged from it or them.

In an embodiment, the output production mixture or mixtures may be movable out of the middle section or sections, as the tridimensional grid or grids raises on top of it and/or is pulled up. The production mixture or mixtures, this time resulting one or ones, may be compactus again and may get unloaded. The fluid or fluids from the side section or sections may be unloaded through the unload scaffold tubes or any other item used for that purpose. In an embodiment, after the middle section or sections are emptied, the bottom section or sections may also be unloaded. In an embodiment, the bottom section is configured to being unloaded before the unloading of the middle section. In these cases, the mount pads on handles, tubes and/or poles of the lower membrane may be released on one side, so that the lower membrane gets tilted by emptying of the bottom section. The lower membrane may be tilted so that the resulting mixture may slide down the lower membrane and may be unloaded, and fluid or fluids from the bottom section or sections may also be pushed for being unloaded. Once all fluids are unloaded from the device, the system may be operable to initiate elution. Elute may be inloaded into the device through the inload sector.

In an embodiment, the device may be configured for elution to continue to one or more separation sectors. In an embodiment, the bioreactor system may be configured for elute, after unload sector, the be collected in the unloading container and then discarded.

In an embodiment, the one or more items may be operable to move scaffold, inload and/or unload and other tubes, poles and/or all other items coming out of the device for enabling any part of the production process. These items may need to be moved in order to perform some of their functions. An embodiment provides different apparatuses machinery and/or gadgetry operable to enable this movement.

In an embodiment, a handle, and/or any other accessory used as a handle, may be attached and/or in any other way may be incorporated in one, some or all scaffold, inload and/or unload and other tubes, poles and/or all other items coming out of the device. These handles, and/or any other accessory used in purpose of a handle, may be more or less complex.

Besides that, the device may contain and/or may be placed onto or into some apparatuses, machinery and/or gadgetry that may enable shaking and/or mixing of the device's contents in order to enhance its performances and/or one or more synthesis and/or posttranslational modification reactions.

### Moving of the Device or its Parts

An embodiment provides a setup of the device where movement of scaffold, inload and/or unload and other tubes, poles and/or all other items coming out of device may be limited to their pulling out of the device and pushing into the device.

Regardless of the simplicity of these movements, there may be different moving apparatuses, machinery and/or gadgetry configured to enable movements. The complexity of the movement mechanisms may depend on the complexity of the machine that the device is placed in or part of.

In an embodiment, the moving apparatus may be a simple, manually moving handle or handles. In an embodiment, the moving apparatus may be a complex electric machine that moves the tubes and therefore the entire scaffold with it. In an embodiment, the moving apparatus may be electric. In an embodiment, the moving apparatus may be automatized.

An embodiment provides apparatuses, machinery and/or gadgetry operable to enable shaking and/or mixing in many different ways. The type of the apparatuses, machinery and/or gadgetry may depend on the type of shaking and/or mixing that enhances performance of the device and/or one or more synthesis and/or posttranslational modifications' reactions. The adequate apparatuses, machinery and/or gadgetry may be applied.

Also, the device may include stirring gadgets and/or pumps to enable stirring, mixing and/or pumping flow of fluids inside of the device. These gadgets may be configured to operate with least interferences with synthesis and posttranslational modifications.

### Unloading

In an embodiment, the method may provide removing waste material from each of the plurality of the compartments. The unload sector may serve to provide the device with removal of fluids that do not participate in production process anymore. The unload sections may be configured to be emptied in different ways. The unload sector may be operable for pumping and/or pouring out fluids. The main difference between the device's setup for pumping out and from that for pouring out may be that the setup for pumping out does not require tilting of the membranes of the device, while the setup for pouring out content of some sections may require tilting towards the unload opening or in case of the bottom section, pushing toward it. The upper and/or lower membranes may be tilted in order for fluids to be poured out. Tilting may be done by pulling up or pulling down some of the handles, tubes and/or poles. In some cases, the lower membrane may be dropped by releasing handles, poles and/or tubes on it.

### Pumping

In an embodiment, all sections may be operable to be emptied by pumping.

In order to unload some fluid out of the device, the device or at least one part of the unload sector may need to be equipped with at least one unload pump. Depending on the production volume, wells' capacity, delicacy of products and production components, type of the devices, fluidity of the fluids, there may be one or more pumps on one or more of the items.

In an embodiment, there may be pumps on the unload tubes only. In an embodiment, there may be one or more pumps on the unload containers only. In an embodiment, there may be pumps on one or more unload tubes and the containers at the same time.

In an embodiment, the pump may be inside the unload container. In an embodiment, the pump may be configured to be activated straight away when fluid is ready to start unload, in order to enforce its unloading. In an embodiment, the pump may be configured to be activated when enough fluid is unloaded into the unload container in order to pump out the rest of fluid or fluids.

In an embodiment, this pump or these pumps may be operable to direct flow of the fluid toward the unload openings in the device's envelope and enforce its flow through the unload items all the way to wastes', production's components', product's and/or any other content of interest container.

### Pouring Out

In an embodiment, all sections may be configured to be emptied by pouring out of fluids and/or mixtures. In an embodiment, the section may be configured for pouring the fluids out from this section by opening the envelope's wall or part of it that is placed in relation to that section and pouring the fluid out through that envelope's wall or part of it. In an embodiment, the middle section and/or sections may be configured to unload their content by pouring it out through the unload tubes. In these cases, other sections may be emptied also by pouring them out.

In an embodiment, the section may be configured for removal some of fluids from the section they belong to by tilting the membrane toward the unload opening. In an embodiment, the device may be configured to pouring the fluids out from the device by tilting the entire device so that fluid flows toward the unload opening.

In order for fluids to be unloaded, one or more upper and/or lower membranes, and/or in some embodiments the bottom envelope's or envelopes' walls, may need to have handles, tubes and/or poles that would enable its or theirs tilting, so that fluid that needs to be unloaded may slide down that membrane or wall and enter the unload opening by pouring out.

The membranes in the devices' sections that are being poured out may have flexible widenings at any, some or all of their ends. These flexible ends may stretch out as the membrane gets tilted, and in that way form a ceaseless joint with the unload opening. This configuration of the device may prevent leakage from the middle section into the bottom section and otherwise, while unloading the middle section by pouring it out. In an embodiment, the ends of the tridimensional grids may also have to be specially designed in order to fit such membranes.

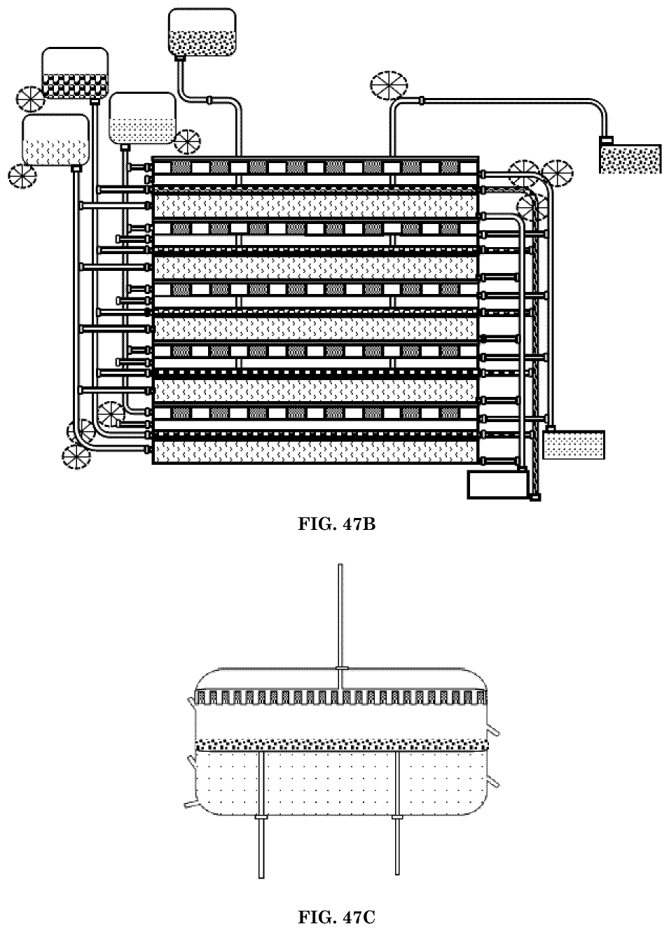

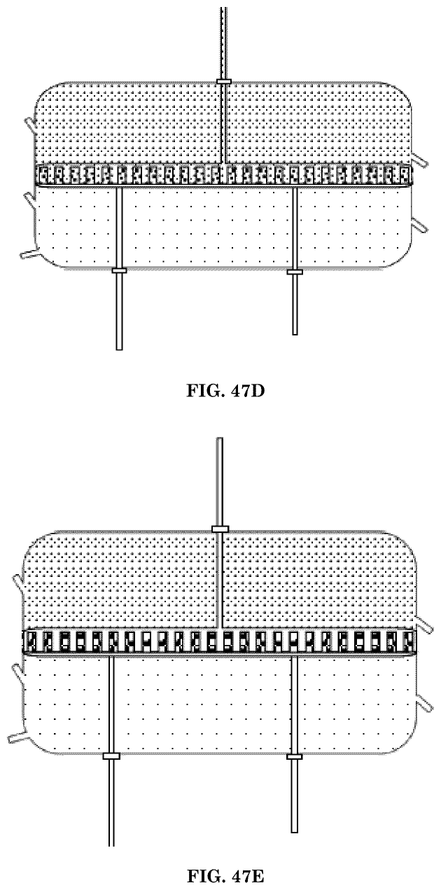

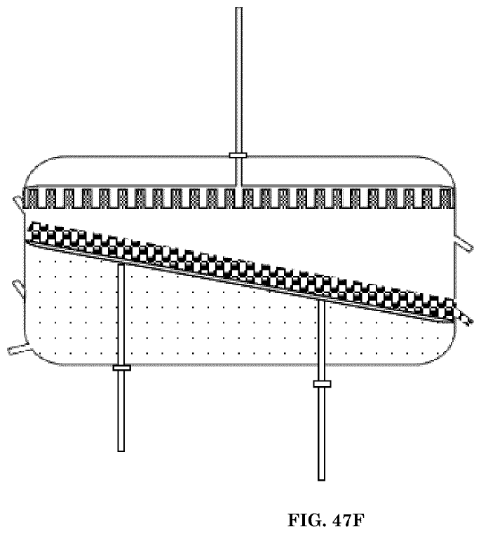

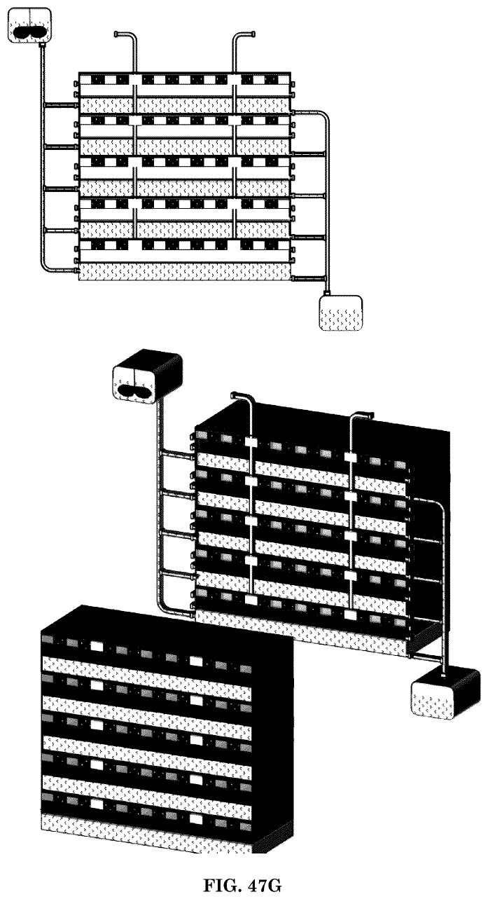

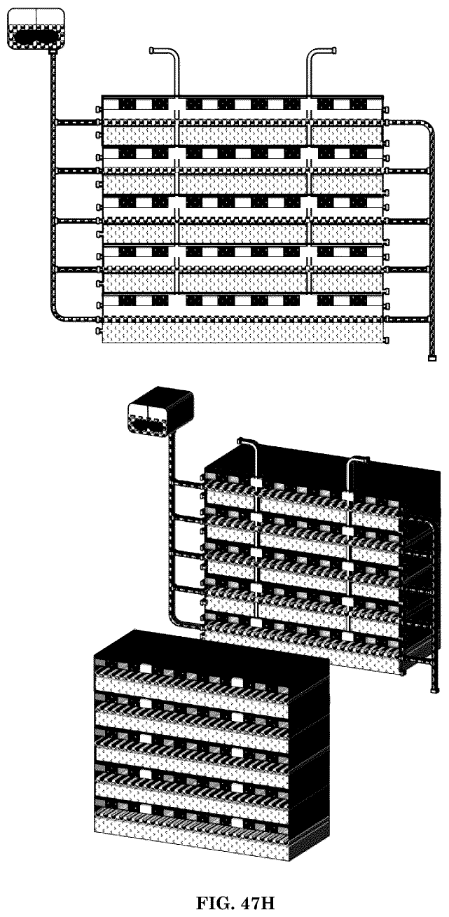

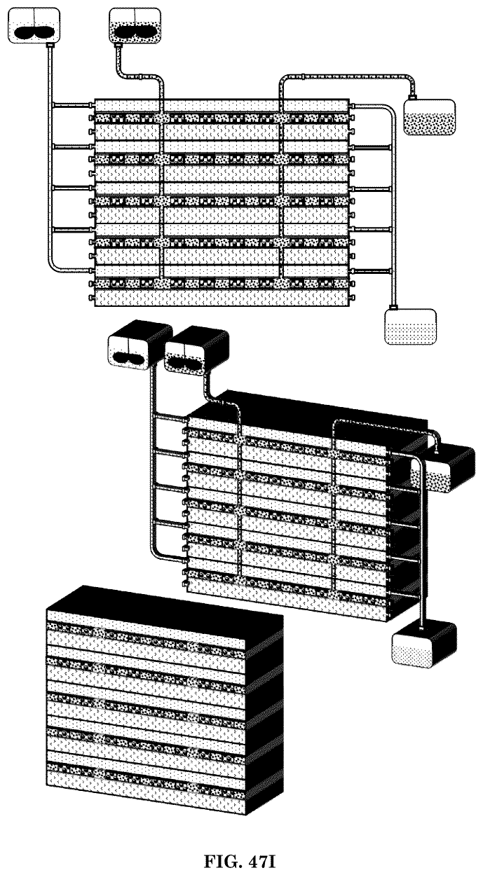

FIGS. 47A-47I illustrate setups of the devices for pumping and pouring out. FIGS. 47A-47B illustrate the pumping out sections. FIG. 47A shows pumps on the pouring in containers and the pouring out tubes. FIG. 47B shows pumps on the pouring in containers, pouring in and pouring out tubes. FIGS. 47C-47F shows tilting of the lower membrane. FIG. 47C illustrates setting up the device. FIG. 47D illustrates the device's setup for starting synthesis. FIG. 47E illustrates the device's setup at the time when synthesis and posttranslational modifications are over. FIG. 47F illustrates the device's setup for pouring out the resulting production mixture by tilting the lower membrane. FIGS. 47G-47I are 2D and 3D cross section views of the device setups for pouring in and out of the sections. FIG. 47G illustrates pouring in and out of the bottom sections. FIG. 47H illustrates pouring in and out of the middle sections. FIG. 47I illustrates pouring in and out of the upper sections.

In an embodiment, the device may be configured for direct flow of the fluids from the device into the unload container through one or more envelope and/or envelope like openings. In an embodiment, the device may be configured to transfer fluid from the device into the unload container through one or more tubes.

In an embodiment, the device may be equipped with a stirring gadget that may enforce flow. The stirring gadget may be a stirring machine. In an embodiment, the device may be equipped with a mixing machine that may enforce flow. In an embodiment, the bioreactor system may be configured to control pouring out fluid with opening and/or closing one or more appropriate valves placed within the unload sector. In an embodiment, these valves may be placed on one or more unload device's or devices' openings so they contain fluid or fluids in it or them. In an embodiment, the device may be configured to push one or more fluids toward the unload opening by tilting part of and/or the entire device.

In an embodiment, the device may be configured to pouring out of sections' fluids through the top or bottom envelope's wall. For example, in some embodiments, there may be the opening only in the form of the top envelope's wall of the device. In that case, after the top envelope's wall is open the bottom section may be poured in, then the lower membrane may be placed on top of it and then the input production mixture may be poured in and then the rest of the tridimensional grid may be placed on top of the lower membrane filling in the wells with production mixture.

The device may be further configured for the side section fluid being poured in and then the upper section fluid being poured in on top of it. The device may be configured for several cycles of pouring in and pouring out of the upper section's fluid during the production process. After the synthesis and/or posttranslational modification production reaction or reactions in a bioreactor are over, the top envelope's wall may be opened and the upper section's fluid may be poured out. After that the tridimensional grid containing side section's fluid may be pulled out of the device's envelope. Then the device may be configured for the resulting production mixture to be poured out of the device.

After that, the device is configured for the lower membrane to be taken out of the device and the fluid from the bottom section to be poured out of the device. In an embodiment, the device may be configured for the middle section's fluid being poured out through the tube. In an embodiment, other sections may be configured for fluids to be pumped and/or poured out of the device. For example, in some embodiments, the bottom section's fluid may be pumped out of the device while the upper section's fluid may be poured out, and otherwise. Besides tilting the device in order to help pouring out of the fluids, the device may be configured for tilting of the lower and/or upper membrane and/or bottom of the device in order to pour fluid or fluids out of the section it or they are in. In an embodiment, the upper membrane may be tilted by pulling one of the tubes on the opposite end of the one where the unload opening is placed. In that way the upper section's fluid may slide toward the unload opening. If the lower membrane is tilted toward the unload opening, then the device may be configured for the resulting production mixture being poured out through that opening. In an embodiment, there may be one or more poles that may enable tilting of the membrane or membranes. In an embodiment, there may be one or more tubes attached to the lower and/or upper membrane to help its tilting and serve as the inload and/or unload tube or tubes for the bottom and/or the upper section. The tubes may be used to inload and/or unload fluids below the lower and/or above the upper membrane, respectively. By tilting the lower membrane toward the unload opening the middle section's fluid may slide towards it. The device may be configured for tilting the lower membrane toward the unload opening which may push the bottom section's fluid toward the bottom section's unload opening. In order to speed up the process of unloading the bottom section by pouring out fluid from it, in some embodiments, there may be poles, handles and/or tubes attached to the bottom envelope's wall to enable its movement.

In an embodiment, there may be tubes, handles and/or poles attached to the bottom envelope's wall or envelopes' walls and the lower membrane or membranes. Poles may ensure stability, placement and tilting of the item, while tubes may do all that and also may provide fluid or fluids to the section.

In an embodiment, there may be poles attached to the bottom section carrying plates that may be the same size and shape as wells' bottoms. When production is over, the plates may be pushed up and may close the wells from the bottom in order to stop leaking of the middle section's fluid with the resulting production mixture that is present in the middle section. This setup may allow easier sliding of the middle section's fluid mixture into the unload tube. The plates may preferably be placed underneath the wells. At first, they may be pulled all the way to the bottom of the bottom section while the bottom section or sections are filled and production in the device is performed. After that, when the bottom section is emptied enough, they may be pushed up in order to close the wells from below. Preferably, unload tubes' openings may be tipped down and placed on the bottom of the section they belong to. In that way, normal flow of fluids going through them may be enabled.

In an embodiment, the unload tubes may be closed before unload of fluids. In an embodiment, there may be valves, screws, rubbers, caps or any other form of closing the unload tubes.

Preferably in some embodiments, where one of the sections is empty, the membrane pores between the empty and one or more adjacent supporting sections may be wider than the ones adjacent to the production mixture containing section, so that fluid may flow more easily from one supporting section to another.

### Production Process

The non-limiting example of the production process in the compartmentalizing bioreactor system is shown in FIG. 1B. In this figure, the “Filing containers” serve to inload fluids into the “Device” where cell-free synthesis and posttranslational modifications take place. The device is equipped with the “Pump” operable to pump the resulting fluids and/or to pour out from the upper, middle and bottom sections. The pump may also pump the resulting fluid from the side section of the device. The resulting fluids, except the resulting fluids from the middle section are going into the “Waste container.” The fluid or fluids from the middle section go to the tube that contains the “First line of separation.” In the “First line of separation,” the desired product is separated from the rest of the production mixture. The bioreactor system includes “Detection” devices to observe quality of this separation. The tube for the “First line of separation” contains three valves for separating fluids based on the obtained results. One valve is configured for opening production components' pipeline, another valve is configured for opening the desired product's pipeline, and the third valve is configured for leading to the redirecting tube. This tube is equipped with a “Pump” and serves to redirect fluid that is not satisfactorily separated back to the “First line of separation” tube for one more separation, which may be repeated as many times as necessary, until the separation is satisfactory. Fluid that contains production components is flushed through a tube into another tube for “Separation of production components.” The tube “Separation of production components” is also equipped with one or more detecting devices to monitor this separation. The “Separation of production components” tube serves to determine what, how many and in what condition are production components present in the rest of the production mixture, and to determine whether they may be used again in production or not. If the detected production components are satisfactory, they are released through the valve on the recycling tube for recycling of production components. The recycling tube is equipped with a “Pump” that helps to return production components back to the “Device” for further production. If there are any faulty production components, they are released through another valve. Depending on whether the signal shows unsatisfactory production components or their poor separation, the system is configured for different measures to be taken. If the detected signal shows unsatisfactory production components, they may be thrown into the “Waste” container. One of the redirecting tubes is equipped with a valve leading to the “Waste” container, and the opening of the valve allows unsatisfactory production components go to the “Waste” container. If the signal shows inadequate separation, fluid is redirected to the tube for “Separation of production components” by using the redirecting tube equipped with the “Pump.” There may be as many separation cycles within the “Separation of production components” as necessary until separation is satisfactory. Fluid containing desired product flows through the tube to the “Altering well,” in which chemical, physical and/or biological altering of this fluid take place. This well is equipped with a “Pump” for better mixing of the reaction components. The bioreactor system further includes the tube “Second line of separation,” where the resulting fluids goes following the alteration. The “Second line of separation” tube is also equipped with detection devices. The “Second line of separation” serves to distinguish satisfactory products from faulty ones. If the product is satisfactory, preferably, it is flushed directly through normal flow of the “Two end” tubes and collected in the “Products” container or vial. If the product is unsatisfactory than the valve on the widening of the two ended tube is opened and the fluid is flushed into the “Waste container.” In an embodiment, unsatisfactory products may be flushed through normal flow into the “Waste container,” while satisfactory products go through the widening part into the “Products” container or vials. Products and waste obtained in the desired product's pipeline, as well as waste obtained in the production components' pipeline are measured on the “Scale” as one more of detection and control devices. The scheme shows the production process, but it is non-limiting, as there may be other embodiments with different steps of the method. The production process may be used for improved, continuous production of peptides, polypeptides, proteins, nucleic and/or amino acids, their strings, genetic material and/or their conjugates with same and/or different molecules, with possibility of recycling some of the production components.

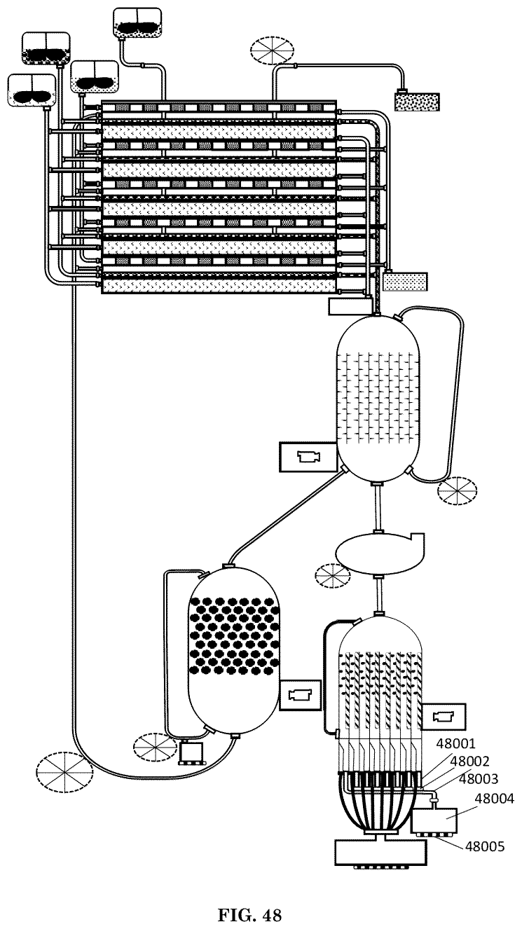

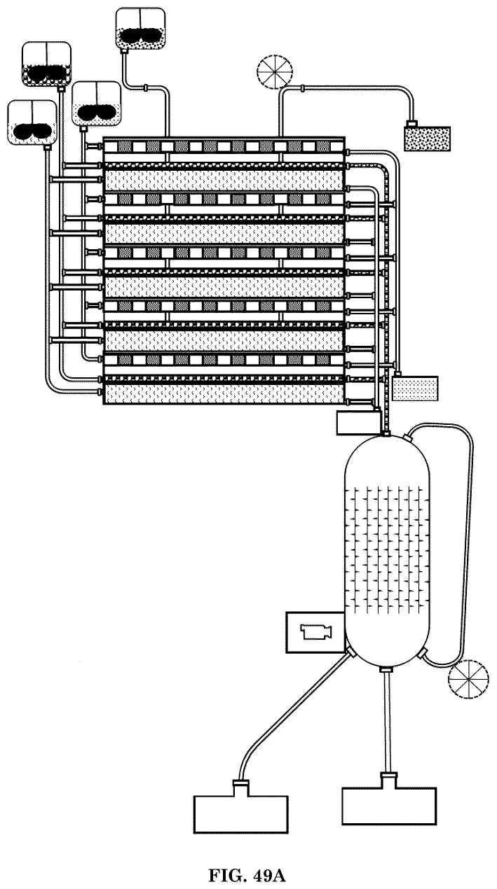

FIG. 48 illustrates collection of the products in a container. In this figure, the pipe 50001 carries the desired product to the tube 48003 through the tube and pipe joint 48002 into the container 48004 equipped with the scale 48005.

FIGS. 49A-49E illustrate examples of production setups of a bioreactor system with parts of subsequent machinery excluded. FIG. 49A illustrates an exemplary production setup without parts for the second separation and chemical and/or biological treatment of the products and recycling of production components. FIG. 49B illustrates an exemplary production setup without parts for recycling of production components. FIG. 49C illustrates an exemplary production setup without parts for the second separation and chemical and/or biological treatment of products. FIG. 49D illustrates an exemplary production setup without parts for the second separation of products. FIG. 49E illustrates an exemplary production setup without parts for the second separation products and recycling of production components.

### Separation and Recycling

In an embodiment, the method provide separating production components from a desired product within the resulting mixture. The first line separation may be provided in order to distinguish the desired product or products from the rest of the resulting production mixture.

In an embodiment, a big tube may gather all the middle section's or sections' fluids, that are in the device. That tube may then be divided into small tubes that contain the first line separation. In an embodiment, each middle section's fluid of the device may be inloaded into a separate tube that contains first line of separation. FIG. 50A-50F illustrate setups for the separation sector. In these drawings, each middle section's pouring out tube is connected with the separate first line of separation tube containing a redirecting tube. FIG. 50A illustrates each middle section's fluid of the device is inloaded into a separate tube that contains the first line of separation 50001-50008. In this figure, the separate pouring out pipe 50001 from one middle section leads to the separate tube 50002 for the first line of separation connected to the first line of separation machinery. In this setup, the pipe 50004 carries the production mixture that does not include the desired product. This pipe leads to the pipe 50005 that carries the combined production mixture from all other pipes that do not include the desired product. This setup also includes the separate redirecting tube 50006 for the first line of separation. For example, by opening an appropriate valve 1014 on the first separation tube, the rest of the resulting production mixture may be directed toward the separate tube 50007 that is intended for its further processing. The separate tube 50007 carries the desired product mixture to the tube 50008 that carries the combined desired product mixture from all tubes. In an embodiment, the tube 50008 leads to an altering well and then to second separation line. In some other embodiments, this tube can lead to a single or multiple operations of further processing. In an embodiment, the tubes 50008 are connected to the second line of separation tube's section 50009. This section includes the pipe 50010 connected with the redirecting tube 50011 for the second line of separation.

FIG. 50B illustrates a bioreactor system where the first line of separation is done in separate tubes for each middle section and production setup is without a second separation and chemical and/or biological treatment of the products and recycling of the production components. FIG. 50C illustrates the first line of separation production setup without machinery for recycling of the production components. FIG. 50D illustrates the first line of separation production setup without machinery for the second separation and chemical and/or biological treatment of the products. FIG. 50E illustrates the first line of separation production setup without machinery for the second separation of products. FIG. 50F illustrates the first line of separation production setup without machinery for the second separation products and recycling of production components.

The first line of separation may be any setup that leads to the adequate degree of separation of the desired product or desired products from the rest of the resulting production mixture.

In an embodiment, the separation sector may be configured to retain the desired product on stationary phase and to separate the desired product from the rest of the middle section's or sections' fluid or fluids, i.e., the resulting production mixture. In an embodiment, the stationary phase 50003 may be on the inside of part or parts of the first separation tube or tubes. The separation sector may comprise the chromatographic equipment operable to perform chromatography in order to differentiate the product of interest from the resulting production mixture. The chromatographic equipment may be effective because it may keep the product of interest in place, while rest of the mixture's components and other materials may be cleared with the elute. The chromatographic equipment may be configured for the affinitive chromatography. The type of affinity chromatography stationary phase may depend on the desired product. For example, in case of monoclonal antibody being a desired product the stationary phase may be protein A.

The separation sector may be further equipped with the signal detectors 1008. In an embodiment, the signal detectors may be spectrophotometers. The signal detectors may be configured to detect signal and to make sure whether the separation process is done adequately and completely.

If there is no satisfactory separation of the desired product and the rest of the resulting production mixture, the setup may include two valves on the first separation tube or tubes, which may be closed, and for liquid to be directed by opening the lower valve 1011 to the repetitional tube (redirecting tube) 1010, 50006 and, by help of the pump 1012 to be again introduced into the separative tube or tubes 1013, 50002.

The redirecting tube 1010 may also be used as a part of elution road when the elution of the first separation tube or tubes is necessary. Once the separation is satisfactory, the separation sector may be configured for the desired product to be eluted from the stationary chromatography phase and directed to its own section. In this setup, the valve may be configured to be opened at the time the detecting device shows satisfactory signal. In an embodiment, the first separation tube that separates the desired product from the rest of the middle section's mixture may have three valves at its ends.

One of the valves may serve to let by the desired product, the second valve may serve to let the rest of resulting production's mixture and the third valve may direct the liquid to the repetition tube, so it lets by both the desired product and the rest of resulting production's mixture in order for them to be separated again.

During the purification process, only one valve at the time may be opened, depending on what the detecting device is showing. Depending on the valve that is being opened, adequate material may be directed through the following pipeline. There may be at least two main pipelines: the desired product's and the production components' pipeline.

In an embodiment, separate elution tube or tubes may be provided to the subsequent machinery or certain part of it.

In order to speed up elution, there may be elution tubes that enter the first separative tube and/or the second and/or other separative tubes. The elution tubes may, but don't have to, be equipped with one or more valves at their beginnings and/or ends. The elution tubes may be coming out of the inload container that is mutual for the device and the subsequent machinery or may have its or their own inload container.

One or more separate unload elution tubes added to the subsequent machinery or part of it may provide unload or, preferably, when the entire bioreactor system is being eluted, the elute fluid may go to the waste containers.

In an embodiment, the method may further comprise recycling the production components. The recycling may comprise directing the production components into the bioreactor device for another production cycle.

In an embodiment, the separation sector may be connected to a recycle sector. According to the detected signal, the adequate valve may be opened. Referring to FIG. 1C, if everything is correct with the production components and their separation, the certain range of signal may be detected and the corresponding valve 1040 may be open. The production components may be directed through the recycle tube 1042 into the appropriate inload container back into the production. This may be done with the help of one or more pumps 1046. There may be a valve in a place where the recycle tube is connected to the input production mixture inload container. This valve 1041 is configured to open when the production components' mixture is redirected back into the inload container.

In an embodiment, the recycle tube may contain one or more wells where the production components may be physically, chemically and/or biologically treated. In an embodiment, there may also be additional separation lines and/or detection devices after the treatment wells. In case of any production components separation faulty, signal may differ from the correct range, and then the adequate valve may be opened. In an embodiment, production components may be then directed into waste 1043-1045.

In an embodiment, they may be directed into another redirection tube 1036. If the detected signal shows poor separation, the lower valve 1045 may stay closed and production components' mixture may be directed further through a tube back again into the separation column, in order to repeat the separation. This process may be done as many times as necessary in order for production components to be separated properly or turned to waste. There may be a valve on place where the redirecting tube is connected to the separation tube and then this valve may need to be opened when the production components' mixture is redirected into the separation column. Also, this process may be done with the help of one or more pumps 1039. If detected signal shows that the components are faulty, the lower valve may be opened and the components flushed and/or may be thrown to waste.

Each product, production component and/or waste, that has come out of or it is flushed from the bioreactor system may be measured on weight scale, at proper time, so there may be an exact notion how much of each of the fluids is missing and potentially may be replaced. At each point where the product or products and/or production components are collected they may be thrown to waste or further processed outside of the bioreactor system.

### The Desired Product Pipeline—Alteration, Purification and Collection of the Desired Product

In an embodiment, the method may comprise collecting the desired product.

In an embodiment, the method may further comprise chemical or physical altering of the desired product prior to its collecting. Referring to FIG. 1C, the part of desired product's pipeline may comprise the well 1016 to hold the product that may be altered, i.e., chemically, physically or biologically treated. The product may be altered within the well to block or eliminate virus contamination. The well may be of different shapes, sizes and materials. There may be more than one well. The well may have an opening 1015 through which material may be added or it may be intended for other purposes. In an embodiment, the opening on the well may be used also for unloading of material from the well.

In an embodiment, the opening on the well may be used only to unload of material from the well. When not used, the opening may be closed. In an embodiment, the opening may be closed with a cap. The well may, but does not have to, be equipped with by one or more pumps 1018 for mixing purposes.

In an embodiment, the well may have an exit valve. There may be more than one exit valves. One of the exits of the well may have a valve 1017. In an embodiment, one or more valves may be placed at the openings, i.e. entrances and/or exits of the wells. The exit valves may preferably be closed when the product is being chemically, physically and/or biologically treated. Once the reaction is over, the valve on the well's exit may be opened for the continuity of the process flow through the tube 1019.

In an embodiment, the method may also comprise further separation or purification of the desired product prior to its collecting. Referring to FIGS. 1C, 50A and 50C, the bioreactor system may have a second separation pipeline 1020, 50009 configured for the continuity of the product or products flow for another cycle of desired product's or products' purification as shown on. The second purification line may be included to confirm the quality and/or effectivity of the created product or products.

More precisely, the second purification line may be operable to separate satisfactory products from the products of the unsatisfactory quality. The second separation pipeline may be configured to include one or more purification items.

In an embodiment, the purification item may be an affinitive chromatography system.

In an embodiment, the inside of the tube or tubes of the second separation line may be coated with a stationary phase. The second separation pipeline may be configured to provide adequate separation of the desired product or products. The pipeline may be equipped with a signal detector 1021 operable to detect quality of the product and need for further purification. In an embodiment, the signal detector may be a spectrophotometer. The signal detector may be an instrument for detection of circular dichroism. At the end of the detection part of the tube there can be a valve that is opened when the signal shows clear separation 1022 as shown in FIG. 1C.

When the signal shows inadequate separation, the valve may be closed and the mixture may be redirected to the same tube for another cycle of separation. The system may include a pump operable for redirecting flow of the mixture. There may be a valve at the connecting part of the connecting tube 50010 and redirecting tube 50011 and purification tube as shown on FIGS. 50A and 50C. The valve may be configured to be opened when the mixture is intended to re-enter the purification tube. Referring to FIG. 1C, the redirecting tube 1024 equipped with a pump 1025 may be operable to return the desired product mixture into as many cycles of purification as needed until the separation signal is clear. Once the signal is clear, the valve 1026 may be opened for the product to continue to flow through the two-ended tube. The tube may be expanded at some point and the expanded part may be divided into, at least, two parts. In an embodiment, the tube's expansion may be divided into two parts, where one part of the tube may be placed directly under the normal flow of the tube and covered with a cap and another part of the tube may be placed within the expanded part. In this type of embodiments, the widening of the tube 1028 may start somewhere above the cap of the opposite part of the tube, i.e., above the cap on the opposite wall of the tube. While the section under the normal flow of the tube 1027 may have a valve in the form of cap, another section may be empty. When the cap is opened, fluid may be poured directly into that section and when the cap is closed, the product may flow over it into an empty section. The cap valve may be opened and closed in accordance with the signal detection.

In an embodiment, if the signal shows correct product, no action may be needed, the valve may stay closed and the desired product may go over the closed cap and into the empty part. In an embodiment, these parts may be directing tubes 48001 and 48002 as shown in FIG. 48. If the signal shows any inadequacy of the product, the valve may be opened and the fluid may go through tubes 1031 automatically to waste container 1032 as shown in FIG. 1C.

In an embodiment, in the middle there may be a stick holding a valve that may be turned left or right. Therefore, on one side there may be a valve in the form of a cap, while the other one may be empty. Depending on the recorded signal, the stick may be turned in the direction for a valve to cover the adequate tube part. When the detecting device shows a signal in the range of the waste products, the stick may be turned in the way that the valve cap is covering the part that is directly under the normal flow of fluid and leaves the perforated part open, so that waste flows over the cap into perforated part and from that directly into the waste. When the signal is detected in the range of the desired product, the cap may be turned into the perforated section and normal flow of the fluid simply may continue into the part that is directly underneath it.

In an embodiment, the bioreactor system may comprise a bowl or a container to collect one or more products as shown on FIGS. 50D and 50E. In an embodiment, the desired product may be collected into vial 1029, bowl or container 48004 as shown on FIGS. 1C and 48. In an embodiment, empty sections may be attached to one or more tubes that may be united into one tube 48003 and the desired product may there be collected into a vial 1030, bowl and/or container 48004 as shown on FIGS. 1C and 48. In an embodiment, the desired product may be filtered.

In an embodiment, the method may comprise weighing the desired product. Each vial, bowl or container with the desired product may be measured as one more form of quality control instruments 1030 and 1033 as shown on FIG. 1C.

The following list includes particular embodiments of the present invention. But the list is not limiting and does not exclude alternate embodiments, or embodiments otherwise described herein. Percent identity described in the following embodiments list refers to the identity of the recited sequence along the entire length of the reference sequence.

### EMBODIMENTS

1. A bioreactor system for cell-free production comprising at least one sector selected from the following group consisting of: a device sector, an inload sector, an unload sector, a separating sector and a desired product sector, wherein the device sector comprises at least one unit comprising a plurality of compartments to carry out cell-free reactions; the inload sector comprises one or more containers for intake of fluid and one or more tubes operational to carry fluid from the inload sector to the device sector; the unload sector comprises one or more tubes operational for removal of fluid from the device sector; the separating sector comprises one or more tubes for separation of a desired product from a waste material; and the desired product sector comprises at least one tube and at least one container for collecting the desired product.

2. The bioreactor system of embodiment 1, wherein each one of the inload, unload and separating sectors includes one or more pumps operable to carry fluids through the bioreactor system.

3. The bioreactor system of one or both embodiments 1 and 2, wherein the at least one unit comprises an upper section, a middle section, a side section and a bottom section.

4. The bioreactor system of any one or more of embodiments 1-3, wherein the middle section comprises the plurality of the compartments inside a tridimensional grid to hold a production mixture.

5. The bioreactor system of any one or more of embodiments 1-4, wherein the plurality of the compartments comprise wells, and wherein walls of the wells are partially and/or entirely semipermeable.

6. The bioreactor system of any one or more of embodiments 1-5, wherein the upper, side and bottom sections are configured to supply supporting solutions to the compartments.

7 The bioreactor system of any one or more of embodiments 1-6, wherein the at least one unit further comprises an upper membrane in-between the upper section and the side and/or the middle section, and a lower membrane in-between the middle and/or side section and the bottom section.

8. The bioreactor system of any one or more of embodiments 1-7, wherein the upper and lower membranes are semipermeable, or wherein the upper membrane is semipermeable and the lower membrane impermeable

9. The bioreactor system of any one or more of embodiments 1-7, wherein the upper and lower membranes are impermeable, or wherein the upper membrane is impermeable and the lower membrane semipermeable.

10. The bioreactor system of any one or more of embodiments 1-9, wherein the side section comprises a scaffold.

11. The bioreactor system of any one or more of embodiments 1-10, wherein the scaffold comprises one or more tubes and/or poles.

12. The bioreactor system of any one or more of embodiments 1-11, wherein the one or more tubes are partially outside of an envelope and are configured for inload or unload fluids.

13. The bioreactor system of any one or more of embodiments 1-12, wherein the one or more tubes and/or poles are connected to the tridimensional grid and are configured as handles to move the tridimensional grid up and down the scaffold.

14. The bioreactor system of any one or more of embodiments 1-13, wherein the one or more tubes are connected to the inload sector.

15. The bioreactor system of any one or more of embodiments 1-14, wherein the one or more tubes comprise valves for sequential opening of the one or more tubes to inload fluids into the device sector.

16. The bioreactor system of any one or more of embodiments 1-15, wherein the device sector comprises three to four units.

17. The bioreactor system of any one or more of embodiments 1-16, wherein the device sector comprises an envelope that encompasses the at least one unit.

18. The bioreactor system of any one or more of embodiments 1-17, wherein the device sector further comprises one or more moving machines.

19. The bioreactor system of any one or more of embodiments 1-18, wherein the one or more moving machines are operable to move parts of the device sector or provide shaking, or both.

20. The bioreactor system of any one or more of embodiments 1-19, wherein the inload sector further comprises a mixing or stirring gadget, or both.

21. The bioreactor system of any one or more of embodiments 1-20, wherein the separating sector further comprises at least one device selected from the group consisting of: a signal detector, a chromatographic device, and a spectrophotometric device.

22. The bioreactor system of any one or more of embodiments 1-21, wherein the desired product sector further comprises the altering well.

23. The bioreactor system of any one or more of embodiments 1-22, wherein the altering well comprises a pump.

24. The bioreactor system of any one or more of embodiments 1-23, wherein the desired product sector further comprises a scale.

25. The bioreactor system of any one or more of embodiments 1-24, wherein the unload sector comprises one or more waste containers.

26. The bioreactor system of any one or more of embodiments 1-25 further comprising a recycle sector configured for separation of production component from waste material and directing them back to the device sector.

27. The bioreactor system of any one or more of embodiments 1-26, wherein the recycle sector comprises one or more separation lines.

28. The bioreactor system of any one or more of embodiments 1-27, wherein the recycle sector comprises one or more pumps operable to carry the production components from the one or more separation lines to the device sector.

29. A method of producing a biological product, comprising: inloading fluid comprising a cell-free biological material into a plurality of compartments within a bioreactor device; adding at least one supporting solution to each one of the plurality of the compartments to form a production mixture; providing conditions suitable for one or more chemical reactions within the plurality of the compartments for transforming the production mixture into a resulting mixture; removing waste material from each of the plurality of the compartments; separating production components from a desired product within the resulting mixture; and collecting the desired product in a container.

30. The method of embodiment 29, wherein the step of inloading comprises pouring in fluid into one or more inload containers.

31. The method of one or both of embodiments 29-30, wherein the step of inloading comprises stirring or mixing the fluid.

32. The method of any one or more of embodiments 29-31, wherein the step of inloading further comprises pumping the fluid into the bioreactor device.

33. The method of any one or more of embodiments 29-32, wherein the one or more chemical reaction comprises synthesis of a compound.

34. The method of any one or more of embodiments 29-33, wherein the synthesis comprises transcription or translation reactions, or both.

35. The method of any one or more of embodiments 29-34 further comprising at least one reaction of posttranslational modification.

36. The method of any one or more of embodiments 29-35 wherein the step of separating comprises affinitive chromatography.

37. The method of any one or more of embodiments 29-36, wherein the step of separating further comprises monitoring quality and quantity of the desired product.

39. The method of any one or more of embodiments 29-37, wherein monitoring comprises spectrophotometry, or circular dichroism.

40. The method of any one or more of embodiments 29-39 further comprising recycling the production components.

41. The method of any one or more of embodiments 29-40, wherein the step of recycling comprises directing the production components into the bioreactor device for another production cycle.

42. The method of any one or more of embodiments 29-41, wherein the step of recycling comprises further separation of the production components from the waste material.

43. The method of any one or more of embodiments 29-42, wherein the step of separation comprises size exclusion chromatography.

44. The method of any one or more of embodiments 29-43, wherein the step of recycling further comprises monitoring quality and quantity of the production components.

45. The method of any one or more of embodiments 29-44, wherein prior to collecting the method further comprises chemical, biological or physical altering of the desired product.

46. The method of any one or more of embodiments 29-45, wherein prior to collecting the method further comprises further separation or purification of the desired product.

47. The method of any one or more of embodiments 29-46, wherein the step of collecting comprising weighing the desired product.

48. A method of manufacturing a bioreactor system of any one or more of embodiments 1-28 comprising assembling, casting or bolting parts of the bioreactor system together.

49. The method of embodiment 48, wherein the bioreactor system is made by using at least one material selected from the group consisting of: plastic, glass, metal, cellulose, silicone and inox.

50. A device for cell-free production of a biological product, wherein the device comprises at least one unit comprising a plurality of compartments to carry out cell-free reactions.

51. The device claim 50, wherein the at least one unit comprises an upper section, a middle section, a side section and a bottom section.

52. The device of any one or both of embodiments 51 and 52, wherein the middle section comprises the plurality of the compartments to hold a production mixture.

53. The device of any one or more of embodiments 50-52, wherein the plurality of the compartments comprise wells.

54. The device any one or more of embodiments 50-53, wherein walls of the wells are partially or entirely semipermeable.

55. The device of any one or more of embodiments 50-54, wherein the upper, side and bottom sections are configured to supply supporting solutions to the compartments.

56. The device of any one or more of embodiments 50-55, wherein the at least one unit further comprises an upper membrane in-between the upper section and the middle section or in-between the upper section and the side section; and a lower membrane in-between the middle section and the bottom section or in-between the middle section and the side section.

57 The device of any one or more of embodiments 50-56, wherein the upper and lower membranes are partially or entirely semipermeable.

58. The device of any one or more of embodiments 50-56, wherein the upper and lower membranes are impermeable.

59. The device of any one or more of embodiments 50-58, wherein the side section comprises a scaffold.

60. The device of any one or more of embodiments 50-59, wherein the scaffold comprises at least one tridimensional grid and one or more tubes and/or poles.

61. The device of any one or more of embodiments 50-60, wherein the one or more tubes are partially outside of an envelope and are configured for inload or unload of fluids.

62. The device of any one or more of embodiments 50-61, wherein the one or more tubes are connected to the tridimensional grid and are configured as handles to move the tridimensional grid up and down the unit.

63. The device of any one or more of embodiments 50-62, wherein the one or more tubes are connected to the inload sector.

64. The device of any one or more of embodiments 50-63, wherein the one or more tubes comprise valves for sequential opening of the one or more tubes to inload fluids into the device sector.

65. The device of any one or more of embodiments 50-64, wherein the device sector comprises three to four units.

66. The device of any one or more of embodiments 50-65, wherein the device comprises an envelope that encompasses the at least one units.

The description of embodiments of the disclosure is not intended to be exhaustive or to limit the disclosure to the precise form disclosed. While specific embodiments of, and examples for, the disclosure are described herein for illustrative purposes, various equivalent modifications are possible within the scope of the disclosure, as those skilled in the relevant art will recognize. For example, while method steps or functions are presented in a given order, alternative embodiments may perform functions in a different order, or functions may be performed substantially concurrently. The teachings of the disclosure provided herein can be applied to other procedures or methods as appropriate. The various embodiments described herein can be combined to provide further embodiments. Aspects of the disclosure can be modified, if necessary, to employ the compositions, functions and concepts of the above references and application to provide yet further embodiments of the disclosure. These and other changes can be made to the disclosure in light of the detailed description. All such modifications are intended to be included within the scope of the appended claims.

Further embodiments herein may be formed by supplementing an embodiment with one or more element from any one or more other embodiment herein, and/or substituting one or more element from one embodiment with one or more element from one or more other embodiment herein.

### EXAMPLES

The following non-limiting examples are provided to illustrate particular embodiments. The embodiments throughout may be supplemented with one or more detail from one or more example below, and/or one or more element from an embodiment may be substituted with one or more detail from one or more example below.

### Example 1

### Entire Machine

This system consists of a device that itself can be compartmentalizing bioreactor or it can be used for compartmentalization of another already existing bioreactor, and its potential subsequent machinery. The invention is created to enhance production based on cell-free synthesis, by providing altered conditions for it. It offers a possibility of continuous production, by purposeful subsequent processing of synthesized product and production components.

Demand for immense production volumes requires large amounts of materials to be processed and robust ways of dealing with them. On the other hand, delicate nature of molecular sized biocomponents demands fine-tuned processes. This invention finds specific balance between those two, while, at the same time, functioning in simple and easy way.

The device part of the system creates compartments and providing platforms for cell free product synthesis and/or posttranslational modifications. Subsequent machinery enables continuity and/or automatization of fabrication in whole or in part and/or reuse of cell free components. Present disclosure offers solutions to four problems stated above, in section titled Background.

Solutions to problems stated above are, respectively: (1) Compartmentalization; (2) providing platforms surrounding each compartment; (3) continuous fabrication process and machinery for it; and (4) method for reuse of cell free components and machinery for it.

### (1) Compartmentalization

In order to reduce chaos of the system, reduction in number of its components needs to be provided. Since, the number of participants in cell free productions should not be reduced, the number of systems they are placed in needs to be increased. This can be achieved by dividing bioreactor into small compartments. In that way, the quantity of the components in the whole bioreactor system remains, but the number of particles in each compartment, that now presents new system, is lower.

This disclosure herein provides description of a bioreactor device that each has four sections: the upper, the middle, the side and the bottom one. The middle section is where the production mixture is poured into and it gets divided onto compartments by specially designed tridimensional grid. The upper, the side and the bottom sections are supporting sectors that are connected to cell free production mixture through providing platforms.

Thanks to good mixing practices within filling containers, every compartment has the same probability of containing all necessary components for completion of cell free synthesis processes. Furthermore, those processes are protected from unwanted interferences by membranes and the grid's walls.

Turning messy cell-free production mixture into strict geometrical structure, by compartmentalization enable easier and more precise calculation of its approximative overall productivity.

### (2) Providing Platforms Surrounding Each Compartment

In order to get maximal gain out of cell-free synthesis and potential posttranslational modifications, it is important to provide the middle section's mixture with proper supporting fluids. This system enables that by surrounding each production compartment with providing platforms, that can supply supportive fluids. In that way, this system enables that each part of the cell-free production mixture is saturated with required supportive substances. Exchange process is actualized through dialysis, which does not disrupt the cell free synthesis and posttranslational modifications processes as much as mixing does. Even if the supporting fluid or fluids are flowing it would be tangential flow, which also would not disturb the reactions as much as mixing would. On contrary, it can help increase productivity because it can enable unplugging of the pores in the dialysis membranes.

Each of the providing platforms can supply same and/or different fluids. Contents of these fluids can be altered during the production process. In that way, each compartment is provided with all that is necessary for its functioning.

### (3) Continuous Fabrication Process and Machinery for it

Once the synthesis and/or one or more posttranslational modification reactions are over and desired product is created, future processes in its turning into a final product are of importance for its quality. Therefore, some of the embodiments of this invention contain adapted processes and machinery for their realization, continuity and possible automatization.

The challenge of adapting the known methods to specific requirements of this type of production is resolved by designing specific pipelines that enables continuity of the process through meaningful flow of the eluate. This type of flow is provided by strategical design of the tubes, as well as intentionally placed gadgets, that in some embodiments can include: actuators, pumps, valves, monitoring devices, etc.

### (4) Method for Reuse of Cell-Free Components and Machinery for it

Possibility of reuse of the components used in cell free production is provided as set of specially designed tubes that in some embodiments can be placed after the effective separation of desired product and the rest of the production mixture.

In order to successfully reuse components of cell-free production, it is first necessary to provide their proper exclusion from the system, adequate separation and then their re-inclusion in the system in appropriate way. All that requires to be aware of their amount and shape, in order to determine which ones can be reused, which ones need to be thrown away and how many of them need to be replaced.

### Example 1.1

### Production of Monoclonal Antibodies

An example of the best version of the invention can be machine for production of monoclonal antibodies. This machine would contain multi units device and all subsequent machinery. The machine would consist of six sectors: inload, device for cell free product synthesis, unload sector, the separation tubes, desired antibody pipeline and cell free components recycle pipeline.

### Inload Sector

Inload sector is the first to be used. This machine would start with six inload containers. Into containers proper fluids are inloaded and they are being mixed with mixing devices that are contained within containers. Also, each container would be attached to tubes, at the beginning and at the end equipped with valves, that serve as liaison between inload container and section. Four inload containers would be connected to all three supportive sections, the bottom, the side and the upper one, and they would change contents of each of these sections during the reaction, except for the cell free antibody production input mixture's inload container that would be connected only to middle section. Buffer container would be connected to all four sections. Each container would operate in times suitable for its actions. Valves would be open when fluid from container is being inloaded into appropriate section. Inload containers are ball shaped, have an opening, with a safety cap, into which the materials are being inloaded and a mixing device that is able to evenly mix the fluid with minimal mechanical damage to it. First container would contain a mixing device and nutrient fluid. It would have tubes, that go into the bottom, upper section and side section, attached to it. This fluid would contain amino acids, energy molecules, cofactors and other molecules necessary for support of cell free antibody synthesis and posttranslational modifications. This fluid would, through the tubes leading form the container to them, be inloaded into all bottom sections that are included into cell free product synthesis device. Then it would be necessary to lift up the tridimensional grid. Second container would also contain mixing device and cell free antibody synthesis and posttranslational modifications input fluids. These fluids would contain all components that participate in synthesis and posttranslational modifications of desired antibody. This fluid would, through the tubes leading form the container to them, be inloaded into all middle sections that are included into cell free product synthesis device. Then the valves on the first container that led to side section connected tubes would be open and the nutrition fluid would be inloaded into the grid and the grid would slowly start to descend into the middle section. Sometime after the reactions start, the valves on the third container, that contains mixture of gases, mixing device and tubes that lead to all three supporting sections attached to it, would be open and the necessary gases would slowly from time to time be entering the middle section through supporting sectors. The fourth container would contain waste fluid and it would be connected with and slowly from time to time be introduced into all sections free from production components, the bottom, side and upper section, as the reaction moves forward and waste is being created. It will also gradually be mixed with other fluids within sections during the cell free antibody synthesis. The fifth fluid would contain chaperones, glycosides and other materials necessary for additional post translational modifications of the antibody. It would also be connected to all three supporting sections i.e. the bottom, side and upper and it would be introduced to them when the protein synthesis part of antibody production is over. The sixth container contains buffer for elution of the device and subsequent tubes. Thus, it is connected through tubes with all sections and its contents is released after the reaction is over.

Containers would be made of inox material and content of each of the supporting sections' inload containers would be slightly quantitatively and/or qualitatively altered during time by adding one or more fluids through the openings on the inload containers. All alterations would be done so that each of the supporting containers, i.e. their contents, keep their original function.

### Device Sector

The inload sector continues into the device sector. All sections would be filled till the top except the upper section. Where it would be left enough space for gasses that are created during the synthesis and posttranslational modifications to go and they would be removed from device by opening valve on unload tubes of upper sections. The device may be encapsulated into an inox envelope. The envelope may contain tube joints equipped with safety bolts and scaffold's tubes' and lower membranes poles' openings, equipped with safety silicon rubbers and mechanism for the tubes' and poles' movements up and down. Inside the envelope there would be a device that consists of a hundred units, placed one on top of another. Each of the units would have all four sections and would be separated from the lower one by impermeable layer of inox. Lower membranes would have two rows of sixteen poles attached to them placed parallel to each other and away from membranes' endings. These poles would be strings of forty nine supporting and one connecting short pole. The middle sections would be thin, so that 6 μl of the cell free antibody production input mixture is placed into one compartment. Each other section would be of the size best corresponding to the necessities of the middle section. There would be forty-eight cylindrical tubes entering tridimensional grids. The tubes would be placed parallel to each other in eight rows and six columns. Each grid would have 3072 wells, that would be lined up in 64 rows and 48 columns. Grids' elements on upper end of each grid and on each of the grids' plates would be the same. Well diameter would be 0.9 mm and well height would be 2.36 mm. Since entire device has 50 units it would contain 153600 wells. Each unit's height would be 12 mm, and height of entire device would be 600 mm, length 288 mm and width 384 mm. Device would be able to process 0.9216 liters of input mixture. Grids' elements would be in shape of circles and they would form cylindric compartments. Once the cell free antibody synthesis and posttranslational modifications reactions are over, valves on unload tubes for upper sections are open and the upper sections' contents start being unloaded by pouring out. During unload of upper sections two rows of left upper membranes' tubes are pulled up, so that rest of upper sections' mixtures would slide down into unload opening for upper section. Once that is over the rest of upper membranes is pulled up. Then tridimensional grids are pulled up from the middle into the upper sections. Then the compartments contents are mashed together and side sections' mixtures are pumped out. Mount pads on two rows of lower membranes' poles are released, and now one side of lower membranes is dropping as bottom sections' mixtures are poured out, pushing them further on. As this is happening, valves on middle sections' unload tubes are open and they are poured out. Tilting of lower membrane enables middle sections' mixtures to slide into their belonging unload tubes. Once middle sections' mixtures are poured out, the rest of bottom sections mixtures can be pumped out.

### Unload Sector

As there would be tubes that inload fluids into the section, there would also be tubes that unload fluids out of the device. Each of these tubes would have a valve that would be open when the fluid needs to be poured out and closed when fluid is needed in the section. The bottom, side and upper sections' unload tubes would all be joined in one tube and there would be a pump enabling easier unload of the fluids. That tube would end in a waste container where all the fluids unloaded in it would be dismissed.

### Separation Tubes Sector

Four unload tubes from five neighboring middle sections would be unloaded into twenty first separative tubes. Inside of those tubes would be coated with protein A affinity chromatography stationary phase. There the antibodies of interest would be retained and the rest of the middle sections' mixture would be washed away with elution buffer poured first from the container through the device part and then through separate tubes leading to the affinity chromatography tubes. The effectiveness of the separation would be detected by a spectrophotometric device. The light source would be connected to optical fibers that would transfer the light to each of the twenty affinity chromatography tubes and the other set of optic fibers would collect the signals and detect it in one device. There would be three valves at the end of each affinity chromatography-spectrophotometry tube. After each valve at each chromatography tube there is a tube connected to it. Thus, there are desired product's tube, production component's tube and redirection tube. When the detected signal shows good separation the production components pipeline's valves are opened and the rest are closed. Once the detected signal shows antibodies of interest the desired products pipeline's valves are opened and that fluid goes there, while the other valves are closed. When the detected signal shows inadequate separation the recycling valve on the tubes that show signal in that range are opened, the rest of the valves at the end of those tubes are closed and the material is directed back to the chromatography tube. This is done with the help of a pump and the valve, at site where redirecting tube is joined to the affinity chromatography tube, while the valve connecting these two is opened. The chromatography is repeated until the signal is satisfactory.

### Desired Antibody Pipeline

Once the desired product's valve is opened, desired antibodies start flowing through separate tube. At the middle of that tube would be a well in which the antibodies would be treated in order for eventually present viruses to neutralized. This well would be round shaped, would have an opening, secured with a cap, and equipped with a pump. Once the neutralization reaction is over the valve on the bottom of the well is opened and the flow of the antibodies continues. The tube is expanded and then divided into ten small and narrow tubes whose insides are coated with affinity chromatography stationary phase adequate for specific antibody that is being made. Here the antibodies of interest are divided from the rest of the mixture that can contain defected antibodies, impurities, retained production components, etc. This chromatography serves to confirm the quality and effectivity of the created product. Each chromatography would be followed by signal detection. That signal detection would be circular dichroism. This is done to determine the quality and effectiveness of the antibody and to confirm its identity. At the end of the detection part of the tube there is a valve that is opened when the signal shows clear separation, when the signal shows inadequate separation, the valve is closed and the mixture is redirected to the same tube for another cycle of chromatography. This is done with a help of a pump and the valve at the connecting part of the redirecting and chromatography tube, that needs to be open so that mixture can reenter the chromatography tube. This is done as many times as necessary until separation signal is clear. After that the fluid continues elution through tubes, where each tube is two ended. This means that each tube is perforated and divided into two parts. In the middle there is a stick holding a valve that can be turned left or right. Therefore, on one side there is a valve in the form of cap, while the other one is empty. Depending on the recorded signal stick is turned in the direction for valve to covers adequate tube part. When the detecting device shows signal in the range of the waste products the stick is turned in the way that the valve cap is covering the part that is directly under the normal flow of fluid and leaves the perforated part open, so that waste is unloaded over the cap into perforated part and from that directly into the waste. When the signal is detected in the range of the desired product, the cap is turned into perforated section and normal flow of the fluid simply continues into part that is directly underneath it. The product is first unloaded into tube. Each desired product's passage continues to a tube. All the tubes are connected into one big tube, leading to filtration bowl. The bowl content's weight is measured, the content is filtrated, washed with a buffer and product is finished. It can further be processed or poured into packaging material, as desired.

### Cell Free Components Recycle Pipeline

Once the production components' pipeline valve on the affinitive chromatography tube is opened, rest of the middle sections' mixture except the desired product, which is antibody in this case, would then be directed through separate tube. That tube contains one section where the separation in the form of size exclusion chromatography would be performed. This chromatography would be followed by subsequent circular dichroism signal detection. This would be done to make sure that the process is done properly and to quantify production components. After the signal detection, the fluid would be directed to adequate tube with help of three valves. According to the detected signal adequate valve would be open. If the signal detects correct production components, the signal is observed in the certain range and the corresponding valve is open. Then the production components would be directed through that tube back to the appropriate inload container. This would be done by a help of a pump. There would be a valve on the place where the redirecting tube is connected to container and this valve needs to be open when the production components' mixture is redirected back into container. In case of any faulty signal, the adequate valve is open. If detected signal showed that the components are damaged, the lower valve would be open and the components flushed to waste, through it. If the detected signal showed poor separation, the lower valve would be kept closed and production components' mixture would be directed through a redirection tube again back to the separation column, in order to repeat the separation. This process should be done as many times as necessary, for mixture to be separated properly or thrown to waste. There would be a valve on the place where the redirecting tube is connected to the separation tube and this valve needs to be open when the production components' mixture is redirected into separation column. Also, this process would be done by the help of the pump.

Each dismissed waste would be measured, when discarded through lower valve, so there would be an exact notion how much of each of the component is present and how much should be replaced.

### Example 1.1.1

Same as Example 1.1, only it would not contain subsequent machinery. Middle sections' mixtures would be collected in one or multiple containers and then further processed outside of the present invention.

### Example 1.1.2

Same as Example 1.1, only it would not contain desired product's and production components' pipelines, but the product and production components would be collected from appropriate valves at the ends of the separation tubes in one or multiple containers and then further processed outside of the present bioreactor system. FIG. 50B illustrates a separate first line of separation production scheme example-without second separation and chemical and/or biological treatment of products and recycling of production components.

### Example 1.1.3

Same as Example 1.1, only it would not contain production components' pipeline, but production components would be collected from appropriate valves at the ends of the separation tubes in one or multiple containers and then further processed outside of the present bioreactor system. FIG. 50C illustrates a separate first line of separation production scheme example-without recycling of production components.

### Example 1.1.4

Same as Example 1.1, only it would not contain desired product's pipeline, but the product would be collected from appropriate valves at the ends of the separation tubes in one or multiple containers and then further processed outside of the present bioreactor system. FIG. 50D illustrates a separate first line of separation production scheme example-without second separation and chemical and/or biological treatment of products.

### Example 1.1.5

Same as Example 1.1, except it would not contain the entire desired product's pipeline, but only the tube, the well and it would end with a tube coming out of the well. The product would be collected from appropriate valve in one or multiple containers and then further processed outside of the present bioreactor system. FIG. 50E illustrates a separate first line of separation production scheme example-without second separation of products.

### Example 1.1.6

Same as Example 1.1, except it would not contain production components' and part of desired product's pipeline, but only the tube, the well and it would end with a tube coming out of the well. The product would be collected from appropriate valve in one or multiple containers and then further processed outside of the present bioreactor system. FIG. 50F illustrates a separate first line of separation production scheme example-without second separation products and recycling of production components.

### Example 1.2

Production of Messenger RNA (mRNA)

One of the examples of use of the present invention is production of messenger RNA (mRNA). This embodiment would be same as described in Example 1.1, with few exceptions that serve to adjust the production method to the desired mRNA product. Inload sector and device would be same as in Example 1.1, with exception of contents of production mixture and supporting fluids. Therefore, production mixture would be adequate to production of a specific mRNA molecule, supporting fluids would be adequate to production of a specific mRNA molecule and chromatography within production process would be adequate to production of a specific mRNA molecule. In this example that means that first separation line chromatography stationary phase would contain deoxythymidine ligands, molecules that are specific for mRNA molecule, instead of protein A. While in some other examples of mRNA production by help of the present invention this molecule could be different. The production components' pipeline would be same as in Example 1.1, only the size exclusion stationary phase's material would have pores of sizes adequate to mRNA production components. The desired product's pipeline would also be the same as in Example 1.1, with exception that affinity chromatography in it would be adequate to specific mRNA molecule that is being produced. That means that chromatography stationary phase would contain molecule that is specific for the desired mRNA molecule.

### Example 2

Implementation of the Device into Existing Machine

### Example 2.1

Replacement of Conventional Bioreactor with the Device

Inload, unload sectors as well as the subsequent separation methods and machinery of the existing production process would stay the same. Only the conventional bioreactor, in this example bag in which production of insulin is performed is replaced by the multiple units device, whose description is disclosed herein, containing twelve units and two hundred compartments within one unit. Inload and unload tubes would be extended by valves and tubes that would be divided into as many little tubes as necessary to correspond to every unit of the device, by connecting to the adequate inload and unload openings of the device whose description is disclosed herein. The rest of the molecule processing would be done as it is described in Example 1.1 in section Device sector.

### Example 2.2

Implementation of the Device into Existing Bioreactor

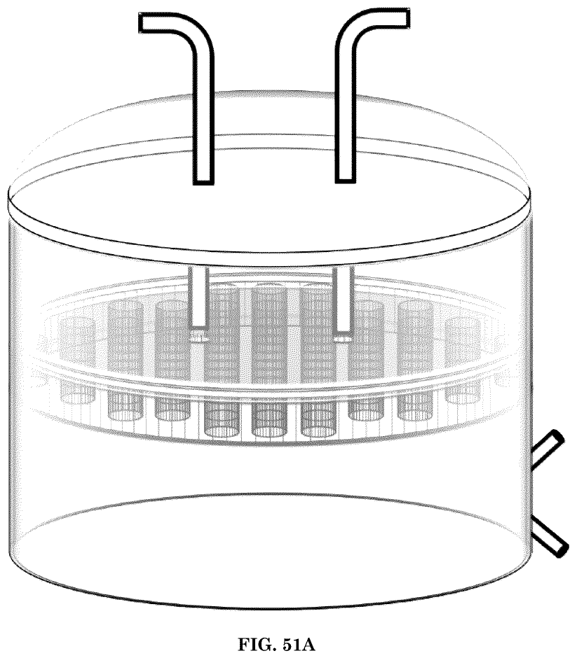

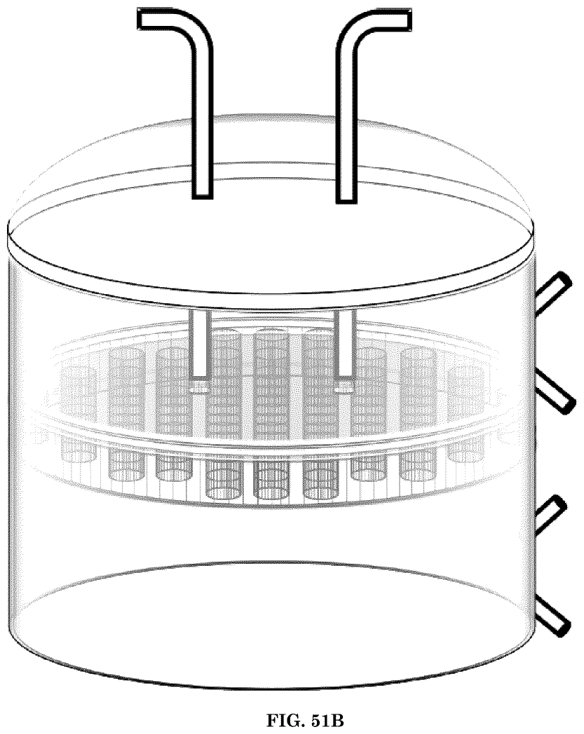

This example describes creation of the device inside of an existing conventional bioreactor. FIGS. 51A-51B illustrate a device implemented into conventional bioreactor.

Instalment of the device into conventional bioreactor will be done by providing scaffold inside of it and inload and unload openings for the upper and the bottom section. Inside of the existing machine, the device would be implemented so that walls of the existing conventional bioreactor are now envelope of the device. Tridimensional grid is placed within the device between inside of its walls. In order to properly fit into the envelope and to cover surfaces that need to be covered, upper and lower membranes have to be of the adequate size and shape as the inside of the conventional bioreactor, so they can cover the entire area and separate the sections, but still be flexible enough for their sides to be moved up and down inside of now device. At the outer ends of the grid there should be thin layer of rubber so it can slide up and down inside of a device. Besides placing the scaffold into the existing machine two holes will be drilled in the lid of the conventional bioreactor. These two holes will be scaffold's tubes' openings, through them two scaffold's tubes will be pushed through and screwed to the bolts on the upper membrane, that is integral part of the tridimensional grid in this example. These tubes would be pulled up and down when appropriate through these openings. The inload and unload openings for the bottom section would be drilled in the bottom section of the device and on the lower side area of then batch bioreactor next to each other. There will be valve at each of the openings. Tubes will be placed into the valves. Tubes would be connected to the pumps. Inload tube would have a pump that pumps in the fluid and the unload tube would have a pump that pumps out the fluid from the device. FIG. 51A illustrates no pouring in and out opening on sides, only on top of the upper section.

### Example 2.2.1

Same as the example 2.2, only there would be inload and unload openings drilled in the upper middle side area of the conventional bioreactor. Those openings would enable instalment of tubes that would serve as inload and unload tubes for the upper and middle section. FIG. 51B illustrates three pouring in and out opening on sides.

It is understood, therefore, that this invention is not limited to the particular embodiments disclosed, but is intended to cover all modifications which are within the spirit and scope of the invention as defined by the appended claims; the above description; and/or shown in the attached drawings.

What is claimed is:

1. A bioreactor system for cell-free production comprising at least one sector selected from the following group consisting of: a device sector, an inload sector, an unload sector, a separating sector and a desired product sector, wherein the device sector comprises at least one unit comprising a plurality of compartments to carry out cell-free reactions; the inload sector comprises one or more containers for intake of fluid and one or more tubes operational to carry fluid from the inload sector to the device sector; the unload sector comprises one or more tubes operational for removal of fluid from the device sector; the separating sector comprises one or more tubes for separation of a desired product from a waste material; and the desired product sector comprises at least one tube and at least one container for collecting the desired product.

2. The bioreactor system of claim 1, wherein the at least one unit comprises an upper section, a middle section, a side section and a bottom section.

3. The bioreactor system of claim 2, wherein the middle section comprises the plurality of the compartments to hold a production mixture.

4. The bioreactor system of claim 3, wherein the plurality of the compartments comprise wells and walls of the wells are partially or entirely semipermeable.

5. The bioreactor system of claim 2, wherein the upper, side and bottom sections are configured to supply supporting solutions to the compartments.

6. The bioreactor system of claim 2, wherein the at least one unit further comprises an upper membrane and a lower membrane.

7. The bioreactor system of claim 6, wherein the upper membrane is in-between the upper section and the middle section or in-between the upper section and the side section; and the lower membrane is in-between the middle section and the bottom section or in-between the middle section and the side section.

8. The bioreactor system of claim 7, wherein the upper and lower membranes are partially or entirely semipermeable.

9. The bioreactor system of claim 2, wherein the side section comprises a scaffold.

10. The bioreactor system of claim 9, wherein the scaffold comprises at least one tridimensional grid and one or more tubes and/or poles.

11. The bioreactor system of claim 10, wherein the one or more tubes are partially outside of an envelope and are configured for inload or unload of fluids.

12. The bioreactor system of claim 1, wherein the device sector comprises an envelope that encompasses the at least one units.

13. The bioreactor system of claim 1, wherein the separating sector further comprises at least one device selected from the group consisting of: a signal detector, a chromatographic device, and a spectrophotometric device.

14. The bioreactor system of claim 1 further comprising a recycle sector configured for separation of production component from waste material and directing them back to the device sector.

15. The bioreactor system of claim 1 comprising only the device sector.

16. A method of producing a biological product, comprising: inloading fluid comprising a cell-free biological material into a plurality of compartments within a bioreactor device; adding at least one supporting solution to each one of the plurality of the compartments to form a production mixture; providing conditions suitable for one or more chemical reactions within the plurality of the compartments for transforming the production mixture into a resulting mixture; removing waste material from each of the plurality of the compartments; separating production components from a desired product within the resulting mixture; and collecting the desired product in a container.

17. The method of claim 16, wherein the one or more chemical reaction comprises synthesis of a compound.

18. The method of claim 17, wherein the synthesis comprises transcription or translation reactions, or both.

19. The method of claim 18 further comprising at least one reaction of posttranslational modification.

20. The method of claim 16, wherein the step of separating comprises affinitive chromatography.

21. The method of claim 20, wherein the step of separating further comprises monitoring quality and quantity of the desired product.

22. The method of claim 21, wherein monitoring comprises spectrophotometry, or circular dichroism.

23. The method of claim 16 further comprising recycling the production components.

24. The method of claim 23, wherein the step of recycling comprises directing the production components into the bioreactor device for another production cycle.

25. The method of claim 23, wherein the step of recycling comprises further separation of the production components from the waste material.
